(19) United States
(12) Patent Application Publication
(10) Pub. No.: US 2025/0370233 A1
(43) Pub. Date: Dec. 4, 2025

(54) VARIABLE MAGNIFICATION OPTICAL SYSTEM AND IMAGING APPARATUS

(71) Applicant: SIGMA CORPORATION, Kanagawa (JP)

(72) Inventor: Takeshi UMEDA, Kanagawa (JP)

(73) Assignee: SIGMA CORPORATION, Kanagawa (JP)

(21) Appl. No.: 19/220,742

(22) Filed: May 28, 2025

(30) Foreign Application Priority Data
Jun. 3, 2024 (JP) 2024-089613

(51) Int. Cl. G02B 15/14; H04N 23/69

(52) U.S. Cl. CPC G02B 15/144115; H04N 23/69

(57) ABSTRACT

A variable magnification optical system including: in order from an object side, a first lens group G1 having a positive refractive power; a second lens group G2 having a negative refractive power; a third lens group G3 having a positive refractive power; a fourth lens group G4 having a positive refractive power; and a fifth lens group G5 having a negative refractive power, wherein, during zooming from a wide-angle end to a telephoto end, a distance between the first lens group G1 and the second lens group G2 changes, a distance between the second lens group G2 and the third lens group G3 changes, and a distance between the third lens group G3 and the fourth lens group G4 changes, during focusing from an infinity end to a closest object end, any one of the fourth lens group G4 or the fifth lens group G5 moves along an optical axis.

### TECHNICAL FIELD

The present invention relates to a variable magnification optical system and imaging apparatus.

### BACKGROUND ART

As a variable magnification optical system used in an imaging apparatus, there is a demand from the market for a small size, a large aperture ratio, a high zooming ratio, and favorable correction of various aberrations.

In the related art, a variable magnification optical system that is small in size and compatible with a large-sized image sensor and in which various aberrations are satisfactorily corrected from a wide-angle end to a telephoto end has been proposed (for example, Patent document 1). In addition, a small variable magnification optical system that can obtain a favorable optical performance at a wide angle of view with a high zooming ratio and an optical device equipped with the variable magnification optical system have been proposed (for example, Patent document 2). Further, a variable magnification optical system that is small as a whole while having a large aperture ratio and has excellent optical performance and an imaging apparatus including the variable magnification optical system have been proposed (for example, Patent document 3).

### RELATED ART DOCUMENTS

### Patent Documents

[Patent Document 1] WO2019/049370

[Patent Document 2] JP-A-2020-071439

[Patent Document 3] JP-A-2023-004721

### Non-Patent Documents

[Non-Patent Document 1] Yoshiya Matsui, “Lens Design Method,” Kyoritsu Shuppan, Nov. 5, 1972, pp. 86, line 17-pp. 87, line 16, pp. 98, lines 11-19.

[Non-Patent Document 2] Yoshiya Matsui, “Normalization of Aberration Coefficients for New Type of Optical Systems,” Optics, The Optical Society of Japan, Vol. 23, No. 10, October 1994, pp. 637, right col, line 33-pp. 638, left col, line 13.

[Non-Patent Document 3] Hiroshi Inoue, Inspection Techniques for Optical Elements and Mechanisms, Revised Edition II: Mechanism Components, Optronics Co., Ltd., Apr. 10, 2009, pp. 95-96, section 4.6.

### SUMMARY OF THE INVENTION

### Problem That the Invention is to Solve

In the above background art, it is difficult to provide a variable magnification optical system in which sufficient reduction in size, a large aperture ratio, and a high zooming ratio are achieved and various aberrations are satisfactorily corrected. For example, in the variable magnification optical systems described in Patent document 2, it is difficult to increase the aperture ratio, and in the variable magnification optical systems described in Patent document 1 and Patent document 3, it is difficult to increase the zooming ratio.

The present invention provides a variable magnification optical system that is small in size, that can increase the aperture ratio and increase the zooming ratio of the variable magnification optical system, and that can satisfactorily correct various aberrations, as a variable magnification optical system used in an imaging apparatus.

### Means for Solving the Problem

In order to solve the above problem, the present invention provides a variable magnification optical system including: in order from an object side, a first lens group G1 having a positive refractive power; a second lens group G2 having a negative refractive power; a third lens group G3 having a positive refractive power; a fourth lens group G4 having a positive refractive power; and a fifth lens group G5 having a negative refractive power, in which, during zooming from a wide-angle end to a telephoto end, a distance between the first lens group G1 and the second lens group G2 changes, a distance between the second lens group G2 and the third lens group G3 changes, and a distance between the third lens group G3 and the fourth lens group G4 changes, during focusing from an infinity end to a closest object end, any one of the fourth lens group G4 or the fifth lens group G5 moves along an optical axis, the third lens group G3 includes at least one negative lens, a lens surface on the object side of a negative lens L3n disposed closest to the image side in the third lens group G3 is convex toward the image side, the fourth lens group G4 includes at least one negative lens, a lens surface on the object side of a negative lens L4n disposed closest to the object side in the fourth lens group G4 is convex toward the image side, and the variable magnification optical system satisfies following conditional expressions.

$$0.61 < f 34 / fW < 1.46 \qquad ( 1 )$$

$$0.32 < f 4 / f 3 < 0.96 \qquad ( 2 )$$

$$- 0.0085 < Δ PgF 1 + Δ PgF 2 < 0.007 \qquad ( 3 )$$

f34: total focal length of the third lens group G3 and the fourth lens group G4. Here, f34=1/(Σ(1/fn)), n=3 to 4. fn is a focal length of an n-th lens group.

fW: focal length of the variable magnification optical system at the wide-angle end

f4: focal length of the fourth lens group G4

f3: focal length of the third lens group G3

ΔPgF1: anomalous dispersion of a negative lens L3n disposed closest to the image side in the third lens group G3. Here, ΔPgF1=PgF1−0.64833+0.00180×vd1. PgF1: partial dispersion ratio of a negative lens L3n disposed closest to the image side in the third lens group G3, with respect to the g-line and the F-line. vd1: Abbe number of a negative lens L3n disposed closest to the image side in the third lens group G3, with respect to the d-line.

ΔPgF2: anomalous dispersion of a negative lens L4n disposed closest to the object side in the fourth lens group G4. Here, ΔPgF2=PgF2−0.64833+0.00180×vd2. PgF2: partial dispersion ratio of a negative lens L4n disposed closest to the object side in the fourth lens group G4, with respect to the g-line and the F-line. vd2: Abbe number of a negative lens L4n disposed closest to the object side in the fourth lens group G4, with respect to the d-line.

### Advantage of the Invention

According to the present invention, it is possible to provide a variable magnification optical system that is small in size, can increase the aperture ratio and increase the zooming ratio of the variable magnification optical system, and has various aberrations satisfactorily corrected, as a variable magnification optical system used in an imaging apparatus.

### BRIEF DESCRIPTION OF THE DRAWINGS

FIG. 1 is a cross-sectional view when an infinite distance object is in focus at a wide-angle end according to Example 1.

FIGS. 2A, 2B, and 2C are longitudinal aberration diagrams in a case where an infinite distance object is in focus at a wide-angle end, an intermediate focal length, and a telephoto end, respectively, according to Example 1.

FIGS. 3A, 3B, and 3C are lateral aberration diagrams in a case where an infinite distance object is in focus at a wide-angle end, an intermediate focal length, and a telephoto end, respectively, according to Example 1.

FIG. 4 is a cross-sectional view in a case where an infinite distance object at a wide-angle end is in focus in Example 2.

FIGS. 5A, 5B, and 5C are longitudinal aberration diagrams in a case where an infinite distance object is in focus at a wide-angle end, an intermediate focal length, and a telephoto end, respectively, according to Example 2.

FIGS. 6A, 6B, and 6C are lateral aberration diagrams in a case where an infinite distance object is in focus at a wide-angle end, an intermediate focal length, and a telephoto end, respectively, according to Example 2.

FIG. 7 is a cross-sectional view when an infinite distance object is in focus at a wide-angle end according to Example 3.

FIGS. 8A, 8B, and 8C are longitudinal aberration diagrams in a case where an infinite distance object is in focus at a wide-angle end, an intermediate focal length, and a telephoto end, respectively, according to Example 3.

FIGS. 9A, 9B, and 9C are lateral aberration diagrams in a case where an infinite distance object is in focus at a wide-angle end, an intermediate focal length, and a telephoto end, respectively, according to Example 3.

FIG. 10 is a cross-sectional view in a case where an infinite distance object at a wide-angle end is in focus in Example 4.

FIGS. 11A, 11B, and 11C are longitudinal aberration diagrams in a case where an infinite distance object is in focus at a wide-angle end, an intermediate focal length, and a telephoto end, respectively, according to Example 4.

FIGS. 12A, 12B, and 12C are lateral aberration diagrams in a case where an infinite distance object is in focus at a wide-angle end, an intermediate focal length, and a telephoto end, respectively, according to Example 4.

FIG. 13 is a cross-sectional view when an infinite distance object is in focus at a wide-angle end according to Example 5.

FIGS. 14A, 14B, and 14C are longitudinal aberration diagrams in a case where an infinite distance object is in focus at a wide-angle end, an intermediate focal length, and a telephoto end, respectively, according to Example 5.

FIGS. 15A, 15B, and 15C are lateral aberration diagrams in a case where an infinite distance object is in focus at a wide-angle end, an intermediate focal length, and a telephoto end, respectively, according to Example 5.

FIG. 16 is a cross-sectional view in a case where an infinite distance object at a wide-angle end is in focus in Example 6.

FIGS. 17A, 17B, and 17C are longitudinal aberration diagrams in a case where an infinite distance object is in focus at a wide-angle end, an intermediate focal length, and a telephoto end, respectively, according to Example 6.

FIGS. 18A, 18B, and 18C are lateral aberration diagrams in a case where an infinite distance object is in focus at a wide-angle end, an intermediate focal length, and a telephoto end, respectively, according to Example 6.

FIG. 19 is a cross-sectional view when an infinite distance object is in focus at a wide-angle end according to Example 7.

FIGS. 20A, 20B, and 20C are longitudinal aberration diagrams in a case where an infinite distance object is in focus at a wide-angle end, an intermediate focal length, and a telephoto end, respectively, according to Example 7.

FIGS. 21A, 21B, and 21C are lateral aberration diagrams in a case where an infinite distance object is in focus at a wide-angle end, an intermediate focal length, and a telephoto end, respectively, according to Example 7.

FIG. 22 is a cross-sectional view in a case where an infinite distance object at a wide-angle end is in focus in Example 8.

FIGS. 23A, 23B, and 23C are longitudinal aberration diagrams in a case where an infinite distance object is in focus at a wide-angle end, an intermediate focal length, and a telephoto end, respectively, according to Example 8.

FIGS. 24A, 24B, and 24C are lateral aberration diagrams in a case where an infinite distance object is in focus at a wide-angle end, an intermediate focal length, and a telephoto end, respectively, according to Example 8.

FIGS. 25A, 25B, and 25C are lateral aberration diagrams in a case where a vibration reduction is performed at an image blur correction angle of 0.3° during focusing on an infinite distance object at a wide-angle end, an intermediate focal length, and a telephoto end, respectively, according to Example 8.

FIG. 26 is a diagram showing a configuration of an imaging apparatus comprising the variable magnification optical system according to the embodiment of the present invention.

### EMBODIMENTS FOR CARRYING OUT THE INVENTION

Hereinafter, a variable magnification optical system according to the present invention and an imaging apparatus equipped with the variable magnification optical system will be described. First, an embodiment of the present invention will be described.

In the present invention, in a case where the number of lenses is counted, a single lens is counted as one lens, and in a case of a cemented lens, each single lens constituting the cemented lens is counted as one lens, unless otherwise specified. For example, a cemented lens of a convex lens and a concave lens are counted as two lenses.

The variable magnification optical system according to the present invention includes: in order from an object side, a first lens group G1 having a positive refractive power: a second lens group G2 having a negative refractive power: a third lens group G3 having a positive refractive power; a fourth lens group G4 having a positive refractive power; and a fifth lens group G5 having a negative refractive power, in which, during zooming from a wide-angle end to a telephoto end, a distance between the first lens group G1 and the second lens group G2 changes, a distance between the second lens group G2 and the third lens group G3 changes, and a distance between the third lens group G3 and the fourth lens group G4 changes, during focusing from an infinity end to a closest object end, any one of the fourth lens group G4 or the fifth lens group G5 moves along an optical axis, the third lens group G3 includes at least one negative lens, a lens surface on the object side of a negative lens L3n disposed closest to the image side in the third lens group G3 is convex toward the image side, the fourth lens group G4 includes at least one negative lens, a lens surface on the object side of a negative lens L4n disposed closest to the object side in the fourth lens group G4 is convex toward the image side, and the variable magnification optical system satisfies predetermined conditional expressions.

$$0.61 < f 34 / fW < 1.46 \qquad ( 1 )$$

$$0.32 < f 4 / f 3 < 0.96 \qquad ( 2 )$$

$$- 0.0085 < Δ PgF 1 + Δ PgF 2 < 0.007 \qquad ( 3 )$$

f34: total focal length of the third lens group G3 and the fourth lens group G4. Here, f34=1/(Σ(1/fn)), n=3 to 4. fn is a focal length of an n-th lens group.

fW: focal length of the variable magnification optical system at the wide-angle end

f4: focal length of the fourth lens group G4

f3: focal length of the third lens group G3

ΔPgF1: anomalous dispersion of a negative lens L3n disposed closest to the image side in the third lens group G3. Here, ΔPgF1=PgF1−0.64833+0.00180×vd1. PgF1: partial dispersion ratio of a negative lens L3n disposed closest to the image side in the third lens group G3, with respect to the g-line and the F-line. vd1: Abbe number of a negative lens L3n disposed closest to the image side in the third lens group G3, with respect to the d-line.

ΔPgF2: anomalous dispersion of a negative lens L4n disposed closest to the object side in the fourth lens group G4. Here, ΔPgF2=PgF2−0.64833+0.00180×vd2. PgF2: partial dispersion ratio of a negative lens L4n disposed closest to the object side in the fourth lens group G4, with respect to the g-line and the F-line. vd2: Abbe number of a negative lens L4n disposed closest to the object side in the fourth lens group G4, with respect to the d-line.

The configuration of the present invention is intended to achieve a small size, an increase in a large aperture ratio and an increase in a high zooming ratio of a variable magnification optical system, and satisfactory correction of various aberrations. By setting the first lens group G1 to have a positive refractive power and setting the fifth lens group G5 to have a negative refractive power, it is easy to position the rear principal point of the variable magnification optical system on the object side. and the variable magnification optical system can be reduced in size. In addition, by setting the second lens group G2 to have a negative refractive power, during zooming from the wide-angle end to the telephoto end, it is easy to suppress a change in lateral magnification taken by a lens group disposed closer to the image side than the second lens group G2, and the variable magnification optical system can be made to have a high zooming ratio.

Next, by setting the third lens group G3 and the fourth lens group G4 to have a positive refractive power, it is easy to suppress a change in focal position that occurs during zooming from the wide-angle end to the telephoto end, and it is not necessary to forcibly increase the refractive power of the third lens group G3 or the fourth lens group G4. As a result, it is easy to correct aberrations in the third lens group G3 and the fourth lens group G4, and the variable magnification optical system can be made to have a large aperture ratio. In addition, by making the object side lens surface of the negative lens disposed closest to the image side in the third lens group G3 convex toward the image side and making the object side lens surface of the negative lens disposed closest to the object side in the fourth lens group G4 convex toward the image side, it is possible to efficiently suppress spherical aberration and on-axis chromatic aberration which may occur in the third lens group G3 and the fourth lens group G4, and the variable magnification optical system can be made to have a high zooming ratio and a large aperture ratio.

Conditional Expression (1) is a conditional expression for specifying an appropriate value with respect to a ratio of a total focal length of the third lens group G3 and the fourth lens group G4 to a focal length of the variable magnification optical system at the wide-angle end, and is related to an increase in the aperture ratio of the variable magnification optical system.

In a case where the refractive power of the third lens group G3 to the fourth lens group G4 is decreased by exceeding the upper limit of Conditional Expression (1), the off-axis aberration correction ability of the lens group disposed closer to the image side than the fourth lens group G4 is reduced, and it is difficult to correct the astigmatism, particularly at the telephoto end. In a case where the refractive power of the third lens group G3 to the fourth lens group G4 is increased by decreasing the value of Conditional Expression (1) below the lower limit, the on axis aberration correction ability of the lens group decreases, and it is particularly difficult to correct spherical aberration at the wide angle end to the telephoto end.

In Conditional Expression (1), the upper limit value is preferably 1.32 and the lower limit value is 0.67, and more preferably 1.19 and 0.74 in order to make the effect of the present invention more reliable.

Conditional Expression (2) is a conditional expression for specifying an appropriate value with respect to the ratio of the focal length of the fourth lens group G4 to the focal length of the third lens group G3, and is related to an increase in a zooming ratio of the variable magnification optical system.

In a case where the refractive power of the third lens group G3 is increased by exceeding the upper limit of Conditional Expression (2), the correction of the on axis aberration in the lens group causes deterioration of the off-axis aberration, and the comatic aberration, particularly at the telephoto end is difficult to correct. In a case where the refractive power of the fourth lens group G4 is increased by falling below the lower limit of Conditional Expression (2), correction of the on-axis aberration in the lens group causes deterioration of the off axis aberration, and particularly, correction of the astigmatism at the wide-angle end becomes difficult.

In Conditional Expression (2), the upper limit value is preferably 0.91 and the lower limit value is 0.34, and more preferably 0.87 and 0.35 in order to make the effect of the present invention more reliable.

Conditional Expression (3) is a conditional expression for specifying an appropriate value with respect to the sum of the chromatic aberration correcting ability of the third lens group G3 and the chromatic aberration correcting ability of the fourth lens group G4, and is related to an increase in a zooming ratio of the variable magnification optical system.

In a case where the sum of the anomalous dispersion of the negative lens L3n, which is disposed closest to the image side in the third lens group G3, and the anomalous dispersion of the negative lens L4n, which is disposed closest to the object side in the fourth lens group G4, is increased by exceeding the upper limit of Conditional Expression (3), the behavior of the third lens group G3 to the fourth lens group G4 on the short wavelength side in a case where the ray passes through the third lens group G3 to the fourth lens group G4 is excessive, and it is particularly difficult to correct the on-axis chromatic aberration at the telephoto end. In a case where the sum of the anomalous dispersion of the negative lens L3n, which is disposed closest to the image side in the third lens group G3, and the anomalous dispersion of the negative lens L4n, which is disposed closest to the object side in the fourth lens group G4, is decreased by falling below the lower limit of Conditional Expression (3), the behavior of the ray on the short wavelength side in a case where the ray passes through from the third lens group G3 to the fourth lens group G4 is insufficient, and it is particularly difficult to correct the on-axis chromatic aberration at the wide-angle end.

In Conditional Expression (3), in order to make the effect of the present invention more reliable, the upper limit value is preferably 0.0069 and the lower limit value is −0.0084, and it is more preferably 0.0068 and −0.0083.

Furthermore, the variable magnification optical system according to the embodiment of the present invention satisfies the following conditional expressions.

$$0.13 < \vert f 13 / f 4 L \vert < 1.25 \qquad ( 4 )$$

f13: total focal length of the first lens group G1 and the third lens group G3. Here, f13=1/(Σ(1/fn)), n=1 to 3. fn is a focal length of an n-th lens group.

f4L: total focal length of the fourth lens group G4 to the lens group disposed closest to the image side (hereinafter, last lens group GL). Here, f4L=1/(Σ(1/fn)), n=4 to L. fn is a focal length of an n-th lens group. fL is a focal length of the last lens group.

Conditional Expression (4) is a conditional expression for specifying an appropriate value with respect to a ratio of a total focal length of the first to third lens groups G1 to G3 to a total focal length of the fourth lens group G4 to the lens group (hereinafter, referred to as a last lens group GL) disposed closest to the image side, and is related to reduction in total length of the variable magnification optical system.

In a case where the refractive power of the fourth lens group to the last lens group GL is increased by exceeding the upper limit of Conditional Expression (4), the off-axis aberration correction ability in the fourth lens group G4 to the last lens group GL decreases, and particularly, it is difficult to correct comatic aberration at the telephoto end. In a case where the refractive power of the first lens group G1 to the third lens group G3 is increased by falling below the lower limit of Conditional Expression (4), the off-axis aberration correction ability of the first lens group G1 to the third lens group G3 decreases, and particularly, it is difficult to correct the astigmatism at the wide angle end.

In Conditional Expression (4), the upper limit value is preferably 0.95 and the lower limit value is 0.16, and more preferably 0.78 and 0.20 in order to make the effect of the present invention more reliable.

Furthermore, the variable magnification optical system according to the embodiment of the present invention satisfies the following conditional expressions.

$$1.12 < m 4 / m 3 < 1.56 \qquad ( 5 )$$

m4: amount of movement of the fourth lens group G4 during zooming from the wide-angle end to the telephoto end (movement toward the object side is positive)

m3: amount of movement of the third lens group G3 during zooming from the wide-angle end to the telephoto end (movement toward the object side is positive)

Conditional Expression (5) is a conditional expression for specifying an appropriate value with respect to a ratio between the total movement amount of the fourth lens group G4 during zooming and the total amount of movement of the third lens group G3 during zooming, and is related to the aberration correction ability of the variable magnification optical system.

In a case where the distance between the third lens group G3 and the fourth lens group G4 is separated at the wide angle end by exceeding the upper limit of Conditional Expression (5), the off-axis chief ray height with which light is incident on the fourth lens group G4 at the wide-angle end is excessively increased, and particularly, it is difficult to correct the astigmatism at the wide-angle end. In a case where the distance between the third lens group G3 and the fourth lens group G4 approaches at the wide-angle end by falling below the lower limit of Conditional Expression (5), the off-axis chief ray height with which light is incident on the fourth lens group G4 at the wide angle end is excessively reduced, and particularly, it is difficult to correct the astigmatism at the wide angle end.

In Conditional Expression (5), the upper limit value is preferably 1.53 and the lower limit value is 1.14, and more preferably 1.50 and 1.16 in order to make the effect of the present invention more reliable.

Furthermore, the variable magnification optical system according to the embodiment of the present invention satisfies the following conditional expressions.

$$1.17 < \vert f 5 \vert / f 4 < 2.89 \qquad ( 6 )$$

f5: focal length of the fifth lens group G5

f4: focal length of the fourth lens group G4

Conditional Expression (6) is a conditional expression for specifying an appropriate value with respect to a ratio of the focal length of the fifth lens group G5 to the focal length of the fourth lens group G4, and is related to an aberration correction ability of the variable magnification optical system.

In a case where the refractive power of the fourth lens group G4 is increased by exceeding the upper limit of Conditional Expression (6), the correction of the on axis aberration in the lens group causes deterioration of the off-axis aberration, and particularly, the comatic aberration at the telephoto end is difficult to correct. In a case where the refractive power of the fifth lens group G5 is increased by falling below the lower limit of Conditional Expression (6), correction of the on axis aberration in the lens group causes deterioration of the off-axis aberration, and particularly, comatic aberration at the wide-angle end becomes difficult.

In Conditional Expression (6), the upper limit value is preferably 2.75 and the lower limit value is 1.23, and more preferably 2.61 and 1.29 in order to make the effect of the present invention more reliable.

Furthermore, the variable magnification optical system according to the embodiment of the present invention satisfies the following conditional expressions.

$$0.83 < m 5 / m 4 < 1.24 \qquad ( 7 )$$

m5: amount of movement of the fifth lens group G5 during zooming from the wide-angle end to the telephoto end (movement toward the object side is positive)

m4: amount of movement of the fourth lens group G4 during zooming from the wide-angle end to the telephoto end (movement toward the object side is positive)

Conditional Expression (7) is a conditional expression for specifying an appropriate value with respect to a ratio between the total movement amount of the fifth lens group G5 during zooming and the total amount of movement of the fourth lens group G4 during zooming, and is related to the aberration correction ability of the variable magnification optical system.

In a case where the distance between the fourth lens group G4 and the fifth lens group G5 is separated at the wide-angle end by exceeding the upper limit of Conditional Expression (7), the burden of correcting the off-axis aberration of the fifth lens group G5 at the wide-angle end increases, and particularly, it is difficult to correct the comatic aberration at the wide-angle end. In a case where the distance between the fourth lens group G4 and the fifth lens group G5 is separated at the telephoto end by falling below the lower limit of Conditional Expression (7), the burden of correcting the off-axis aberration of the fifth lens group G5 at the telephoto end increases, and particularly, it is difficult to correct the comatic aberration at the telephoto end.

In Conditional Expression (7), the upper limit value is preferably 1.22 and the lower limit value is 0.84, and more preferably 1.19 and 0.86 in order to make the effect of the present invention more reliable.

Furthermore, the variable magnification optical system according to the embodiment of the present invention satisfies the following conditional expressions.

$$1.34 < \vert f 5 L \vert / fW < 4.25 \qquad ( 8 )$$

f5L: total focal length of the fifth lens group G5 to the last lens group GL. Here, f5L=1/(Σ(1/fn)), n=5 to L. fn is a focal length of an n-th lens group. fL is a focal length of the last lens group GL.

fW: focal length of the variable magnification optical system at the wide angle end

Conditional Expression (8) is a conditional expression for specifying an appropriate value with respect to a ratio of a total focal length of the fifth lens group G5 to the last lens group GL to a focal length of the variable magnification optical system at the wide-angle end, and is related to an aberration correction ability of the variable magnification optical system.

In a case where the refractive power of the fifth lens group G5 to the last lens group GL is reduced by exceeding the upper limit of Conditional Expression (8), the on-axis aberration correction ability in the last lens group GL is reduced, and particularly, it is difficult to correct spherical aberration at the telephoto end. In a case where the refractive power of the fifth lens group G5 to the last lens group GL is increased by falling below the lower limit of Conditional Expression (8), the off-axis aberration correction ability in the last lens group GL decreases, and particularly, it is difficult to correct the astigmatism at the wide-angle end.

In Conditional Expression (8), the upper limit value is preferably 3.84 and the lower limit value is 1.49, and more preferably 3.46 and 1.65 in order to make the effect of the present invention more reliable.

Furthermore, the variable magnification optical system according to the embodiment of the present invention satisfies the following conditional expressions.

$$0.51 < bfW / fW < 1.85 \qquad ( 9 )$$

bfW: back focus of variable magnification optical system at wide-angle end

fW: focal length of the variable magnification optical system at the wide-angle end

Conditional Expression (9) is a conditional expression for specifying an appropriate value for a ratio of a back focus at the wide angle end to a focal length at the wide angle end of the variable magnification optical system, and is related to an aberration correction ability of the variable magnification optical system.

In a case where the distance between the last lens group GL and the image surface exceeds the upper limit of Conditional Expression (9), the off axis aberration correction ability in the last lens group GL decreases, and it is difficult to correct astigmatism, particularly at the wide-angle end or the telephoto end. In a case where the distance between the last lens group GL and the image surface falls below the lower limit of Conditional Expression (9) and becomes close, the on-axis aberration correction ability in the last lens group GL decreases, and it is particularly difficult to correct the spherical aberration at the wide angle end or the telephoto end.

In Conditional Expression (9), the upper limit value is preferably 1.76 and the lower limit value is 0.53, and more preferably 1.68 and 0.56 in order to make the effect of the present invention more reliable.

Furthermore, the variable magnification optical system according to the embodiment of the present invention satisfies the following conditional expressions.

$$28.56 < ω W < 44.11 \qquad ( 10 )$$

ωW: half angle of view at a wide angle end of the variable magnification optical system. Here, ωW=arctan(Y/fW)/2. Y is a maximum image height at a wide-angle end of the variable magnification optical system. fW is a focal length of the variable magnification optical system at a wide-angle end.

Conditional Expression (10) is a conditional expression for specifying an appropriate value with respect to a half angle of view at the wide-angle end, and is related to an aberration correction ability of the variable magnification optical system.

In a case where the half angle of view exceeds the upper limit of Conditional Expression (10) and becomes large at the wide-angle end, the burden of off-axis aberration correction taken by the first lens group G1 to the second lens group G2 and the fifth lens group G5 to the last lens group GL increases, and it is particularly difficult to correct the astigmatism at the wide-angle end or the telephoto end. In a case where the half angle of view exceeds the lower limit of Conditional Expression (10) and becomes small at the wide-angle end, the burden of the on-axis aberration correction taken on by the second lens group G2 to the fourth lens group G4 increases, and it becomes difficult to correct the spherical aberration, particularly at the wide-angle end to the telephoto end.

In Conditional Expression (10), the upper limit value is preferably 43.38 and the lower limit value is 29.15, and more preferably 42.65 and 29.74 in order to make the effect of the present invention more reliable.

The variable magnification optical system of the embodiment of the present invention discloses a configuration in which the fourth lens group G4 or the fifth lens group G5 is moved along the optical axis during focusing from the infinity end to the closest object end. As a result, it is possible to achieve both reduction in size of the variable magnification optical system and satisfactory correction of various aberrations in the variable magnification optical system. In a case where the fourth lens group G4 is moved during focusing, it is easy to suppress the variation related to the focusing of the off-axis ray polar angle of the fourth lens group G4, and it is possible to easily correct the astigmatism particularly at the wide-angle end. In a case where the fifth lens group G5 is moved during focusing, it is easy to suppress the variation in the focusing of the on-axis ray polar angle of the fifth lens group G5, and it is possible to easily correct the spherical aberration particularly at the telephoto end.

In the variable magnification optical system according to the embodiment of the present invention, the configuration is disclosed in which the object side lens surface of the negative lens L3n disposed closest to the image side in the third lens group G3 is in contact with the air. Accordingly, it is easy to provide a difference in refractive index before and after the surface, and it is possible to easily correct spherical aberration and on-axis chromatic aberration occurring in the third lens group G3.

In the variable magnification optical system according to the embodiment of the present invention, the configuration is disclosed in which the object side lens surface of the negative lens L4n disposed closest to the object side in the fourth lens group G4 is in contact with air. Accordingly, it is easy to provide a difference in refractive index before and after the surface, and it is possible to easily correct spherical aberration and on-axis chromatic aberration occurring in the fourth lens group G4.

In the variable magnification optical system of the embodiment of the present invention, the first lens group G1 has a configuration in which at least one negative lens is provided. Accordingly, it is possible to suppress occurrence of chromatic aberration by the first lens group G1, and it is possible to facilitate correction of the magnification chromatic aberration particularly at the telephoto end.

In the variable magnification optical system of the embodiment of the present invention, the aperture diaphragm S is provided at a position closest to the object side in the third lens group G3, and the third lens group G3 and the aperture diaphragm S are configured to move as a single unit during zooming. As a result, it is easy to bring the entrance pupil position of the variable magnification optical system closer to the object side, and it is possible to suppress the burden of the off-axis aberration correction of the first lens group G1 to the second lens group G2, and it is possible to easily correct the astigmatism, particularly at the wide-angle end.

In the variable magnification optical system of the embodiment of the present invention, the fifth lens group G5 has a configuration in which at least one positive lens is provided. Accordingly, it is possible to suppress occurrence of chromatic aberration by the fifth lens group G5, and it is possible to easily suppress fluctuation of the on. axis chromatic aberration particularly at the time of focusing at the wide-angle end to the telephoto end.

In the variable magnification optical system of the embodiment of the present invention, a configuration in which the second lens group G2 is fixed with respect to the image surface during zooming from the wide-angle end to the telephoto end is disclosed. As a result, it is possible to maintain equilibrium between the change in lateral magnification, which is provided by the second lens group G2, and the change in lateral magnification, which is provided by the lens group disposed closer to the image side than the second lens group G2, which occurs during zooming, and it is possible to facilitate correction of spherical aberration, particularly at the wide-angle end to the telephoto end.

In the variable magnification optical system of the embodiment of the present invention, a configuration in which the last lens group GL is fixed with respect to the image surface during zooming from the wide-angle end to the telephoto end is disclosed. As a result, it is possible to impart linearity to a change in the off-axis aberration correction burden taken on by the last lens group GL, which occurs during zooming, and it is possible to facilitate astigmatism correction, particularly in the intermediate region.

In the variable magnification optical system according to the embodiment of the present invention, the third lens group G3 has a configuration in which the third lens group G3 has a vibration reduction lens group having a positive refractive power and movable in a direction substantially perpendicular to the optical axis. It is possible to perform image blur correction by moving the vibration reduction lens group in a direction substantially perpendicular to the optical axis. As a result, the correction burden of various aberrations that the vibration reduction lens group bears when vibration reduction is not performed can be suppressed. In particular, by matching the refractive power sign of the vibration reduction lens group with that of the third lens group G3, the vibration reduction lens group can be disposed without hindering the zooming burden of the entire third lens group G3, thereby making it easier to achieve both aberration correction during vibration reduction and aberration correction when vibration reduction is not performed.

The imaging apparatus according to the embodiment of the present invention is configured to be equipped with the above-described variable magnification optical system. Accordingly, it is possible to provide an imaging apparatus comprising a variable magnification optical system that is small in size, achieves an increase in a large aperture ratio and a high zooming ratio of the variable magnification optical system, and satisfactorily corrects various aberrations.

Next, configurations of examples of the variable magnification optical system according to the embodiment of the present invention will be described. In the following description, the lens configuration will be described in order from the object side to the image side.

In [Surface data], the surface number is a number of a lens surface or an aperture diaphragm S counted from the object side, r is a curvature radius of each surface, d is a vertex interval between surfaces, nd is a refractive index with respect to the d-line (wavelength of 587.56 nm), vd is an Abbe number with respect to the d-line, and PgF indicates a partial dispersion ratio with respect to the g-line (wavelength of 435.8 nm) and the F-line (wavelength of 486.1 nm).

An asterisk (*) attached to a surface number indicates that the lens surface shape is an aspherical surface. In addition, BF represents a back focus.

The (diaphragm) attached to the surface number indicates that the aperture diaphragm S is located at that position. A curvature radius with respect to the plane or the aperture diaphragm S is denoted by ∞ (infinity).

[Aspherical surface data] shows each coefficient value for giving the aspherical surface shape of the lens surface marked with * in [Surface data]. In a case where a displacement from the optical axis in a direction perpendicular to the optical axis is y, a displacement (sag) from an intersection of the optical axis and the aspherical surface in an optical axis direction is z, a curvature radius of a reference spherical surface is r, a conic coefficient is K, and fourth-order, sixth-order, . . . , twentieth-order aspherical coefficients are A4, A6, . . . , A20, respectively, it is assumed that coordinates of the aspherical surface are represented by the following expression.

$$z = ( {y}^{⋀} 2 / r ) / [ 1 + \{ 1 - ( 1 + K ) \times {( y / r )}^{⋀} 2 \} ] + Σ ( An \times {y}^{⋀} n ) , \\ n = 4 , 6 , … , 20$$

[Various types of data] indicate values such as a zoom ratio and a focal length in each focal length state.

The [Variable Distance Data] shows the variable distance and the BF value in each focal length state.

The [Lens group data] shows the surface number closest to the object side in each lens group and the total focal length of the entire group.

In addition, in all the values of the specifications described below, unless otherwise noted, the units of the focal length f, the curvature radius r, the vertex interval d, and other lengths are millimeters (mm), but the present invention is not limited thereto since the same optical performance can be obtained in both the proportional magnification and the proportional reduction in the optical system.

In the lens configuration diagram corresponding to each example, a solid line arrow indicates a path of a lens group during zooming from a wide-angle end to a telephoto end, a broken line arrow with a kinked line indicates a path of a lens group during focusing from the infinity end to the closest object end, a broken line arrow without a kinked line indicates a path of a lens group during image blur correction, S is an aperture diaphragm, I is an image surface, and a one dot chain line passing through the center is an optical axis.

In addition, in the aberration diagrams corresponding to the respective examples, d, g, and C represent a d-line, a g-line, and a C-line, respectively, and ΔS and ΔM represent a sagittal image surface and a meridional image surface, respectively.

### Example 1

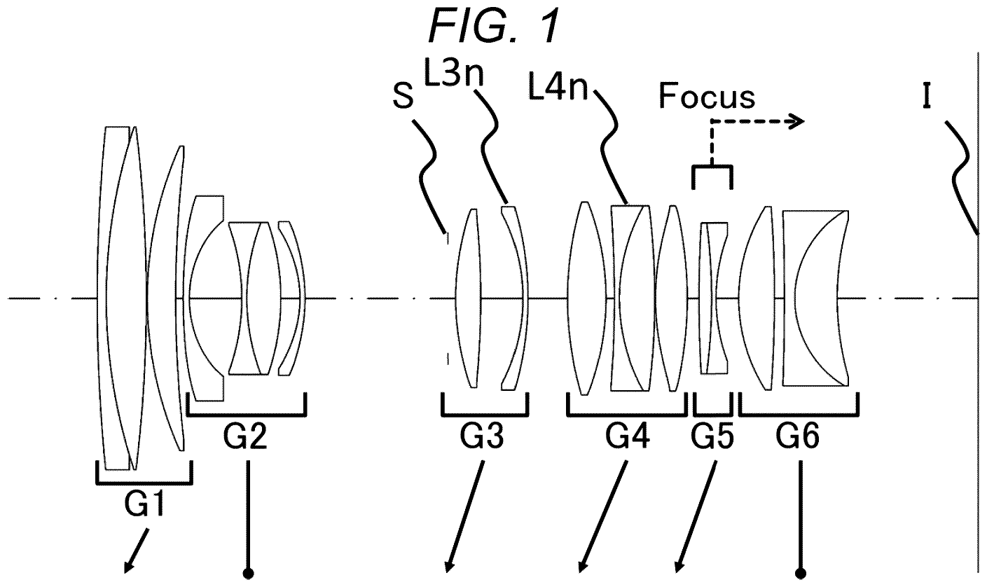

FIG. 1 is a lens configuration diagram of a variable magnification optical system of Example 1 of the present invention.

In Example 1, the zoom lens consists of, in order from the object side, a first lens group G1 having a positive refractive power, a second lens group G2 having a negative refractive power, an aperture diaphragm S, a third lens group G3 having a positive refractive power, a fourth lens group G4 having a positive refractive power, a fifth lens group G5 having a negative refractive power, and a sixth lens group G6 having a negative refractive power. The sixth lens group G6 corresponds to the last lens group GL.

During zooming from the wide-angle end to the telephoto end, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 increases, and the distance between the fifth lens group G5 and the sixth lens group G6 increases. The second lens group G2 and the sixth lens group G6 are fixed with respect to the image surface I during zooming.

During focusing from the infinity end to the closest object end, the fifth lens group G5 moves to the image side along the optical axis.

The first lens group G1 consists of, in order from the object side, a cemented lens of a negative meniscus lens convex toward the object side and a biconvex lens, and a positive meniscus lens convex toward the object side.

The second lens group G2 consists of, in order from the object side, a negative meniscus lens convex toward the object side, a cemented lens of a biconcave lens and a biconvex lens, and a negative meniscus lens convex toward the image side.

The third lens group G3 consists of an aperture diaphragm S, a biconvex lens, and a negative meniscus lens L3n convex toward the image side, in order from the object side.

The fourth lens group G4 consists of a biconvex lens, a cemented lens of a biconcave lens L4n and a biconvex lens, and a biconvex lens, in order from the object side.

The fifth lens group G5 consists of a cemented lens of a biconvex lens and a biconcave lens, in order from the object side.

The sixth lens group G6 consists of a biconvex lens, and a cemented lens of a biconcave lens and a positive meniscus lens convex toward the object side, in order from the object side.

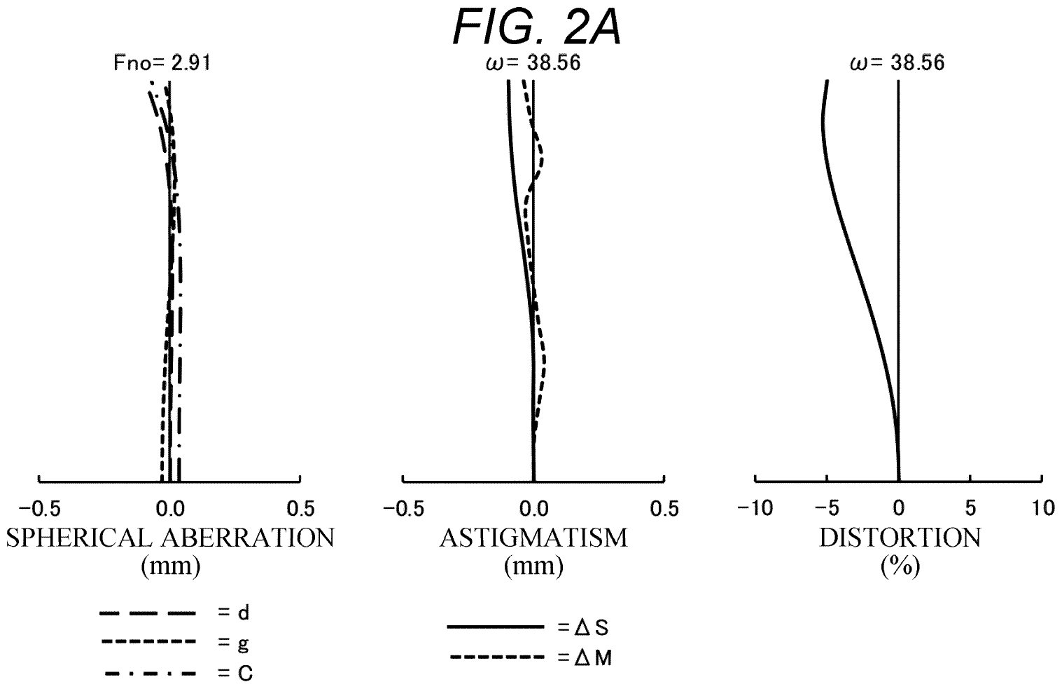

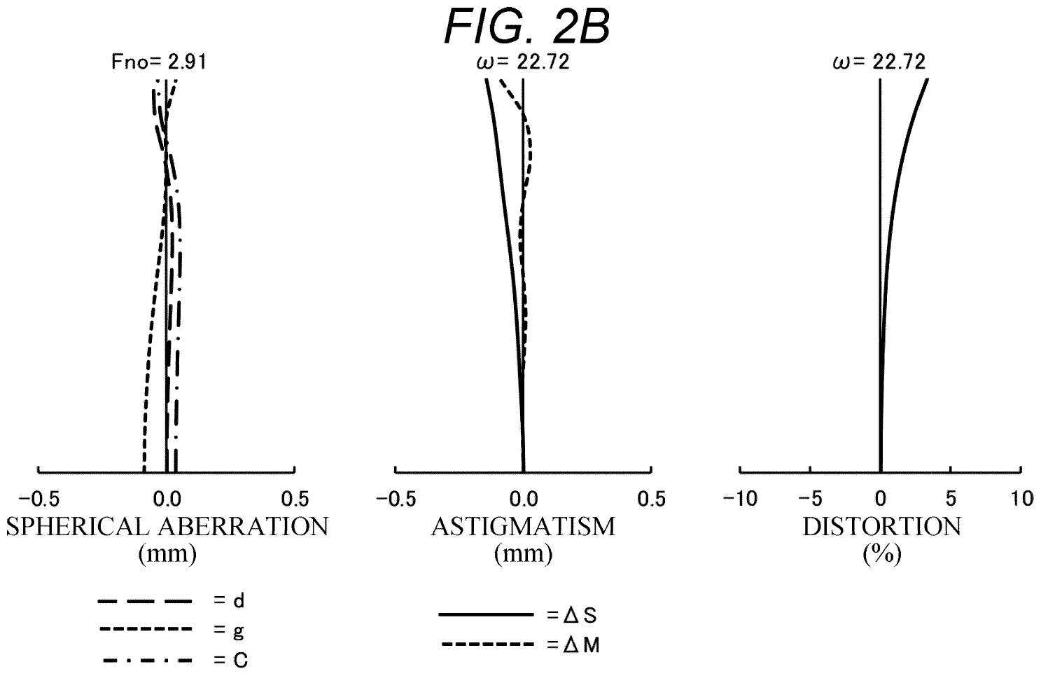

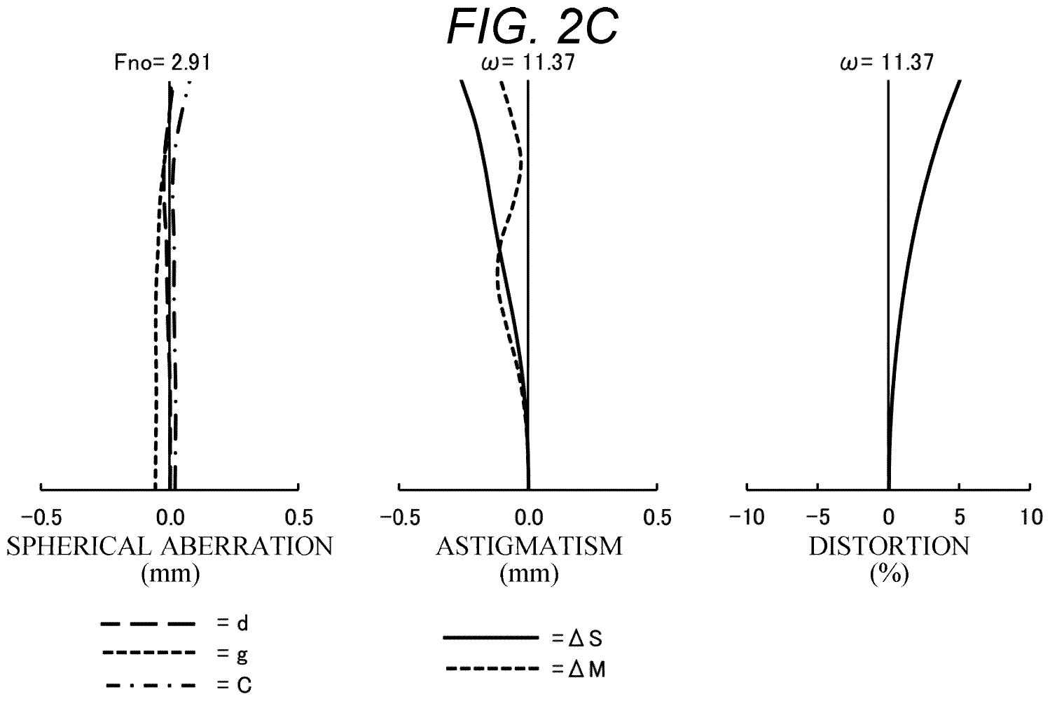

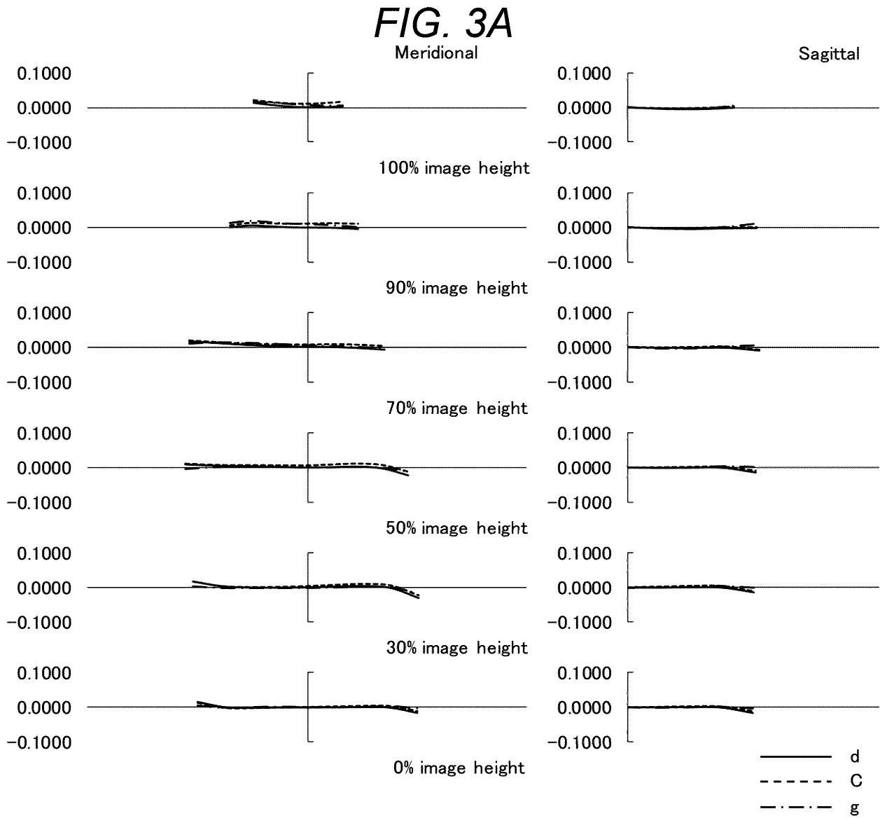

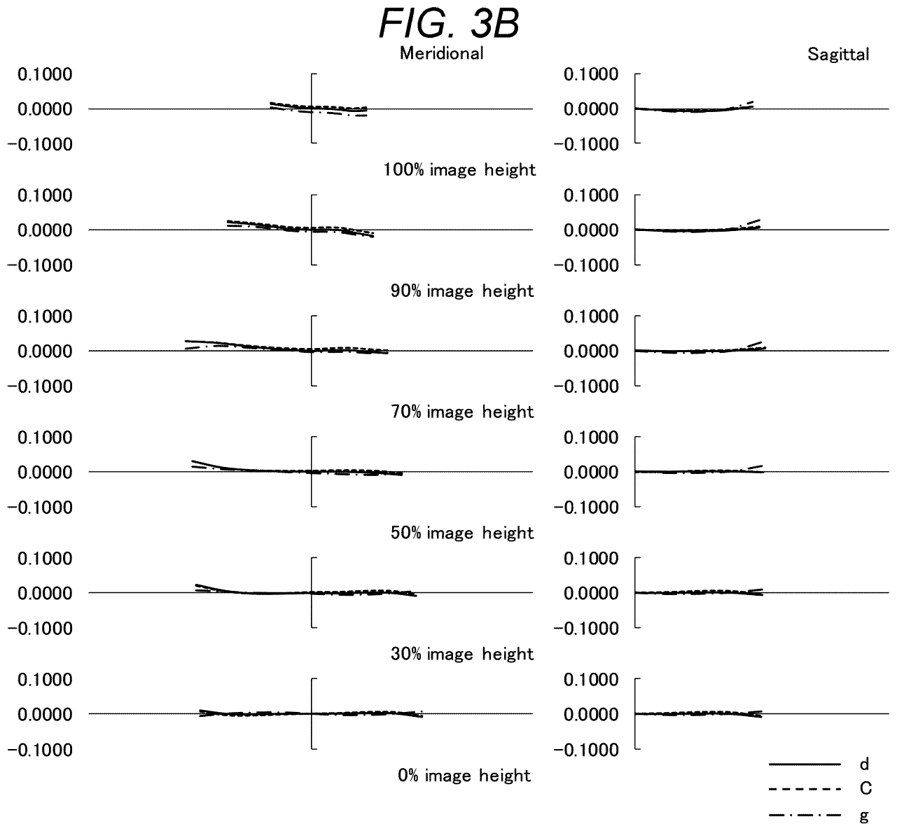

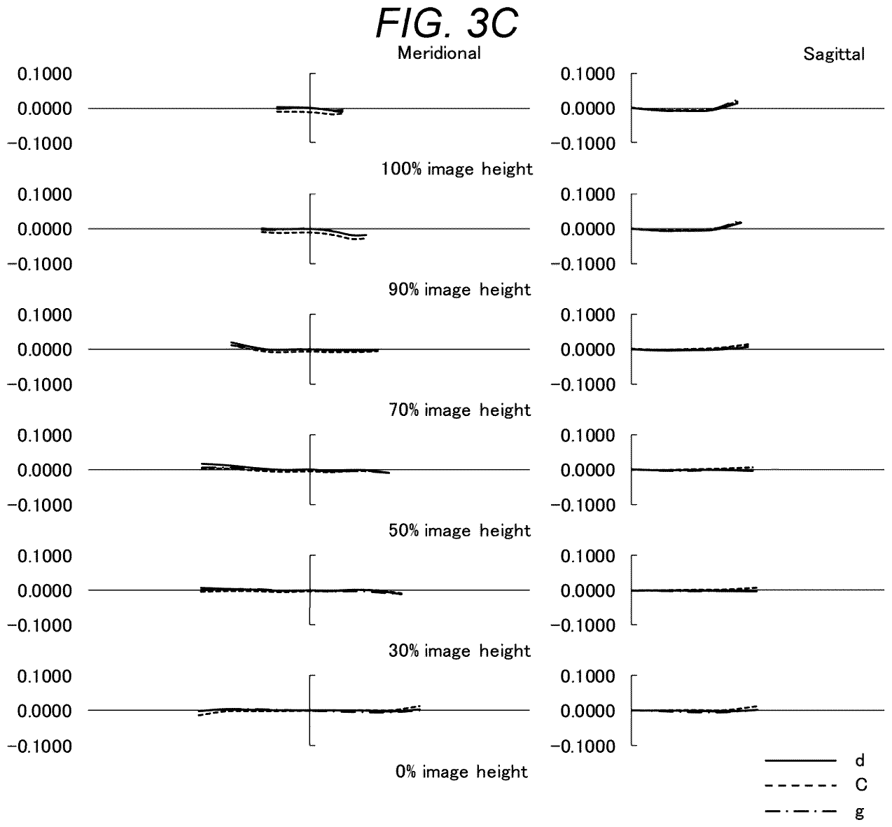

FIGS. 2A, 2B, and 2C are longitudinal aberration diagrams in a case where an infinite distance object is in focus at a wide-angle end, an intermediate focal length, and a telephoto end, respectively, according to Example 1. FIGS. 3A, 3B, and 3C are lateral aberration diagrams in a case where an infinite distance object is in focus at a wide-angle end, an intermediate focal length, and a telephoto end, respectively, according to Example 1. From the aberration diagrams, it can be seen that in the variable magnification optical system according to the present example, various aberrations are satisfactorily corrected from the wide-angle end to the telephoto end, and excellent image formation performance is obtained.

The specification values of the variable magnification optical system of Example 1 of the present invention are shown below.

### Numerical Example 1

Unit: mm

[Surface data]

| Surface number | r | d | nd | vd | PgF |
|---|---|---|---|---|---|
| Object surface | ∞ | (d0) | | | |
| 1 | 360.2963 | 1.8000 | 1.84666 | 23.78 | 0.6192 |
| 2 | 111.3000 | 7.9378 | 1.43700 | 95.10 | 0.5336 |
| 3 | −287.9574 | 0.2000 | | | |
| 4 | 76.2922 | 5.6161 | 1.85033 | 42.70 | 0.5646 |
| 5 | 256.0148 | (d5) | | | |
| 6* | 123.0252 | 1.2084 | 1.77377 | 47.17 | 0.5557 |
| 7* | 23.2300 | 10.4000 | | | |
| 8 | −42.7806 | 1.0000 | 1.77250 | 49.63 | 0.5504 |
| 9 | 43.5593 | 6.7372 | 1.78880 | 28.43 | 0.6009 |
| 10 | −46.5779 | 3.8000 | | | |
| 11* | −22.4247 | 1.0000 | 1.69350 | 53.18 | 0.5482 |
| 12* | −34.9452 | (d12) | | | |
| 13(diaphragm) | ∞ | 1.5000 | | | |
| 14* | 53.6920 | 4.9623 | 1.69350 | 53.18 | 0.5482 |
| 15* | −167.7039 | 8.2650 | | | |
| 16 | −37.5017 | 1.0000 | 1.72342 | 37.99 | 0.5820 |
| 17 | −65.4124 | (d17) | | | |
| 18 | 69.4007 | 7.6084 | 1.49700 | 81.61 | 0.5389 |
| 19 | −53.7860 | 1.6515 | | | |
| 20 | −255.9684 | 1.0000 | 1.73037 | 32.23 | 0.5899 |
| 21 | 38.9123 | 6.9842 | 1.43700 | 95.10 | 0.5336 |
| 22 | −155.2762 | 0.1500 | | | |
| 23* | 50.6600 | 6.2967 | 1.59201 | 67.02 | 0.5358 |
| 24* | −74.2726 | (d24) | | | |
| 25 | 260.8960 | 2.4925 | 1.90110 | 27.06 | 0.6072 |
| 26 | −118.1175 | 1.0000 | 1.69680 | 55.46 | 0.5426 |
| 27 | 37.0787 | (d27) | | | |
| 28 | 34.9425 | 7.0700 | 1.61997 | 63.88 | 0.5426 |
| 29 | −259.7850 | 1.9747 | | | |
| 30 | −500.0000 | 2.0525 | 1.91082 | 35.25 | 0.5822 |
| 31 | 20.6760 | 8.4087 | 1.68948 | 31.02 | 0.5987 |
| 32* | 58.8604 | (BF) | | | |
| Image surface | ∞ | | | | |

[Aspherical Surface Data]

| | Surface 6 | Surface 7 | Surface 11 | Surface 12 | Surface 14 |
|---|---|---|---|---|---|
| K | 0.00000 | −1.00000 | −1.00000 | 0.00000 | 0.00000 |
| A4 | 1.85091E−07 | 8.62972E−06 | 2.24402E−05 | 2.70163E−05 | −1.27386E−06 |
| A6 | 4.26604E−08 | 8.64590E−08 | −1.47419E−07 | −1.55510E−07 | −5.12422E−09 |
| A8 | −2.21868E−10 | −6.91508E−10 | 3.52063E−10 | 4.98439E−10 | 4.41803E−11 |
| A10 | 6.01194E−13 | 6.99967E−12 | 1.85113E−13 | −6.83300E−13 | −1.61037E−13 |
| A12 | −4.78015E−16 | −3.41025E−14 | −1.32511E−15 | −2.83775E−16 | 5.07015E−17 |
| A14 | −7.32009E−19 | −3.35498E−17 | −7.28653E−18 | −1.19661E−18 | −2.39015E−19 |
| A16 | −8.78114E−22 | 1.25237E−18 | −1.96704E−20 | −7.57143E−21 | 2.17445E−21 |
| A18 | 7.22224E−24 | −5.28500E−21 | 1.21596E−22 | 9.37658E−25 | 8.42503E−24 |
| A20 | −6.75429E−27 | 7.25132E−24 | 5.37674E−26 | 1.60524E−25 | −1.61985E−26 |

| | Surface 15 | Surface 23 | Surface 24 | Surface 32 |
|---|---|---|---|---|
| K | 0.00000 | 0.00000 | 0.00000 | 0.00000 |
| A4 | 5.74097E−07 | −3.14483E−06 | 2.83152E−06 | 1.16496E−06 |
| A6 | −5.16686E−09 | −1.98499E−10 | 8.67123E−10 | −7.65792E−09 |
| A8 | 3.82098E−11 | −5.30620E−12 | −1.06632E−11 | −8.49581E−12 |
| A10 | −1.08565E−13 | −2.87197E−14 | −4.64511E−14 | 7.86908E−13 |
| A12 | −2.03240E−16 | 1.08836E−16 | 1.87428E−16 | −6.73161E−15 |
| A14 | 4.83533E−19 | −4.94374E−19 | −1.02921E−19 | 2.04431E−17 |
| A16 | 1.76105E−21 | −8.27912E−22 | −6.14286E−22 | 8.18003E−21 |
| A18 | 4.40341E−24 | 1.11878E−23 | −1.08374E−25 | −1.79202E−22 |
| A20 | −6.76496E−27 | −2.44641E−26 | −2.83106E−27 | 2.86343E−25 |

[Various Types of Data]
Zoom ratio 3.59

| | Wide angle | Intermediate | Telephoto |
|---|---|---|---|
| Focal length | 28.55 | 50.00 | 102.37 |
| F number | 2.91 | 2.91 | 2.91 |
| Total angle of view 2ω | 77.11 | 45.44 | 22.75 |
| Image height Y | 21.63 | 21.63 | 21.63 |
| Total length of lens | 174.47 | 191.98 | 216.16 |

[Variable Distance Data]

| | Wide angle | Intermediate | Telephoto |
|---|---|---|---|
| d0 | ∞ | ∞ | ∞ |
| d5 | 1.5000 | 19.0108 | 43.1924 |
| d12 | 28.3520 | 15.6537 | 1.5000 |
| d17 | 7.8170 | 2.8418 | 1.5000 |
| d24 | 2.3042 | 2.1000 | 5.7383 |
| d27 | 4.4853 | 22.3631 | 34.2202 |
| BF | 27.8972 | 27.8972 | 27.8972 |

[Lens Group Data]

| Group | Starting surface | Focal length |
|---|---|---|
| G1 | 1 | 122.23 |
| G2 | 6 | −24.48 |
| G3 | 13 | 98.83 |
| G4 | 18 | 38.56 |
| G5 | 25 | −74.21 |
| G6 | 28 | −2027.04 |

### Example 2

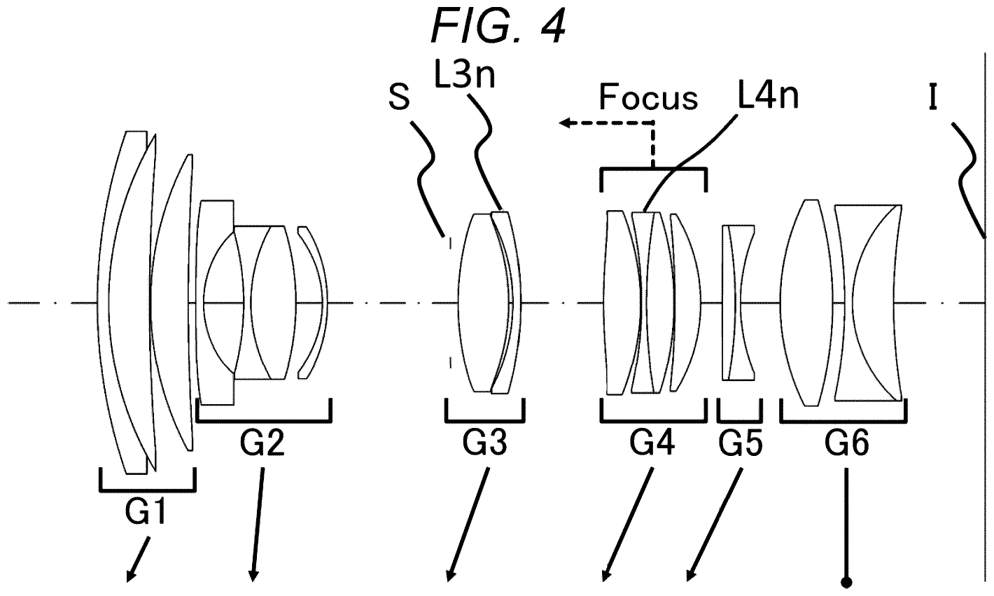

FIG. 4 is a lens configuration diagram of a variable magnification optical system of Example 2 of the present invention.

In Example 2, the zoom lens consists of, in order from the object side, a first lens group G1 having a positive refractive power, a second lens group G2 having a negative refractive power, an aperture diaphragm S, a third lens group G3 having a positive refractive power, a fourth lens group G4 having a positive refractive power, a fifth lens group G5 having a negative refractive power, and a sixth lens group G6 having a negative refractive power. The sixth lens group G6 corresponds to the last lens group GL.

During zooming from the wide-angle end to the telephoto end, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 decreases, and the distance between the fifth lens group G5 and the sixth lens group G6 increases. The sixth lens group G6 remains stationary with respect to the image surface I during zooming.

During focusing from the infinity end to the closest object end, the fourth lens group G4 moves to the object side along the optical axis.

The first lens group G1 consists of, in order from the object side, a cemented lens of a negative meniscus lens convex toward the object side and a positive meniscus lens convex toward the object side, and a positive meniscus lens convex toward the object side.

The second lens group G2 consists of, in order from the object side, a negative meniscus lens convex toward the object side, a cemented lens of a biconcave lens and a biconvex lens, and a negative meniscus lens convex toward the image side.

The third lens group G3 consists of an aperture diaphragm S, a biconvex lens, and a negative meniscus lens L3n convex toward the image side, in order from the object side.

The fourth lens group G4 consists of, in order from the object side, a biconvex lens, a cemented lens of a biconcave lens L4n and a biconvex lens, and a positive meniscus lens convex toward the image side.

The fifth lens group G5 consists of a cemented lens of a biconvex lens and a biconcave lens, in order from the object side.

The sixth lens group G6 consists of a biconvex lens, and a cemented lens of a biconcave lens and a positive meniscus lens convex toward the object side, in order from the object side.

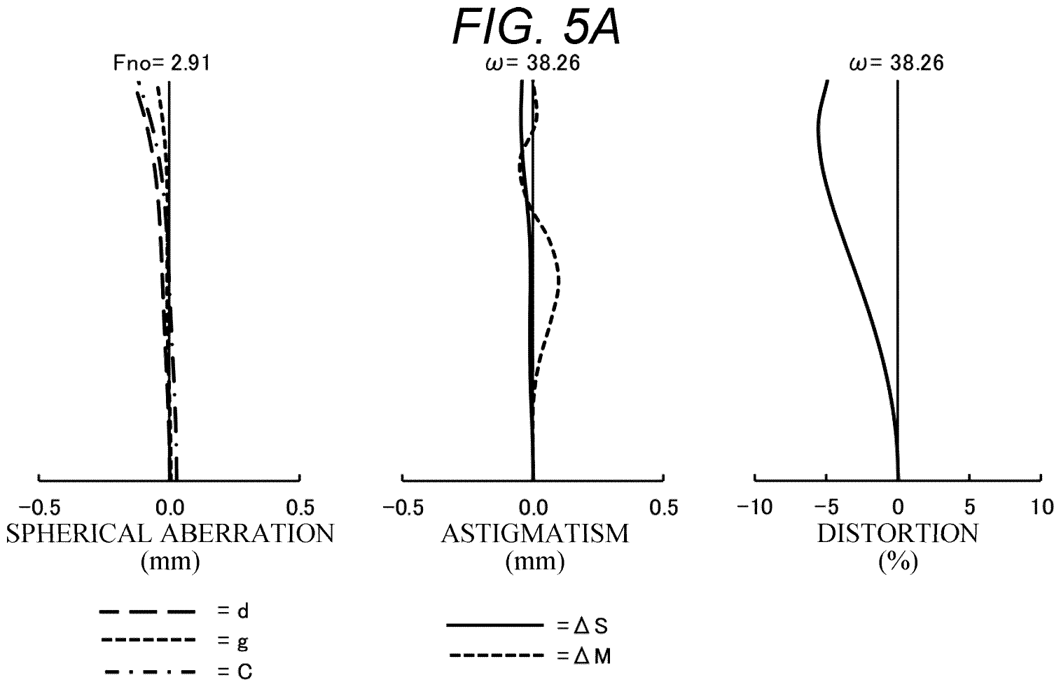

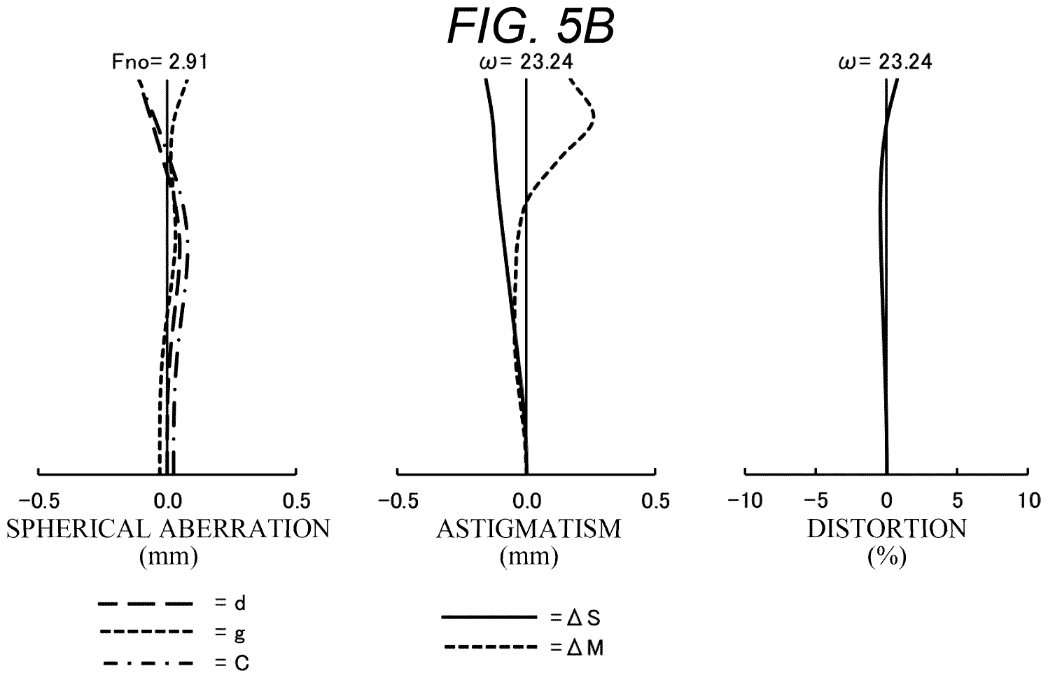

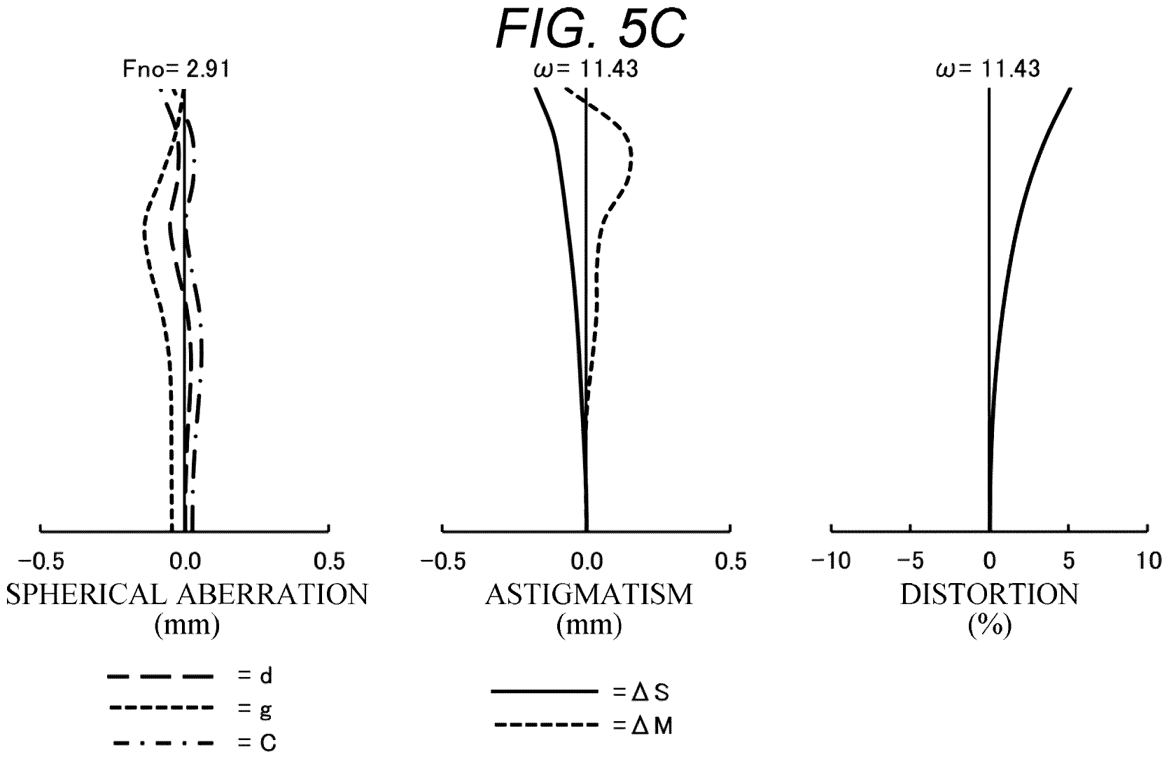

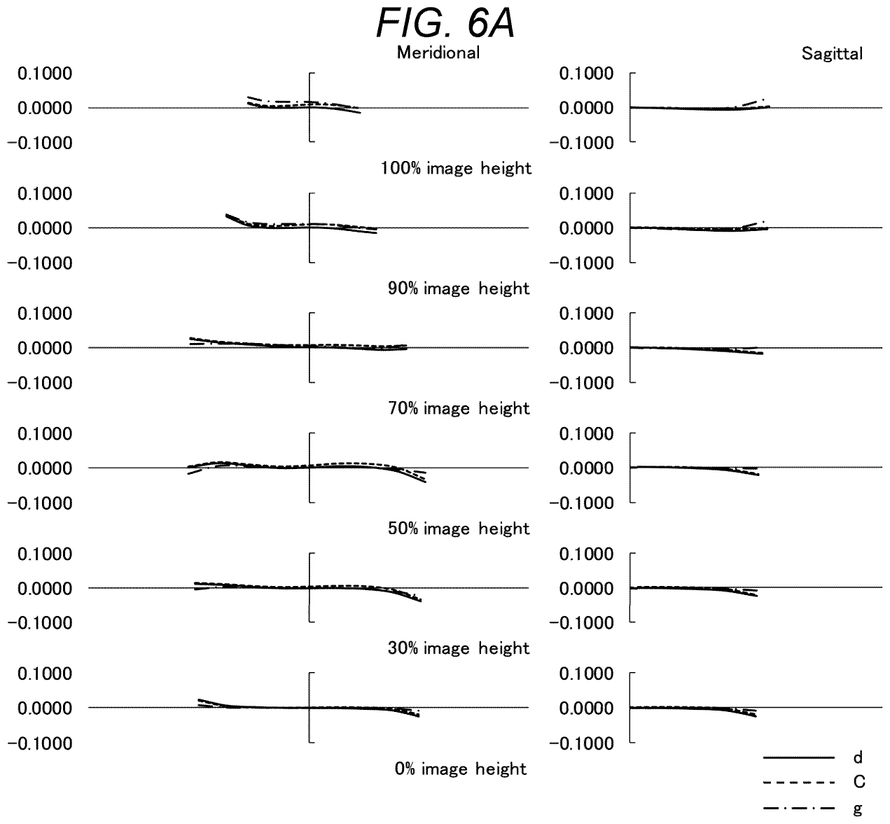

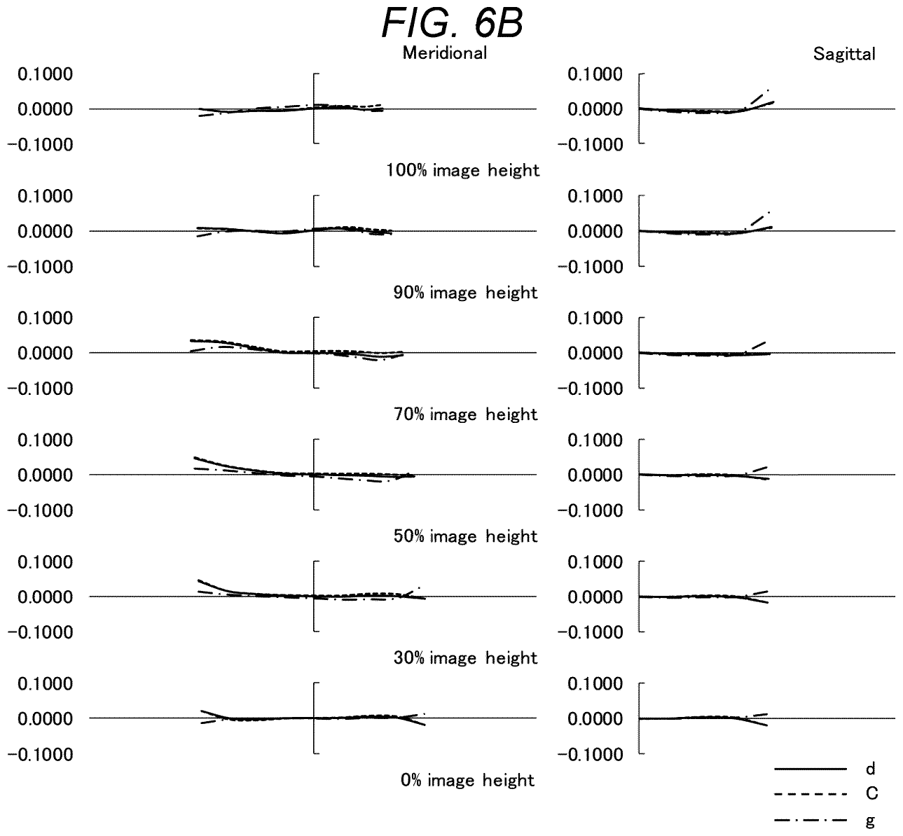

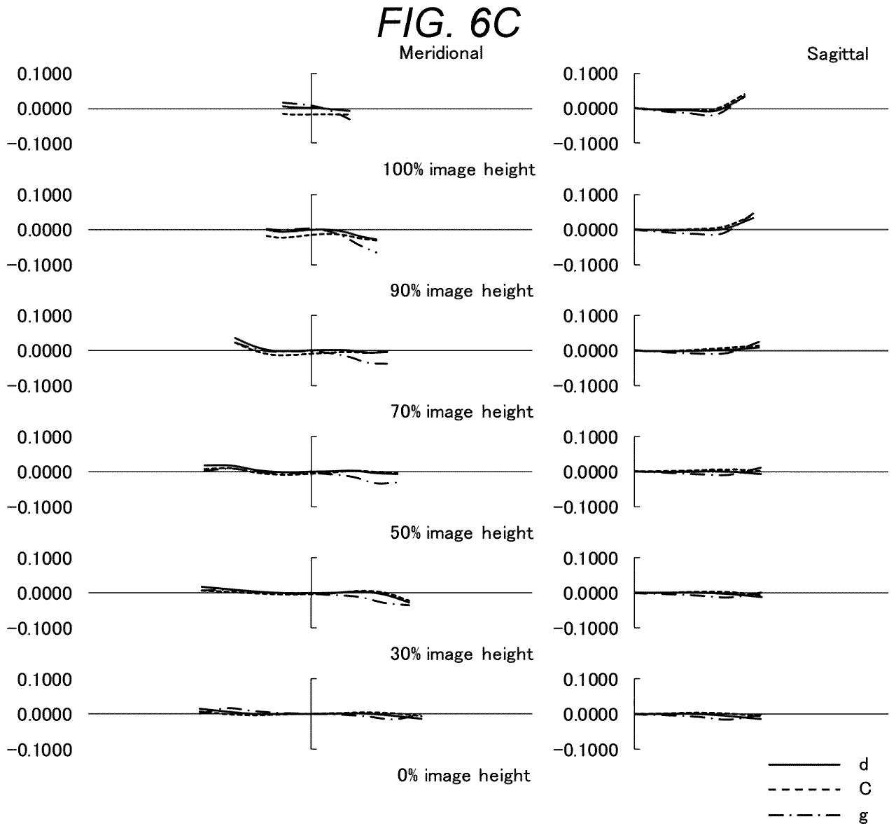

FIGS. 5A, 5B, and 5C are longitudinal aberration diagrams in a case where an infinite distance object is in focus at a wide-angle end, an intermediate focal length, and a telephoto end, respectively, according to Example 2. FIGS. 6A, 6B, and 6C are lateral aberration diagrams in a case where an infinite distance object is in focus at a wide-angle end, an intermediate focal length, and a telephoto end, respectively, according to Example 2. From the aberration diagrams, it can be seen that in the variable magnification optical system according to the present example, various aberrations are satisfactorily corrected from the wide-angle end to the telephoto end, and excellent image formation performance is obtained.

The specification values of the variable magnification optical system of Example 2 of the present invention are shown below.

### Numerical Example 2

Unit: mm

[Surface data]

| Surface number | r | d | nd | vd | PgF |
|---|---|---|---|---|---|
| Object surface | ∞ | (d0) | | | |
| 1 | 105.4246 | 2.2000 | 1.84666 | 23.78 | 0.6192 |
| 2 | 65.6220 | 7.9883 | 1.43700 | 95.10 | 0.5336 |
| 3 | 380.4578 | 0.2000 | | | |
| 4 | 62.8083 | 7.3452 | 1.69680 | 55.46 | 0.5426 |
| 5 | 463.1598 | (d5) | | | |
| 6* | 794.8344 | 1.5000 | 1.77377 | 47.17 | 0.5557 |
| 7* | 20.8730 | 7.8298 | | | |
| 8 | −52.7479 | 1.4000 | 1.77250 | 49.63 | 0.5504 |
| 9 | 31.7096 | 8.7901 | 1.78880 | 28.43 | 0.6009 |
| 10 | −50.8125 | 5.1631 | | | |
| 11* | −21.5511 | 1.0000 | 1.69350 | 53.18 | 0.5482 |
| 12* | −30.7363 | (d12) | | | |
| 13(diaphragm) | ∞ | 1.5000 | | | |
| 14* | 54.5279 | 9.8495 | 1.59201 | 67.02 | 0.5358 |
| 15* | −40.4818 | 0.8101 | | | |
| 16 | −36.2770 | 1.5000 | 1.73800 | 32.33 | 0.5900 |
| 17 | −65.8424 | (d17) | | | |
| 18* | 109.0144 | 7.2343 | 1.59201 | 67.02 | 0.5358 |
| 19* | −43.4869 | 0.1500 | | | |
| 20 | −79.3194 | 1.0000 | 1.73800 | 32.33 | 0.5900 |
| 21 | 109.0743 | 5.3589 | 1.43700 | 95.10 | 0.5336 |
| 22 | −58.5192 | 0.1500 | | | |
| 23 | −167.4864 | 5.0286 | 1.43700 | 95.10 | 0.5336 |
| 24 | −34.4017 | (d24) | | | |
| 25 | 3308.8170 | 2.5191 | 1.90110 | 27.06 | 0.6072 |
| 26 | −86.6130 | 1.0000 | 1.69680 | 55.46 | 0.5426 |
| 27 | 37.2005 | (d27) | | | |
| 28 | 45.9518 | 10.2533 | 1.59282 | 68.62 | 0.5440 |
| 29 | −73.3083 | 2.3558 | | | |
| 30 | −90.4231 | 1.5000 | 1.91082 | 35.25 | 0.5822 |
| 31 | 26.0260 | 8.0319 | 1.68948 | 31.02 | 0.5987 |
| 32* | 106.7239 | (BF) | | | |
| Image surface | ∞ | | | | |

[Aspherical Surface Data]

| | Surface 6 | Surface 7 | Surface 11 | Surface 12 | Surface 14 |
|---|---|---|---|---|---|
| K | 0.00000 | −1.00000 | −1.00000 | 0.00000 | 0.00000 |
| A4 | 2.76955E−06 | 1.43228E−05 | −9.95473E−06 | −2.65543E−06 | −1.41121E−06 |
| A6 | 1.01492E−08 | 3.83685E−08 | 3.42318E−09 | 2.93499E−09 | 2.34821E−09 |
| A8 | −1.88793E−11 | 7.32592E−11 | −4.71186E−11 | −7.97783E−11 | 1.85880E−12 |
| A10 | 1.42142E−14 | 2.67619E−13 | −1.91440E−13 | 4.17562E−13 | 2.28014E−14 |
| A12 | −3.75173E−19 | −2.30089E−15 | 2.43675E−15 | −1.20576E−15 | −8.63512E−17 |
| A14 | −7.00838E−20 | 2.63902E−17 | −7.57236E−18 | 0.00000E+00 | 6.98636E−20 |
| A16 | 9.63513E−23 | −5.44577E−20 | 0.00000E+00 | 0.00000E+00 | 1.12301E−21 |
| A18 | 0.00000E+00 | 0.00000E+00 | 0.00000E+00 | 0.00000E+00 | 3.14040E−24 |
| A20 | 0.00000E+00 | 0.00000E+00 | 0.00000E+00 | 0.00000E+00 | 2.94008E−28 |

| | Surface 15 | Surface 18 | Surface 19 | Surface 32 |
|---|---|---|---|---|
| K | 0.00000 | 0.00000 | 0.00000 | 0.00000 |
| A4 | 1.32972E−06 | −6.02146E−06 | 5.99112E−06 | −1.92263E−06 |
| A6 | 5.30076E−09 | −1.51199E−10 | −2.41223E−09 | 1.10218E−08 |
| A8 | −1.38106E−11 | −4.07088E−12 | −8.79938E−12 | −7.23045E−11 |
| A10 | 2.28184E−14 | −7.07497E−14 | −6.92315E−15 | 2.26623E−13 |
| A12 | 1.08561E−16 | 1.21871E−16 | 0.00000E+00 | −8.23547E−17 |
| A14 | −3.64407E−21 | 0.00000E+00 | 0.00000E+00 | −2.38802E−19 |
| A16 | −6.79685E−22 | 0.00000E+00 | 0.00000E+00 | −1.37288E−21 |
| A18 | −1.03196E−24 | 0.00000E+00 | 0.00000E+00 | 9.36976E−26 |
| A20 | 2.60458E−26 | 0.00000E+00 | 0.00000E+00 | 7.22700E−27 |

[Various Types of Data]
Zoom ratio 3.53

| | Wide angle | Intermediate | Telephoto |
|---|---|---|---|
| Focal length | 28.84 | 50.00 | 101.85 |
| F number | 2.91 | 2.91 | 2.91 |
| Total angle of view 2ω | 76.52 | 46.48 | 22.85 |
| Image height Y | 21.63 | 21.63 | 21.63 |
| Total length of lens | 173.06 | 186.36 | 213.01 |

[Variable Distance Data]

| | Wide angle | Intermediate | Telephoto |
|---|---|---|---|
| d0 | ∞ | ∞ | ∞ |
| d5 | 1.5000 | 11.1198 | 34.7507 |
| d12 | 23.9417 | 12.0612 | 1.5000 |
| d17 | 16.0983 | 7.2089 | 9.9999 |
| d24 | 4.2688 | 1.5000 | 1.5001 |
| d27 | 7.7448 | 34.9654 | 45.7482 |
| BF | 17.8494 | 17.8494 | 17.8494 |

[Lens Group Data]

| Group | Starting surface | Focal length |
|---|---|---|
| G1 | 1 | 98.08 |
| G2 | 6 | −22.18 |
| G3 | 13 | 62.11 |
| G4 | 18 | 43.52 |
| G5 | 25 | −62.25 |
| G6 | 28 | −848.99 |

### Example 3

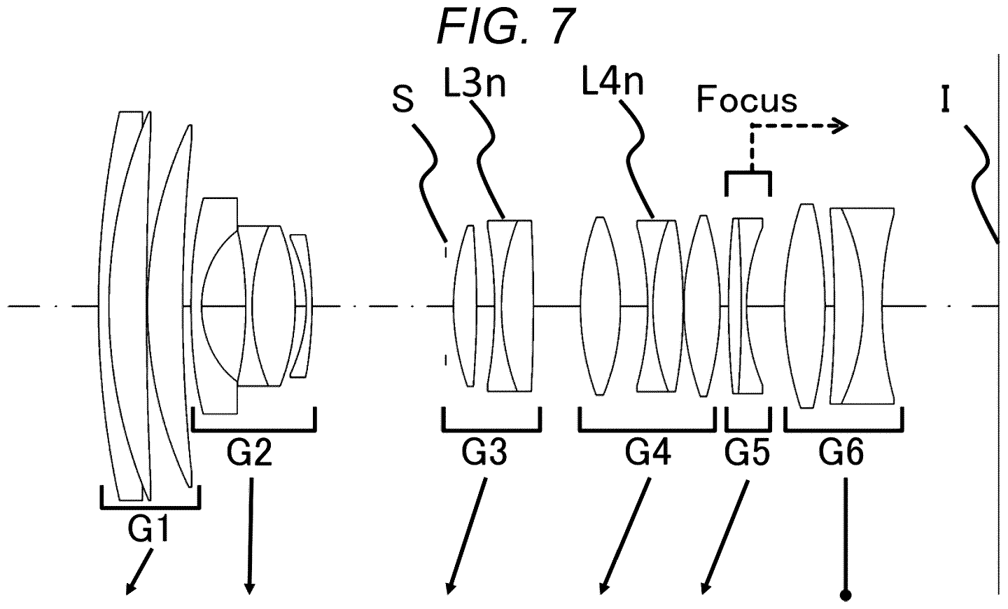

FIG. 7 is a lens configuration diagram of a variable magnification optical system of Example 3 of the present invention.

In Example 3, the zoom lens consists of, in order from the object side, a first lens group G1 having a positive refractive power, a second lens group G2 having a negative refractive power, an aperture diaphragm S, a third lens group G3 having a positive refractive power, a fourth lens group G4 having a positive refractive power, a fifth lens group G5 having a negative refractive power, and a sixth lens group G6 having a negative refractive power. The sixth lens group G6 corresponds to the last lens group GL.

During zooming from the wide-angle end to the telephoto end, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 does not change, and the distance between the fifth lens group G5 and the sixth lens group G6 increases. The sixth lens group G6 remains stationary with respect to the image surface I during zooming.

During focusing from the infinity end to the closest object end, the fifth lens group G5 moves to the image side along the optical axis.

The first lens group G1 consists of, in order from the object side, a cemented lens of a negative meniscus lens convex toward the object side and a positive meniscus lens convex toward the object side, and a positive meniscus lens convex toward the object side.

The second lens group G2 consists of, in order from the object side, a negative meniscus lens convex toward the object side, a cemented lens of a biconcave lens and a biconvex lens, and a negative meniscus lens convex toward the image side.

The third lens group G3 consists of an aperture diaphragm S, a biconvex lens, and a cemented lens of a biconcave lens L3n and a biconvex lens, in order from the object side.

The fourth lens group G4 consists of a biconvex lens, a cemented lens of a biconcave lens L4n and a biconvex lens, and a biconvex lens, in order from the object side.

The fifth lens group G5 consists of a cemented lens of a biconvex lens and a biconcave lens, in order from the object side.

The sixth lens group G6 consists of a biconvex lens, and a cemented lens of a positive meniscus lens convex toward the image side and a biconcave lens, in order from the object side.

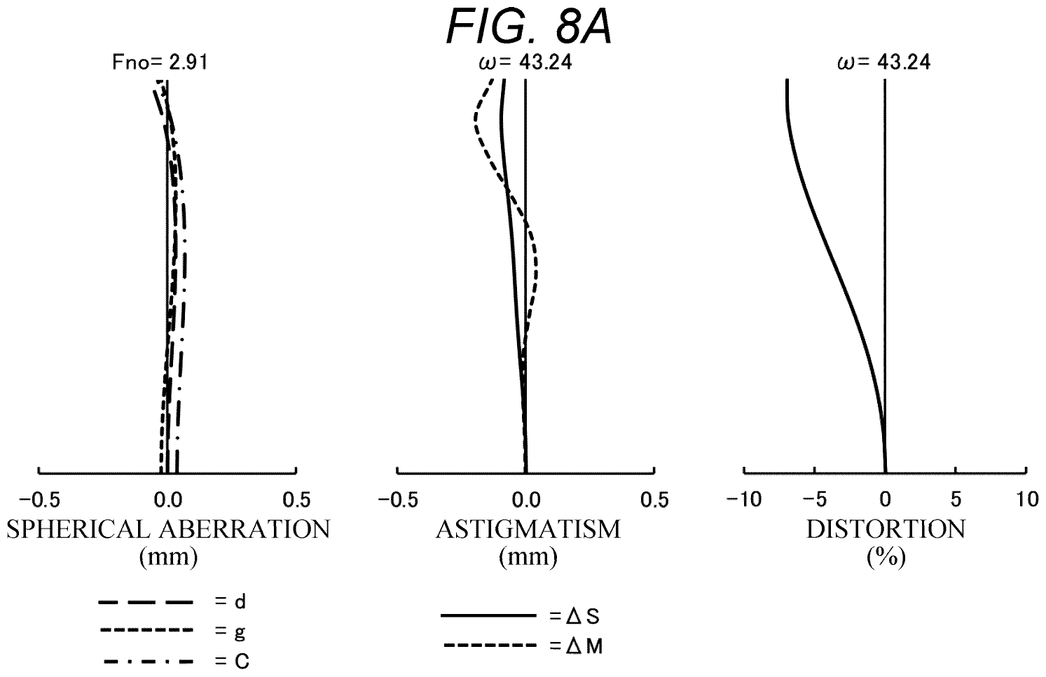

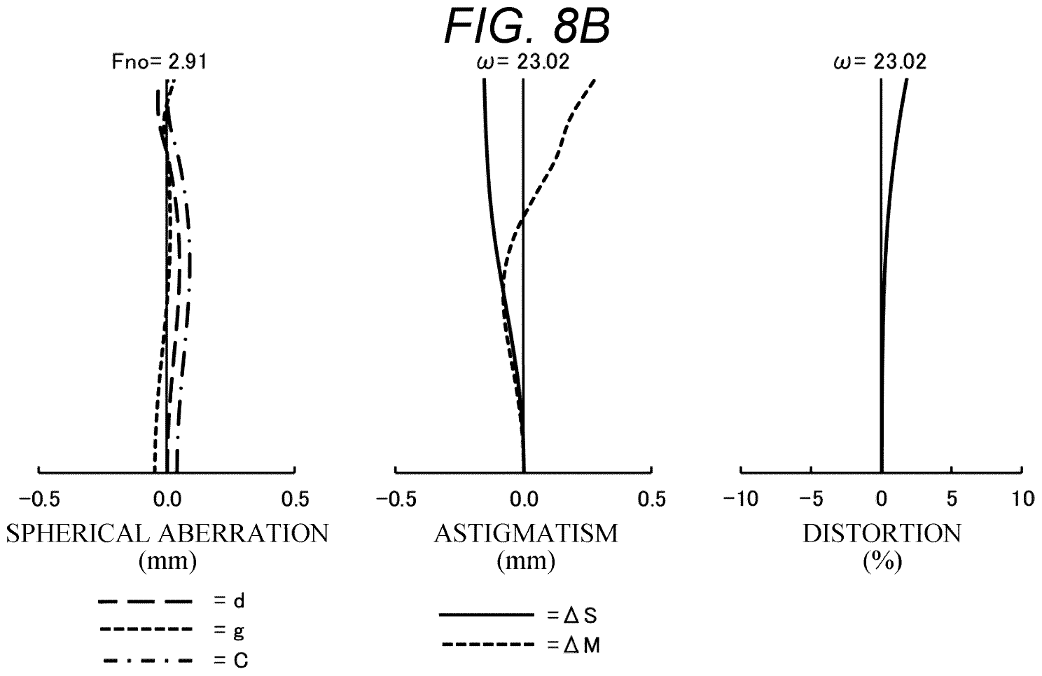

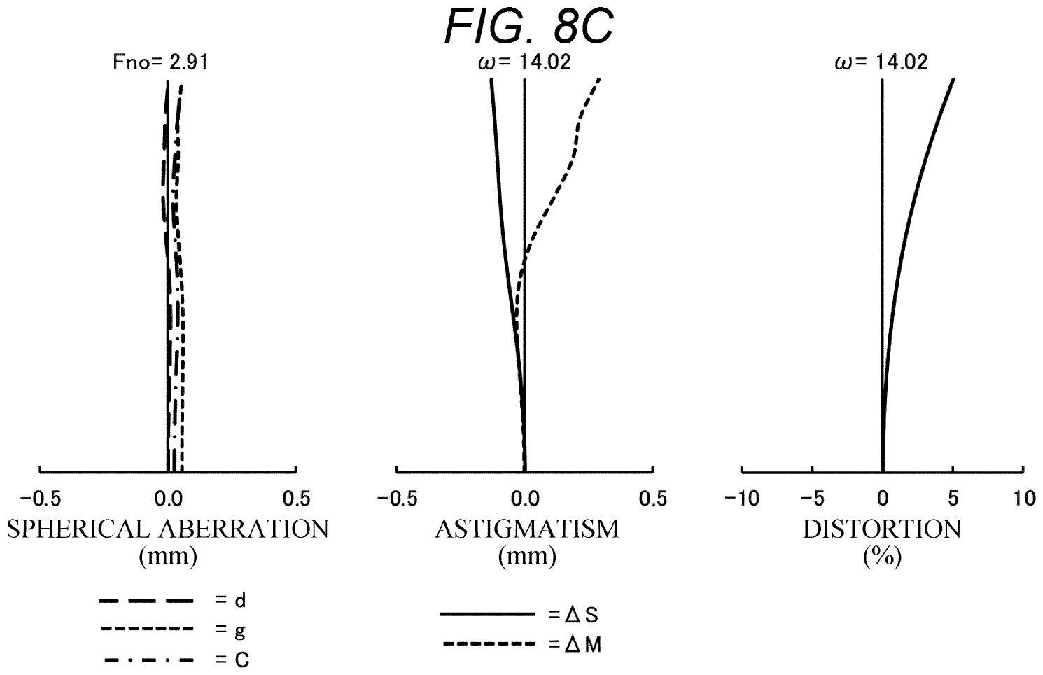

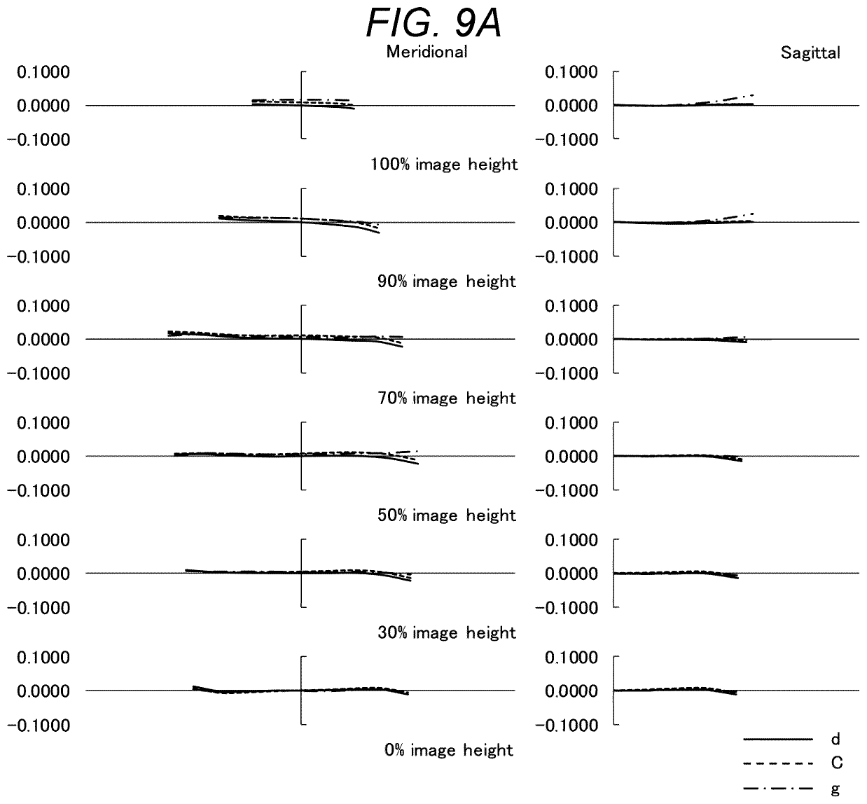

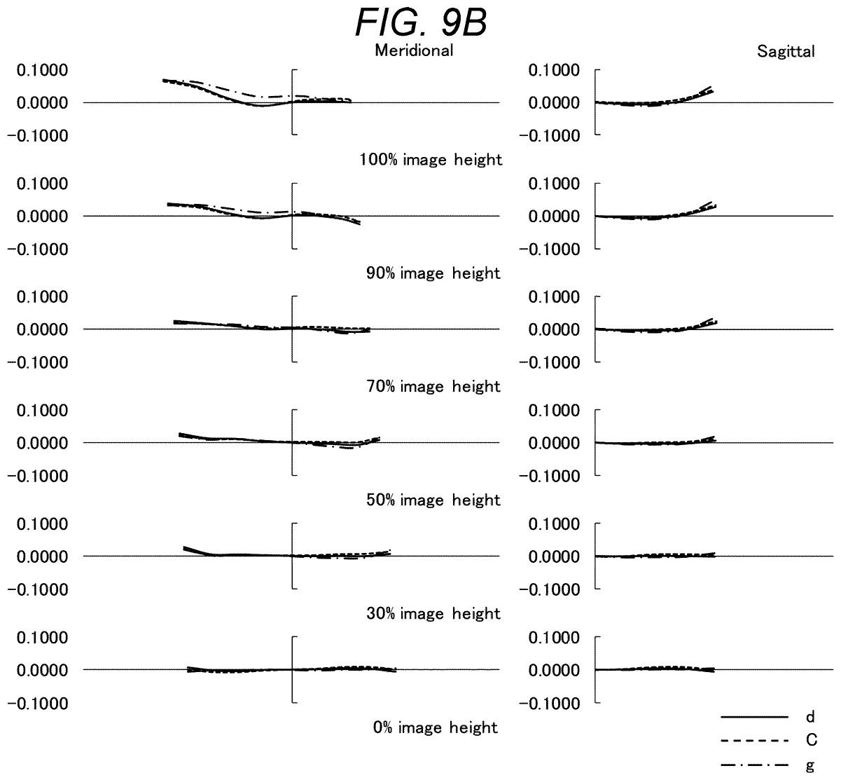

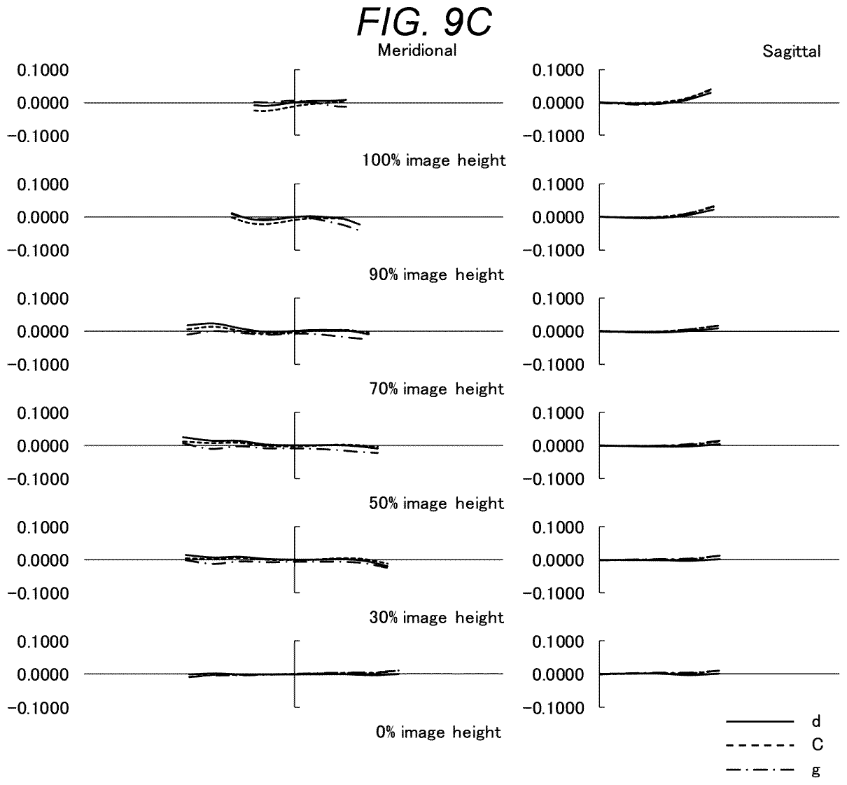

FIGS. 8A, 8B, and 8C are longitudinal aberration diagrams in a case where an infinite distance object is in focus at a wide-angle end, an intermediate focal length, and a telephoto end, respectively, according to Example 3. FIGS. 9A, 9B, and 9C are lateral aberration diagrams in a case where an infinite distance object is in focus at a wide-angle end, an intermediate focal length, and a telephoto end, respectively, according to Example 3. From the aberration diagrams, it can be seen that in the variable magnification optical system according to the present example, various aberrations are satisfactorily corrected from the wide-angle end to the telephoto end, and excellent image formation performance is obtained.

The specification values of the variable magnification optical system of Example 3 of the present invention are shown below.

### Numerical Example 3

Unit: mm

[Surface data]

| Surface number | r | d | nd | vd | PgF |
|---|---|---|---|---|---|
| Object surface | ∞ | (d0) | | | |
| 1 | 179.2084 | 2.0000 | 1.92286 | 20.88 | 0.6390 |
| 2 | 97.3898 | 7.1756 | 1.43700 | 95.10 | 0.5336 |
| 3 | 758.6539 | 0.2000 | | | |
| 4 | 82.2327 | 6.7190 | 1.85033 | 42.70 | 0.5646 |
| 5 | 310.3818 | (d5) | | | |
| 6* | 128.5311 | 2.0000 | 1.85135 | 40.10 | 0.5695 |
| 7 | 20.4306 | 8.4477 | | | |
| 8 | −68.8600 | 1.2000 | 1.69680 | 55.46 | 0.5426 |
| 9 | 40.0193 | 8.2181 | 1.77047 | 29.74 | 0.5951 |
| 10 | −43.1870 | 2.1249 | | | |
| 11* | −26.9006 | 1.1000 | 1.69350 | 53.20 | 0.5467 |
| 12* | −73.7285 | (d12) | | | |
| 13(diaphragm) | ∞ | 1.5000 | | | |
| 14* | 44.1647 | 4.4207 | 1.59201 | 67.02 | 0.5358 |
| 15* | −171.8607 | 3.4330 | | | |
| 16 | −85.1998 | 1.3000 | 1.76200 | 40.10 | 0.5765 |
| 17 | 46.8813 | 6.0871 | 1.77047 | 29.74 | 0.5951 |
| 18 | −355.0483 | (d18) | | | |
| 19 | 50.9169 | 7.6422 | 1.43700 | 95.10 | 0.5336 |
| 20 | −47.4451 | 5.1924 | | | |
| 21 | −58.7592 | 1.0000 | 1.78880 | 28.42 | 0.6006 |
| 22 | 48.8761 | 5.7543 | 1.43700 | 95.10 | 0.5336 |
| 23 | −93.8745 | 0.1500 | | | |
| 24* | 45.1526 | 6.9034 | 1.69350 | 53.20 | 0.5467 |
| 25* | −55.1319 | (d25) | | | |
| 26 | 173.5508 | 2.4342 | 1.84666 | 23.78 | 0.6192 |
| 27 | −260.9119 | 1.0000 | 1.69680 | 55.46 | 0.5426 |
| 28 | 40.1664 | (d28) | | | |
| 29 | 64.3701 | 7.7587 | 1.59349 | 67.00 | 0.5366 |
| 30 | −86.4580 | 1.7944 | | | |
| 31 | −207.3852 | 5.5341 | 1.43700 | 95.10 | 0.5336 |
| 32 | −44.6083 | 3.5810 | 1.80610 | 40.73 | 0.5694 |
| 33* | 74.3189 | (BF) | | | |
| Image surface | ∞ | | | | |

[Aspherical Surface Data]

| | Surface 6 | Surface 7 | Surface 11 | Surface 12 | Surface 14 |
|---|---|---|---|---|---|
| K | 0.00000 | −1.00000 | −1.00000 | 0.00000 | 0.00000 |
| A4 | 4.11166E−06 | 1.81379E−05 | 7.03885E−06 | 6.10735E−06 | −4.59577E−06 |
| A6 | 1.25714E−09 | 3.91055E−08 | −1.45963E−09 | −1.56970E−08 | 2.10732E−08 |
| A8 | −8.47626E−12 | 1.30567E−10 | −1.29399E−10 | −1.25650E−10 | −1.92526E−10 |
| A10 | −5.74457E−16 | −3.61282E−13 | 9.38107E−13 | 9.50079E−13 | 8.48013E−13 |
| A12 | 3.74980E−18 | 2.14933E−15 | −2.24300E−15 | −2.48285E−15 | −1.29928E−15 |

| | Surface 15 | Surface 24 | Surface 25 | Surface 33 |
|---|---|---|---|---|
| K | 0.00000 | 0.00000 | 0.00000 | 0.00000 |
| A4 | 2.03345E−07 | −4.96087E−06 | 3.01099E−06 | 8.76780E−07 |
| A6 | 1.75354E−08 | 1.71047E−09 | −1.74050E−11 | −8.36878E−10 |
| A8 | −1.38485E−10 | 7.75114E−12 | 3.64239E−12 | 1.97059E−11 |
| A10 | 5.52442E−13 | −2.87970E−14 | 2.79577E−15 | −8.33180E−14 |
| A12 | −7.13866E−16 | 1.50074E−17 | −3.61072E−17 | 1.08144E−16 |

[Various Types of Data]
Zoom ratio 3.34

| | Wide angle | Intermediate | Telephoto |
|---|---|---|---|
| Focal length | 24.72 | 50.00 | 82.45 |
| F number | 2.91 | 2.91 | 2.91 |
| Total angle of view 2ω | 86.47 | 46.04 | 28.04 |
| Image height Y | 21.63 | 21.63 | 21.63 |
| Total length of lens | 171.89 | 186.12 | 216.15 |

[Variable Distance Data]

| | Wide angle | Intermediate | Telephoto |
|---|---|---|---|
| d0 | ∞ | ∞ | ∞ |
| d5 | 1.6000 | 14.6473 | 44.4418 |
| d12 | 25.4627 | 6.3833 | 1.5000 |
| d18 | 8.9856 | 2.8620 | 1.5746 |
| d25 | 1.6161 | 1.6161 | 1.6161 |
| d28 | 7.2617 | 33.6478 | 40.0465 |
| BF | 22.2969 | 22.2969 | 22.2969 |

[Lens Group Data]

| Group | Starting surface | Focal length |
|---|---|---|
| G1 | 1 | 137.60 |
| G2 | 6 | −23.06 |
| G3 | 13 | 93.71 |
| G4 | 19 | 37.30 |
| G5 | 26 | −85.24 |
| G6 | 29 | −365.25 |

### Example 4

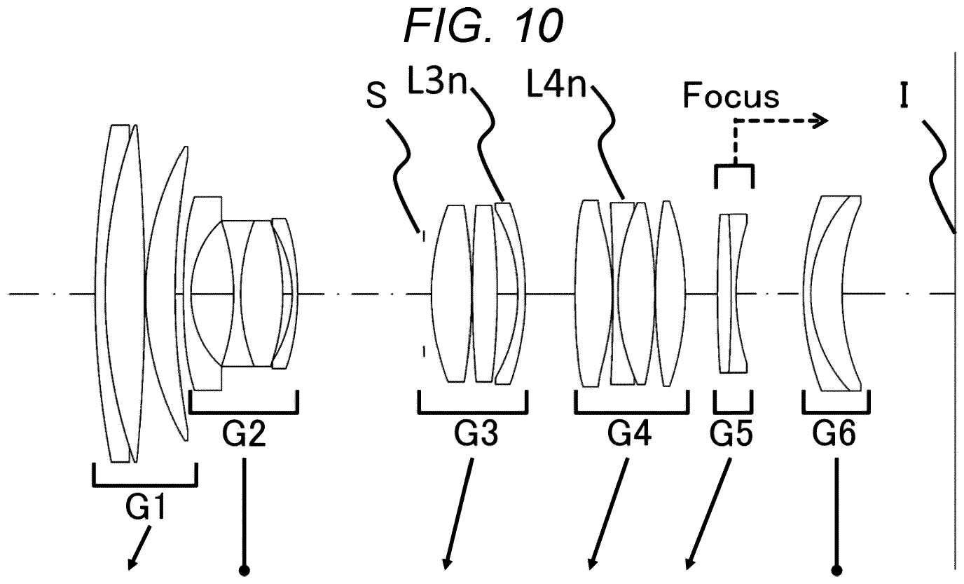

FIG. 10 is a lens configuration diagram of a variable magnification optical system of Example 4 of the present invention.

In Example 4, the zoom lens consists of, in order from the object side, a first lens group G1 having a positive refractive power, a second lens group G2 having a negative refractive power, an aperture diaphragm S, a third lens group G3 having a positive refractive power, a fourth lens group G4 having a positive refractive power, a fifth lens group G5 having a negative refractive power, and a sixth lens group G6 having a negative refractive power. The sixth lens group G6 corresponds to the last lens group GL.

During zooming from the wide angle end to the telephoto end, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 decreases, and the distance between the fifth lens group G5 and the sixth lens group G6 increases. The second lens group G2 and the sixth lens group G6 are fixed with respect to the image surface I during zooming.

During focusing from the infinity end to the closest object end, the fifth lens group G5 moves to the image side along the optical axis.

The first lens group G1 consists of, in order from the object side, a cemented lens of a negative meniscus lens convex toward the object side and a biconvex lens, and a positive meniscus lens convex toward the object side.

The second lens group G2 consists of, in order from the object side, a negative meniscus lens convex toward the object side, a cemented lens of a biconcave lens and a biconvex lens, and a negative meniscus lens convex toward the image side. The third lens group G3 consists of, in order from the object side, an aperture diaphragm S, a biconvex lens, a biconvex lens, and a negative meniscus lens L3n convex toward the image side.

The fourth lens group G4 consists of a biconvex lens, a cemented lens of a biconcave lens L4n and a biconvex lens, and a biconvex lens, in order from the object side.

The fifth lens group G5 consists of a cemented lens of a biconvex lens and a biconcave lens, in order from the object side.

The sixth lens group G6 consists of a cemented lens of a negative meniscus lens convex toward the object side and a positive meniscus lens convex toward the image side in order from the object side.

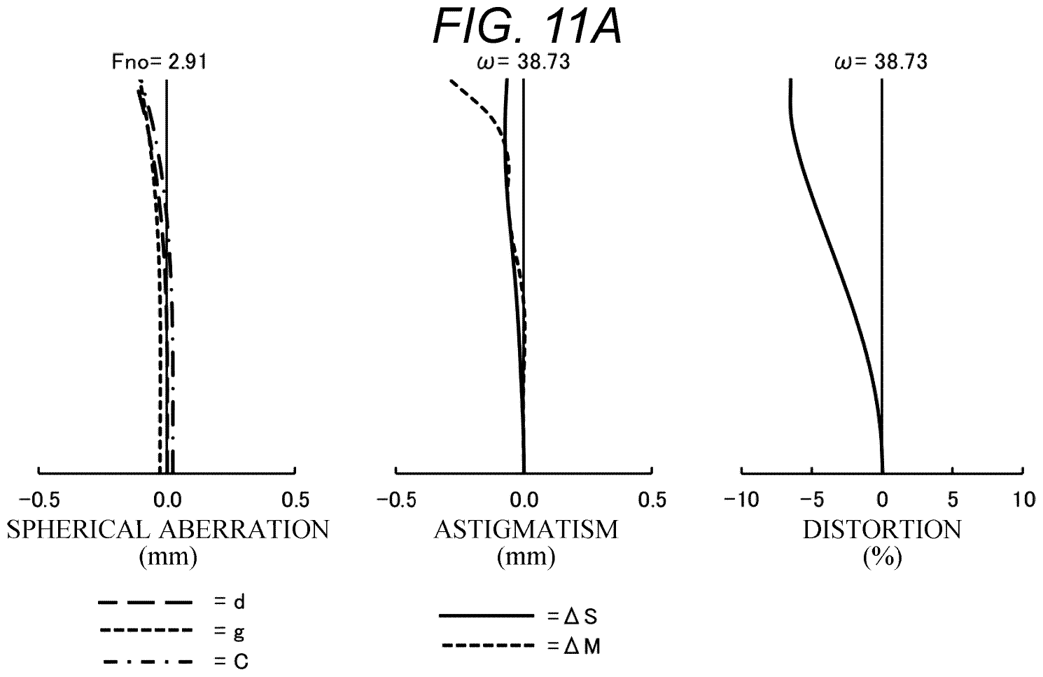

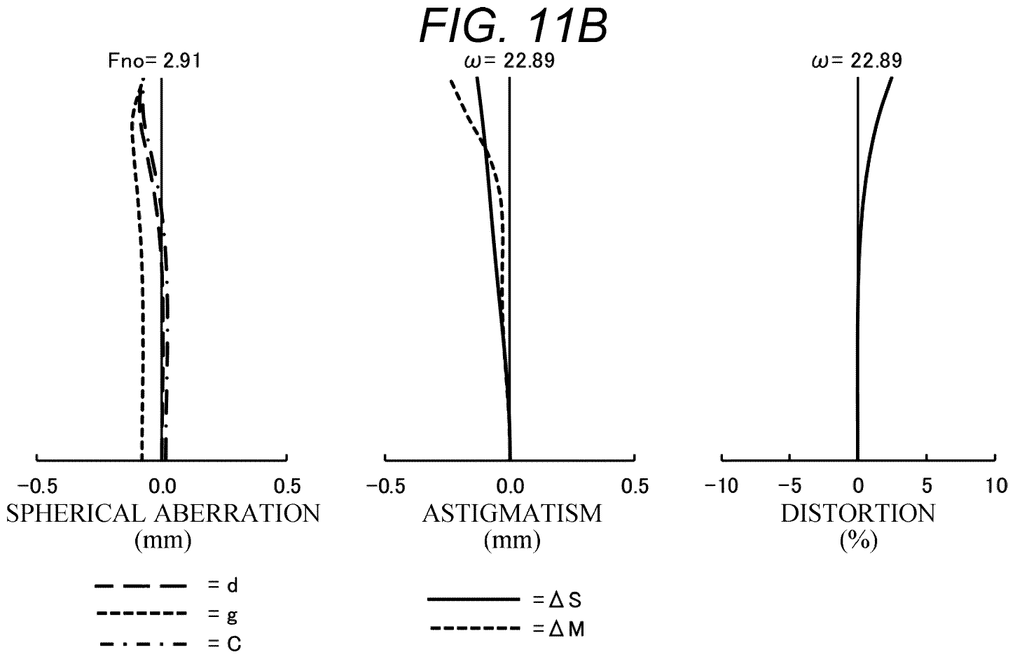

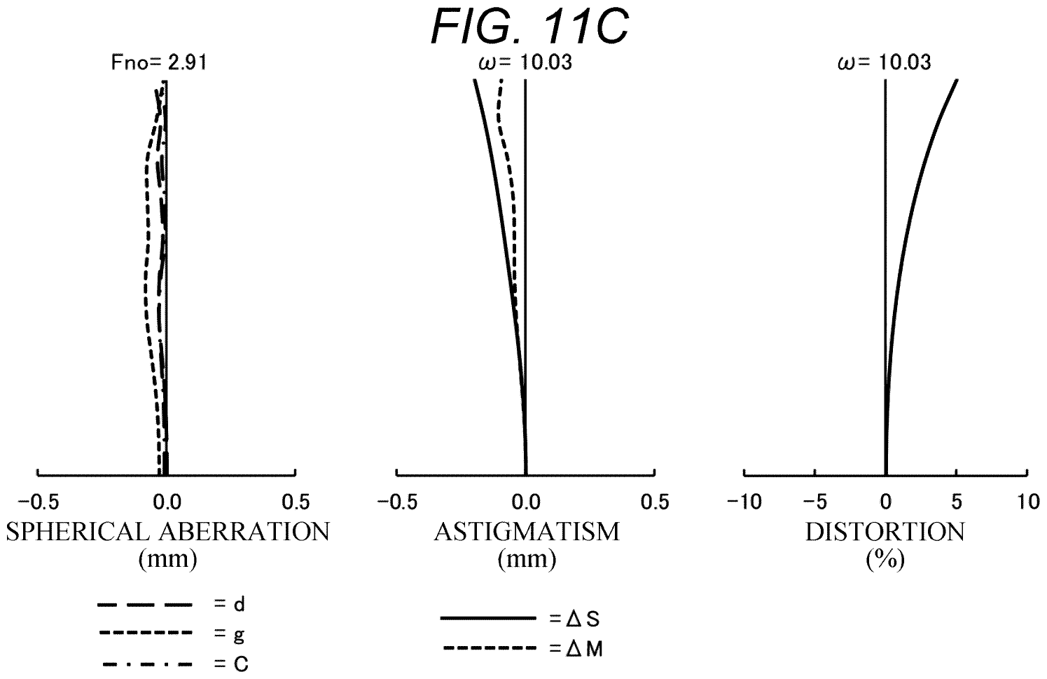

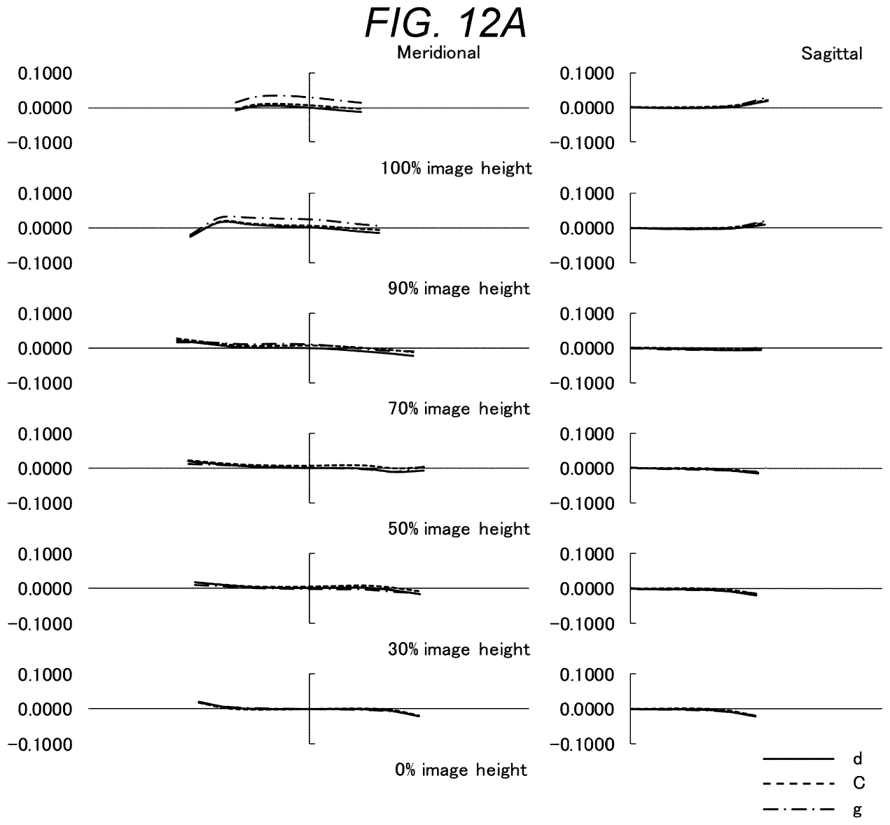

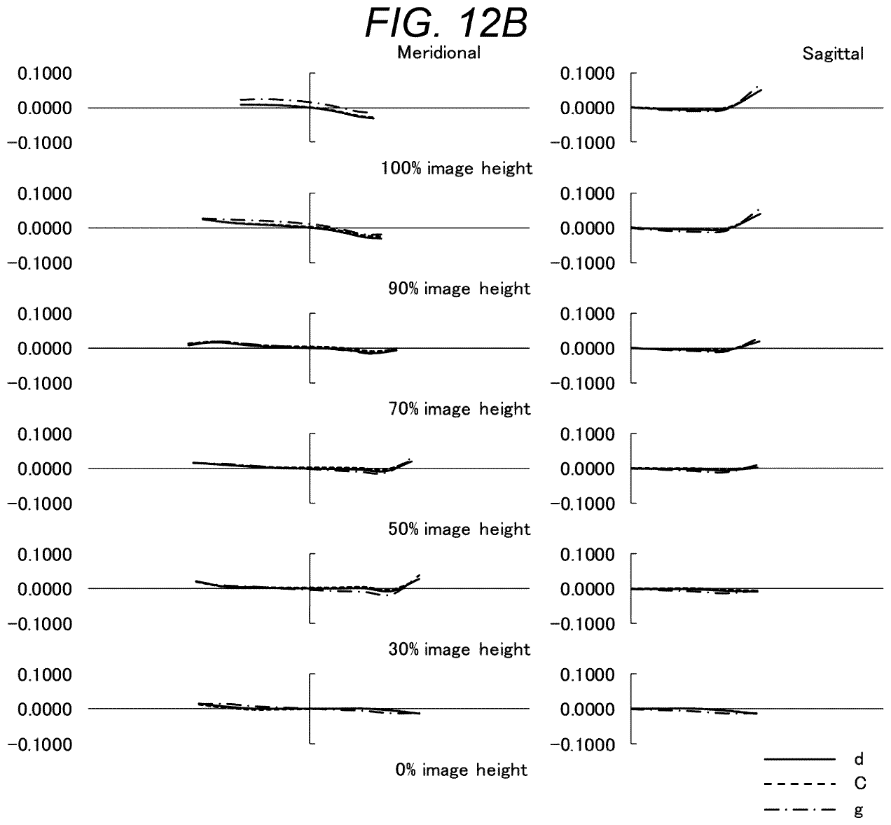

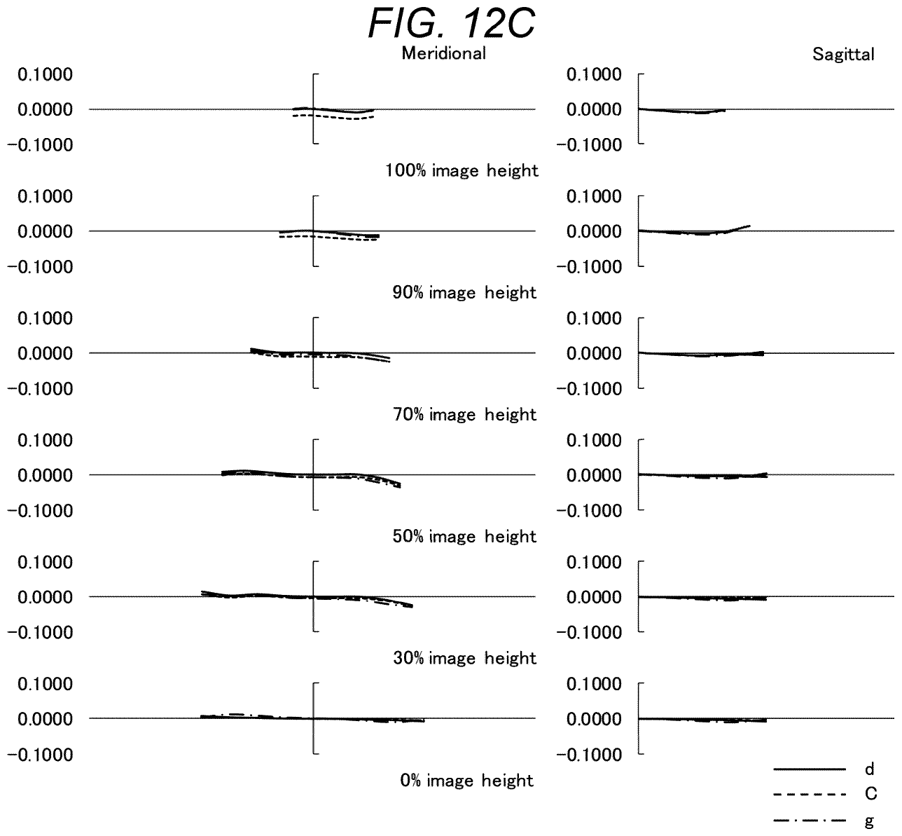

FIGS. 11A, 11B, and 11C are longitudinal aberration diagrams in a case where an infinite distance object is in focus at a wide-angle end, an intermediate focal length, and a telephoto end, respectively, according to Example 4. FIGS. 12A, 12B, and 12C are lateral aberration diagrams in a case where an infinite distance object is in focus at a wide-angle end, an intermediate focal length, and a telephoto end, respectively, according to Example 4. From the aberration diagrams, it can be seen that in the variable magnification optical system according to the present example, various aberrations are satisfactorily corrected from the wide-angle end to the telephoto end. and excellent image formation performance is obtained.

The specification values of the variable magnification optical system of Example 4 of the present invention are shown below.

### Numerical Example 4

Unit: mm

[Surface data]

| Surface number | r | d | nd | vd | PgF |
|---|---|---|---|---|---|
| Object surface | ∞ | (d0) | | | |
| 1 | 182.8962 | 2.0000 | 1.84666 | 23.78 | 0.6192 |
| 2 | 103.0096 | 7.8692 | 1.43700 | 95.10 | 0.5336 |
| 3 | −365.4120 | 0.2000 | | | |
| 4 | 61.6580 | 5.8612 | 1.65160 | 58.54 | 0.5390 |
| 5 | 159.2619 | (d5) | | | |
| 6* | 180.0000 | 1.5000 | 1.77377 | 47.17 | 0.5557 |
| 7* | 23.4545 | 8.5012 | | | |
| 8 | −44.9965 | 1.4000 | 1.75500 | 52.32 | 0.5473 |
| 9 | 42.1796 | 8.3914 | 1.78880 | 28.43 | 0.6009 |
| 10 | −45.3736 | 1.8722 | | | |
| 11* | −24.4401 | 1.1000 | 1.69350 | 53.20 | 0.5467 |
| 12* | −51.1814 | (d12) | | | |
| 13(diaphragm) | ∞ | 1.5000 | | | |
| 14* | 49.5659 | 7.9295 | 1.55332 | 71.69 | 0.5404 |
| 15* | −107.8543 | 0.1500 | | | |
| 16 | 231.7407 | 4.9404 | 1.43700 | 95.10 | 0.5336 |
| 17 | −139.4126 | 4.1037 | | | |
| 18 | −34.5320 | 1.5000 | 1.78590 | 43.94 | 0.5612 |
| 19 | −55.9426 | (d19) | | | |
| 20* | 150.0000 | 7.4430 | 1.59201 | 67.02 | 0.5358 |
| 21* | −46.2774 | 0.1000 | | | |
| 22 | −343.7916 | 1.0000 | 1.73800 | 32.33 | 0.5900 |
| 23 | 46.0034 | 7.3560 | 1.43700 | 95.10 | 0.5336 |
| 24 | −85.1870 | 0.1000 | | | |
| 25 | 110.0127 | 5.9425 | 1.49700 | 81.61 | 0.5389 |
| 26 | −57.2477 | (d26) | | | |
| 27 | 251.5218 | 2.7660 | 1.84666 | 23.78 | 0.6192 |
| 28 | −251.5218 | 1.0000 | 1.69680 | 55.46 | 0.5426 |
| 29 | 48.3062 | (d29) | | | |
| 30 | 55.7665 | 1.5000 | 1.61266 | 44.46 | 0.5640 |
| 31 | 28.9959 | 6.2338 | 1.45562 | 91.31 | 0.5343 |
| 32* | 50.0000 | (BF) | | | |
| Image surface | ∞ | | | | |

[Aspherical Surface Data]

| | Surface 6 | Surface 7 | Surface 11 | Surface 12 | Surface 14 |
|---|---|---|---|---|---|
| K | 0.00000 | −1.00000 | 0.00000 | 0.00000 | 0.00000 |
| A4 | 1.16303E−05 | 2.10660E−05 | 1.01208E−05 | 5.91951E−06 | −1.92131E−06 |
| A6 | −2.39263E−08 | 2.09856E−08 | −5.16644E−09 | −2.37582E−08 | 5.12733E−09 |
| A8 | 5.61904E−11 | 3.43417E−12 | −1.88011E−10 | −1.23913E−10 | −1.80837E−11 |
| A10 | −7.63279E−14 | 2.81058E−13 | 7.79977E−14 | 8.32342E−13 | 4.92591E−14 |
| A12 | 5.26804E−17 | 6.69872E−16 | 9.39229E−15 | −2.12598E−15 | −3.03032E−17 |
| A14 | 0.00000E+00 | 0.00000E+00 | −1.45805E−17 | 7.29516E−19 | 0.00000E+00 |
| A16 | 0.00000E+00 | 0.00000E+00 | −4.99286E−19 | 1.20374E−20 | 0.00000E+00 |
| A18 | 0.00000E+00 | 0.00000E+00 | 3.13435E−21 | −8.26278E−23 | 0.00000E+00 |
| A20 | 0.00000E+00 | 0.00000E+00 | −5.89066E−24 | 1.47495E−25 | 0.00000E+00 |

| | Surface 15 | Surface 20 | Surface 21 | Surface 32 |
|---|---|---|---|---|
| K | 0.00000 | 0.00000 | 0.00000 | 0.00000 |
| A4 | −1.13073E−07 | −3.06852E−06 | 3.92015E−06 | 1.40386E−06 |
| A6 | 2.29101E−09 | 8.76708E−09 | 6.20425E−09 | 2.27926E−09 |
| A8 | −1.42414E−12 | −2.00766E−12 | −9.11955E−12 | 1.10032E−11 |
| A10 | 1.66462E−16 | 9.45764E−14 | 1.04572E−13 | −6.04579E−14 |
| A12 | 0.00000E+00 | −2.95097E−17 | 3.55952E−17 | 1.34174E−16 |
| A14 | 0.00000E+00 | −4.34122E−20 | −1.09199E−19 | −8.90788E−20 |
| A16 | 0.00000E+00 | −2.78767E−22 | −3.13092E−22 | 0.00000E+00 |
| A18 | 0.00000E+00 | −4.85803E−25 | −2.28248E−25 | 0.00000E+00 |
| A20 | 0.00000E+00 | 1.90227E−27 | 1.54201E−27 | 0.00000E+00 |

[Various Types of Data]
Zoom ratio 4.04

| | Wide angle | Intermediate | Telephoto |
|---|---|---|---|
| Focal length | 28.84 | 50.00 | 116.39 |
| F number | 2.91 | 2.91 | 2.91 |
| Total angle of view 2ω | 77.45 | 45.78 | 20.07 |
| Image height Y | 21.63 | 21.63 | 21.63 |
| Total length of lens | 171.24 | 186.47 | 216.95 |

[Variable Distance Data]

| | Wide angle | Intermediate | Telephoto |
|---|---|---|---|
| d0 | ∞ | ∞ | ∞ |
| d5 | 1.6000 | 16.8210 | 47.3085 |
| d12 | 25.2100 | 13.4960 | 1.5000 |
| d19 | 9.8970 | 4.8225 | 1.7139 |
| d26 | 6.4176 | 2.5815 | 1.7513 |
| d29 | 13.3242 | 33.9488 | 49.8835 |
| BF | 22.5352 | 22.5352 | 22.5352 |

[Lens Group Data]

| Group | Starting surface | Focal length |
|---|---|---|
| G1 | 1 | 118.28 |
| G2 | 6 | −22.46 |
| G3 | 13 | 73.66 |
| G4 | 20 | 40.83 |
| G5 | 27 | −96.53 |
| G6 | 30 | −315.04 |

### Example 5

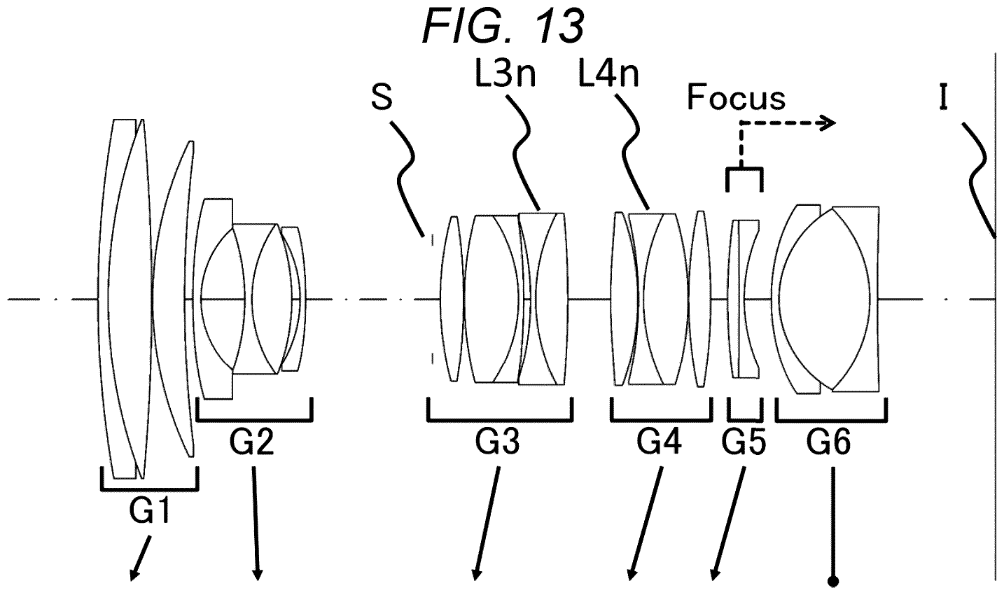

FIG. 13 is a lens configuration diagram of a variable magnification optical system of Example 5 of the present invention.

In Example 5, the zoom lens consists of, in order from the object side, a first lens group G1 having a positive refractive power, a second lens group G2 having a negative refractive power, an aperture diaphragm S, a third lens group G3 having a positive refractive power, a fourth lens group G4 having a positive refractive power, a fifth lens group G5 having a negative refractive power, and a sixth lens group G6 having a negative refractive power. The sixth lens group G6 corresponds to the last lens group GL.

During zooming from the wide angle end to the telephoto end, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 increases, and the distance between the fifth lens group G5 and the sixth lens group G6 increases. The sixth lens group G6 remains stationary with respect to the image surface I during zooming.

During focusing from the infinity end to the closest object end, the fifth lens group G5 moves to the image side along the optical axis.

The first lens group G1 consists of, in order from the object side, a cemented lens of a negative meniscus lens convex toward the object side and a biconvex lens, and a positive meniscus lens convex toward the object side.

The second lens group G2 consists of, in order from the object side, a negative meniscus lens convex toward the object side, a cemented lens of a biconcave lens and a biconvex lens, and a negative meniscus lens convex toward the image side.

The third lens group G3 consists of, in order from the object side, an aperture diaphragm S, a biconvex lens, a cemented lens of a biconvex lens and a negative meniscus lens convex toward the image side, and a cemented lens of a biconcave lens L3n and a biconvex lens.

The fourth lens group G4 consists of a biconvex lens, a cemented lens of a biconcave lens L4n and a biconvex lens, and a biconvex lens, in order from the object side.

The fifth lens group G5 consists of a cemented lens of a biconvex lens and a biconcave lens, in order from the object side.

The sixth lens group G6 consists of a cemented lens of a negative meniscus lens convex toward the object side, a biconvex lens, and a biconcave lens, in order from the object side.

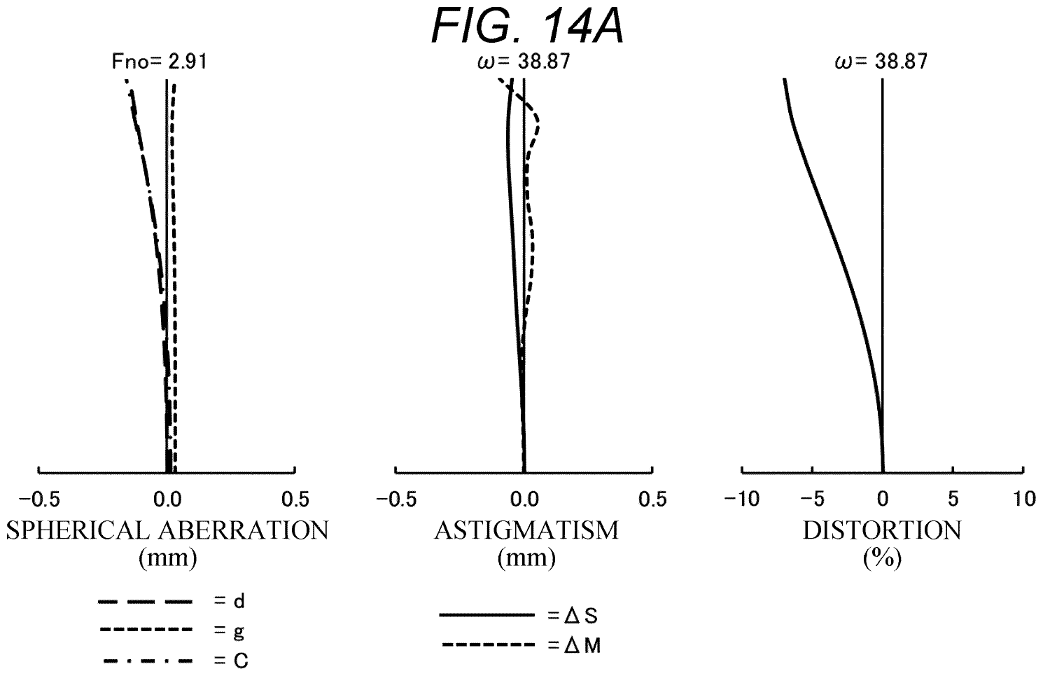

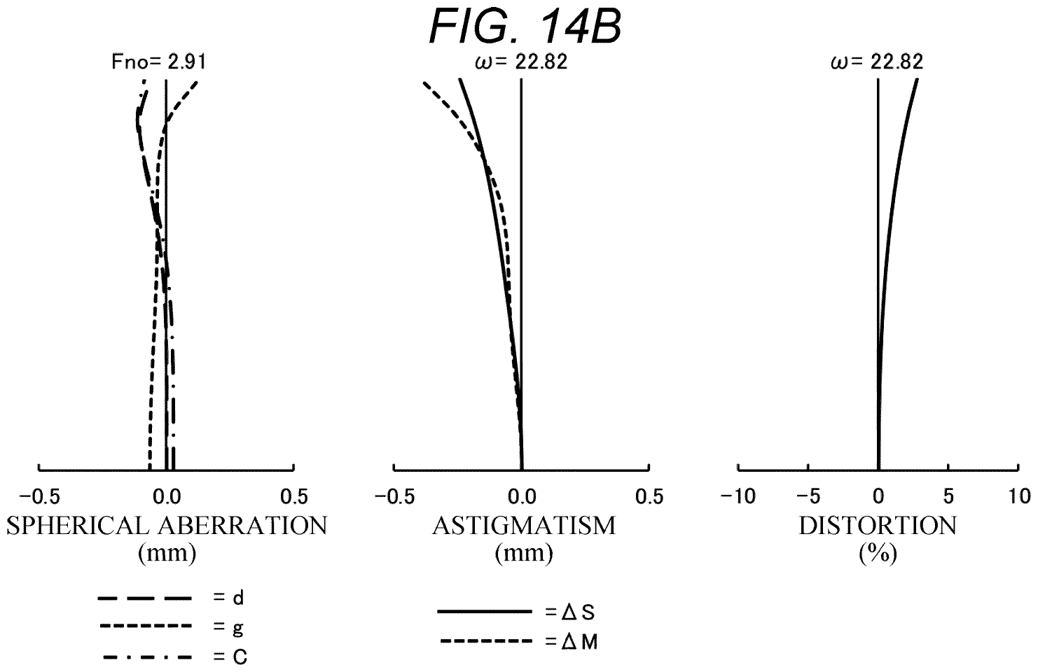

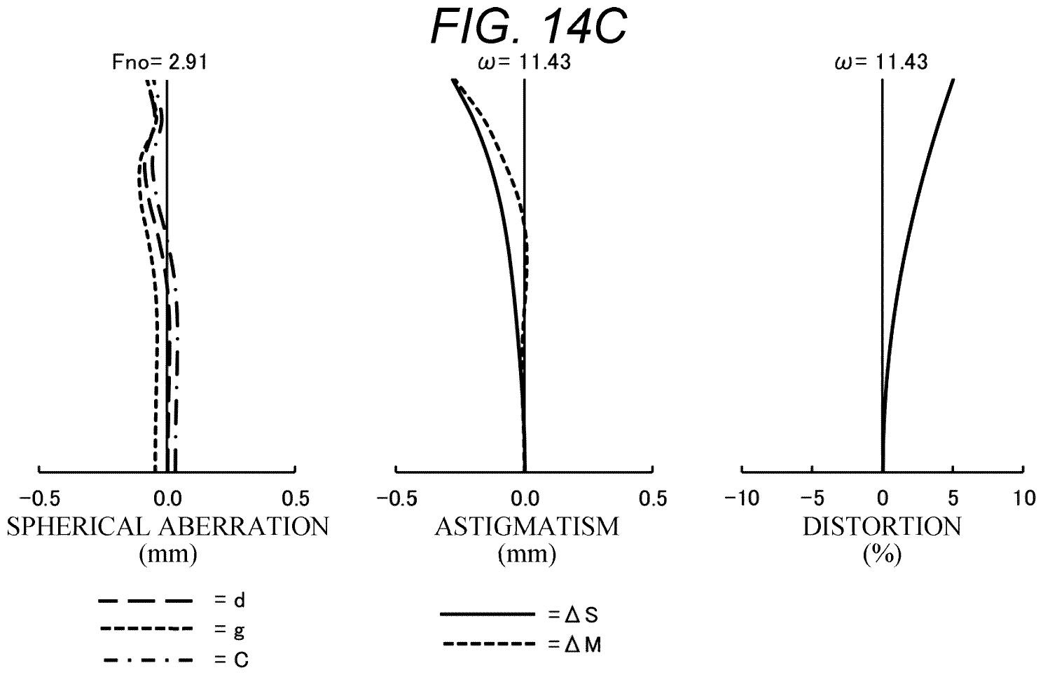

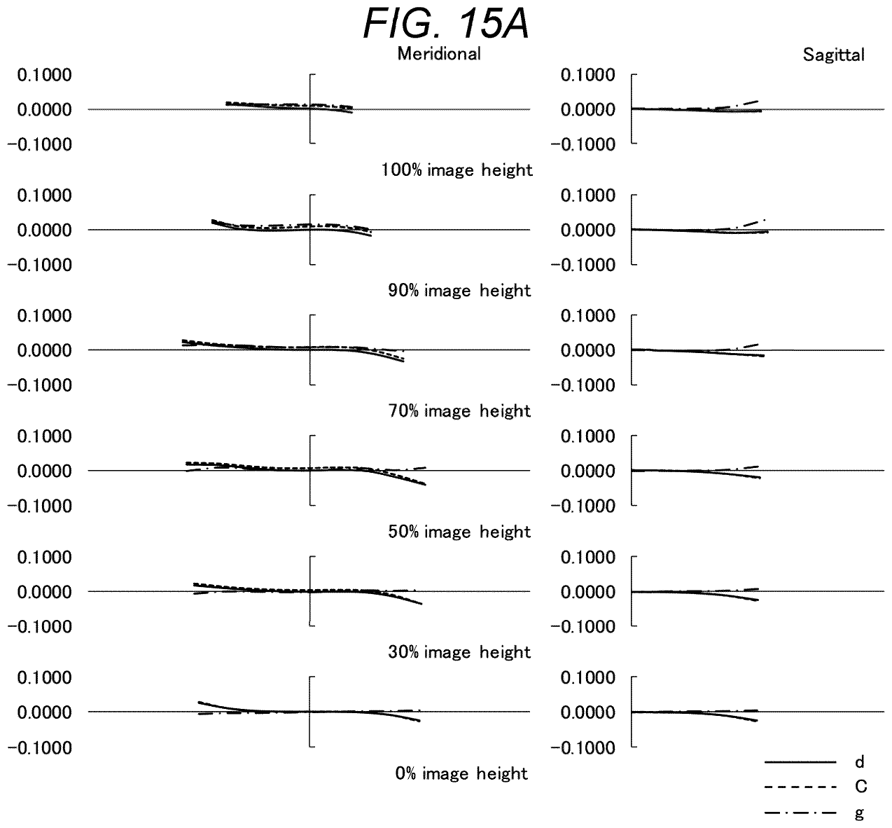

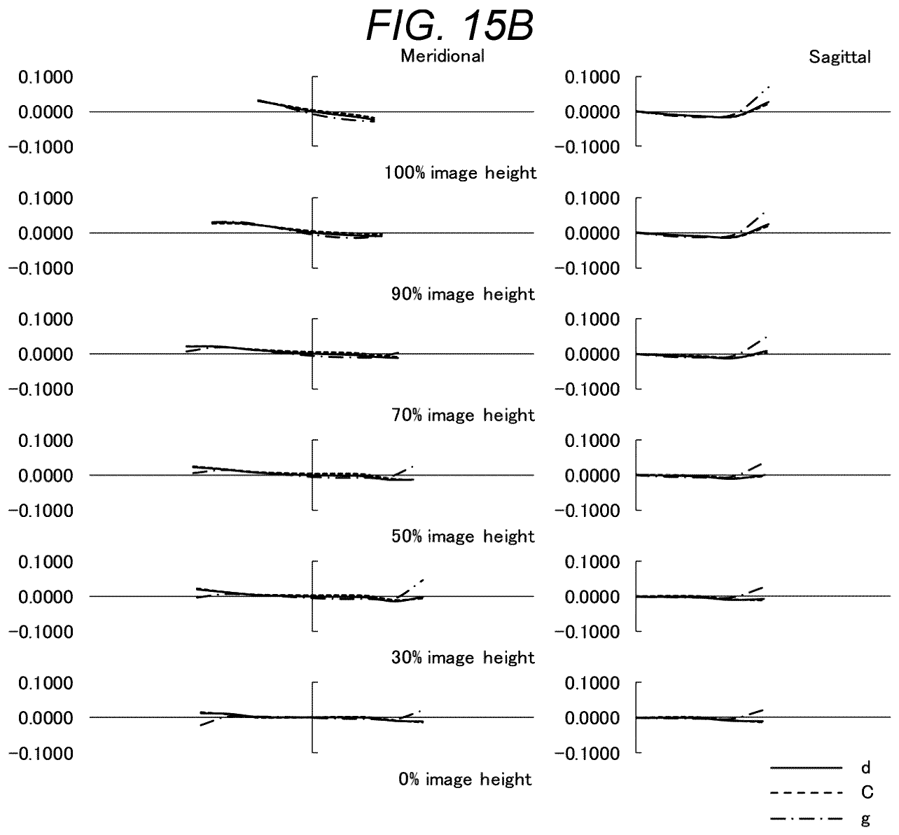

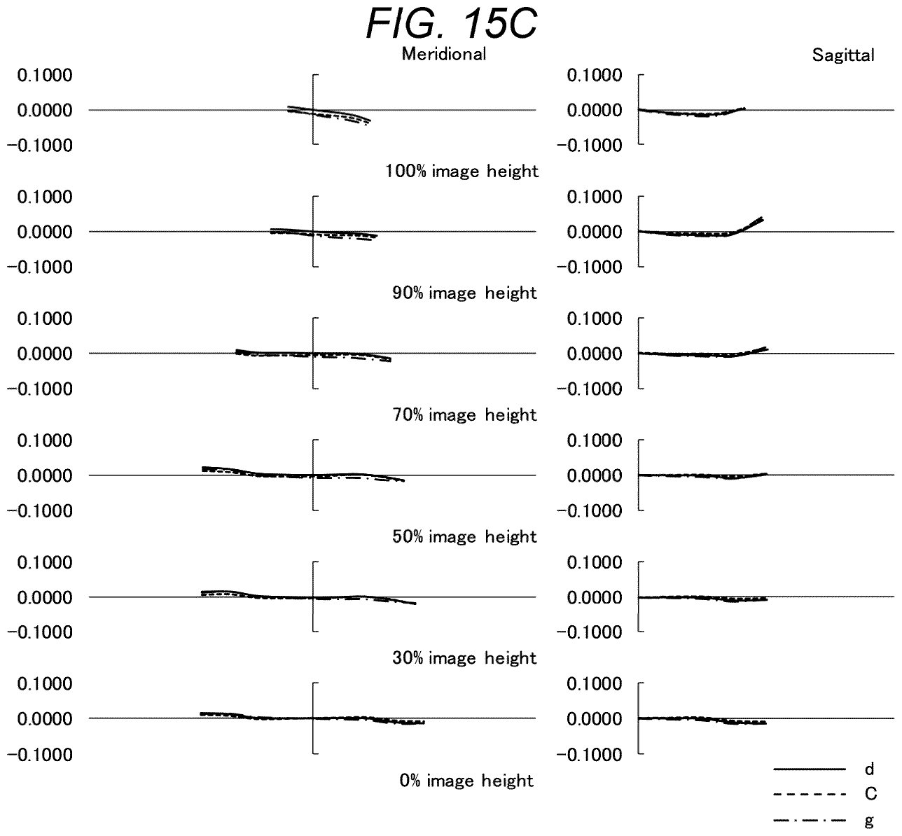

FIGS. 14A, 14B, and 14C are longitudinal aberration diagrams in a case where an infinite distance object is in focus at a wide-angle end, an intermediate focal length, and a telephoto end, respectively, according to Example 5. FIGS. 15A, 15B, and 15C are lateral aberration diagrams in a case where an infinite distance object is in focus at a wide-angle end, an intermediate focal length, and a telephoto end, respectively, according to Example 5. From the aberration diagrams, it can be seen that in the variable magnification optical system according to the present example, various aberrations are satisfactorily corrected from the wide-angle end to the telephoto end, and excellent image formation performance is obtained.

The specification values of the variable magnification optical system of Example 5 of the present invention are shown below.

### Numerical Example 5

Unit: mm

[Surface data]

| Surface number | r | d | nd | vd | PgF |
|---|---|---|---|---|---|
| Object surface | ∞ | (d0) | | | |
| 1 | 208.4271 | 2.0000 | 1.92119 | 23.96 | 0.6202 |
| 2 | 101.0804 | 8.4799 | 1.43700 | 95.10 | 0.5336 |
| 3 | −400.0316 | 0.2000 | | | |
| 4 | 72.5256 | 6.2454 | 1.77250 | 49.63 | 0.5504 |
| 5 | 249.9764 | (d5) | | | |
| 6* | 108.6663 | 1.6000 | 1.69350 | 53.20 | 0.5467 |
| 7* | 19.7189 | 8.5536 | | | |
| 8 | −43.4806 | 1.4000 | 1.69680 | 55.46 | 0.5426 |
| 9 | 26.3610 | 7.7853 | 1.72047 | 34.71 | 0.5834 |
| 10 | −40.7874 | 1.6235 | | | |
| 11* | −25.0635 | 1.1000 | 1.59201 | 67.02 | 0.5358 |
| 12* | −80.3927 | (d12) | | | |
| 13(diaphragm) | ∞ | 1.5000 | | | |
| 14 | 64.4130 | 4.5545 | 1.55032 | 75.50 | 0.5401 |
| 15 | −104.7718 | 0.1500 | | | |
| 16 | 66.3146 | 10.5596 | 1.59282 | 68.62 | 0.5440 |
| 17 | −29.8329 | 1.0000 | 1.74400 | 44.90 | 0.5631 |
| 18 | −122.5985 | 1.3551 | | | |
| 19 | −55.4177 | 1.0000 | 1.74951 | 35.33 | 0.5818 |
| 20 | 37.8660 | 6.2752 | 1.78880 | 28.42 | 0.6006 |
| 21 | −187.4083 | (d21) | | | |
| 22* | 112.8619 | 5.3142 | 1.69350 | 53.20 | 0.5467 |
| 23 | −50.2663 | 0.1000 | | | |
| 24 | −72.2356 | 1.0000 | 1.73037 | 32.23 | 0.5899 |
| 25 | 38.9142 | 8.7116 | 1.43700 | 95.10 | 0.5336 |
| 26 | −58.3377 | 0.1000 | | | |
| 27 | 88.5131 | 4.3130 | 1.75500 | 52.32 | 0.5473 |
| 28 | −110.2222 | (d28) | | | |
| 29 | 119.3467 | 2.2385 | 1.68430 | 26.81 | 0.6232 |
| 30 | −1232.6333 | 1.0000 | 1.59349 | 67.00 | 0.5366 |
| 31 | 34.6525 | (d31) | | | |
| 32* | 42.4586 | 1.5000 | 1.69350 | 53.20 | 0.5467 |
| 33 | 20.7326 | 17.7531 | 1.48749 | 70.44 | 0.5306 |
| 34 | −25.6377 | 1.5000 | 1.75500 | 52.32 | 0.5473 |
| 35 | 580.8799 | (BF) | | | |
| Image surface | ∞ | | | | |

[Aspherical Surface Data]

| | Surface 6 | Surface 7 | Surface 11 | Surface 12 | Surface 22 |
|---|---|---|---|---|---|
| K | 0.00000 | −1.00000 | 0.00000 | 0.00000 | 0.00000 |
| A4 | 1.20562E−06 | 1.68701E−05 | −7.87056E−06 | −5.89962E−06 | −5.83684E−06 |
| A6 | 1.04119E−09 | 2.25846E−08 | −3.83060E−09 | −3.64429E−10 | 2.87448E−09 |
| A8 | 2.20890E−11 | 1.56178E−10 | −1.12975E−11 | −3.79056E−11 | 2.46921E−12 |
| A10 | −7.44295E−14 | −4.74431E−13 | −3.26102E−14 | 1.12067E−13 | −2.02116E−14 |
| A12 | 8.84713E−17 | 2.83689E−15 | −4.06654E−16 | −4.97873E−16 | 3.35568E−17 |

| | Surface 32 |
|---|---|
| K | 0.00000 |
| A4 | 3.47196E−06 |
| A6 | 1.73401E−09 |
| A8 | 2.14902E−11 |
| A10 | −5.79139E−14 |
| A12 | 7.95386E−17 |

[Various Types of Data]
Zoom ratio 3.53

| | Wide angle | Intermediate | Telephoto |
|---|---|---|---|
| Focal length | 28.84 | 50.00 | 101.85 |
| F number | 2.91 | 2.91 | 2.91 |
| Total angle of view 2ω | 77.73 | 45.64 | 22.86 |
| Image height Y | 21.63 | 21.63 | 21.63 |
| Total length of lens | 175.20 | 191.20 | 215.20 |

[Variable Distance Data]

| | Wide angle | Intermediate | Telephoto |
|---|---|---|---|
| d0 | ∞ | ∞ | ∞ |
| d5 | 1.6000 | 19.1285 | 44.6731 |
| d12 | 24.7655 | 13.0295 | 1.5000 |
| d21 | 8.3406 | 3.0682 | 1.5000 |
| d28 | 3.2854 | 1.5000 | 3.8471 |
| d31 | 5.2443 | 22.5095 | 31.7156 |
| BF | 23.0485 | 23.0485 | 23.0485 |

[Lens Group Data]

| Group | Starting surface | Focal length |
|---|---|---|
| G1 | 1 | 118.97 |
| G2 | 6 | −22.01 |
| G3 | 13 | 60.94 |
| G4 | 22 | 41.59 |
| G5 | 29 | −89.87 |
| G6 | 32 | −243.27 |

### Example 6

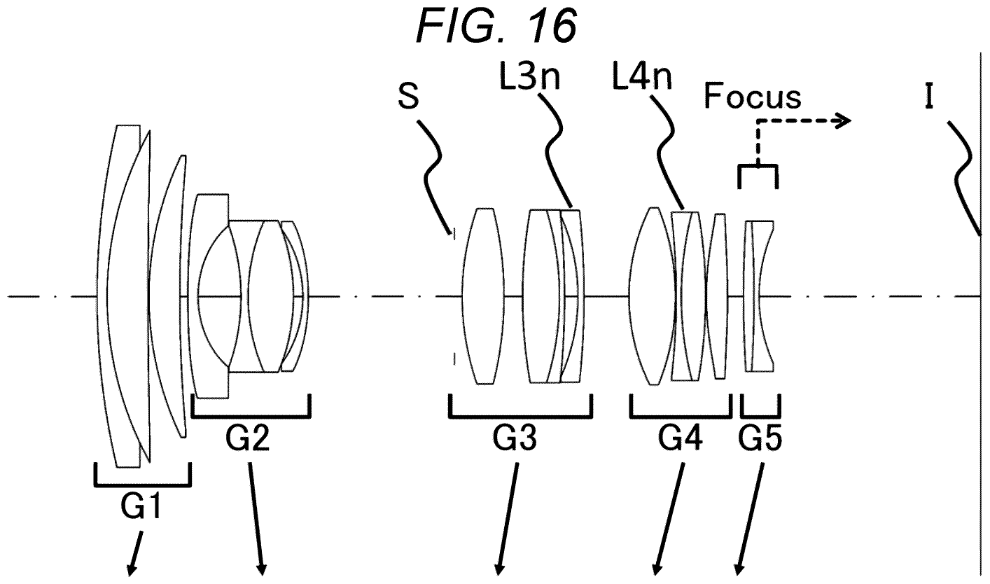

FIG. 16 is a lens configuration diagram of a variable magnification optical system of Example 6 of the present invention.

Example 6 consists of, in order from the object side, the first lens group G1 having a positive refractive power, the second lens group G2 having a negative refractive power, the aperture diaphragm S, the third lens group G3 having a positive refractive power, the fourth lens group G4 having a positive refractive power, and the fifth lens group G5 having a negative refractive power. The fifth lens group G5 corresponds to the last lens group GL.

During zooming from the wide-angle end to the telephoto end, the distance between the first lens group G1 and the second lens group G2 increases, the distance between the second lens group G2 and the third lens group G3 decreases, the distance between the third lens group G3 and the fourth lens group G4 decreases, and the distance between the fourth lens group G4 and the fifth lens group G5 increases.

During focusing from the infinity end to the closest object end, the fifth lens group G5 moves to the image side along the optical axis.

The first lens group G1 consists of, in order from the object side, a cemented lens of a negative meniscus lens convex toward the object side and a positive meniscus lens convex toward the object side, and a positive meniscus lens convex toward the object side.

The second lens group G2 consists of, in order from the object side, a negative meniscus lens convex toward the object side, a cemented lens of a biconcave lens and a biconvex lens, and a negative meniscus lens convex toward the image side.

The third lens group G3 consists of an aperture diaphragm S, a biconvex lens, a cemented lens of a biconvex lens and a negative meniscus lens convex toward the image side, and a negative meniscus lens L3n convex toward the image side, in order from the object side.

The fourth lens group G4 consists of a biconvex lens, a cemented lens of a biconcave lens L4n and a biconvex lens, and a biconvex lens, in order from the object side.

The fifth lens group G5 consists of a cemented lens of a biconvex lens and a biconcave lens, in order from the object side.

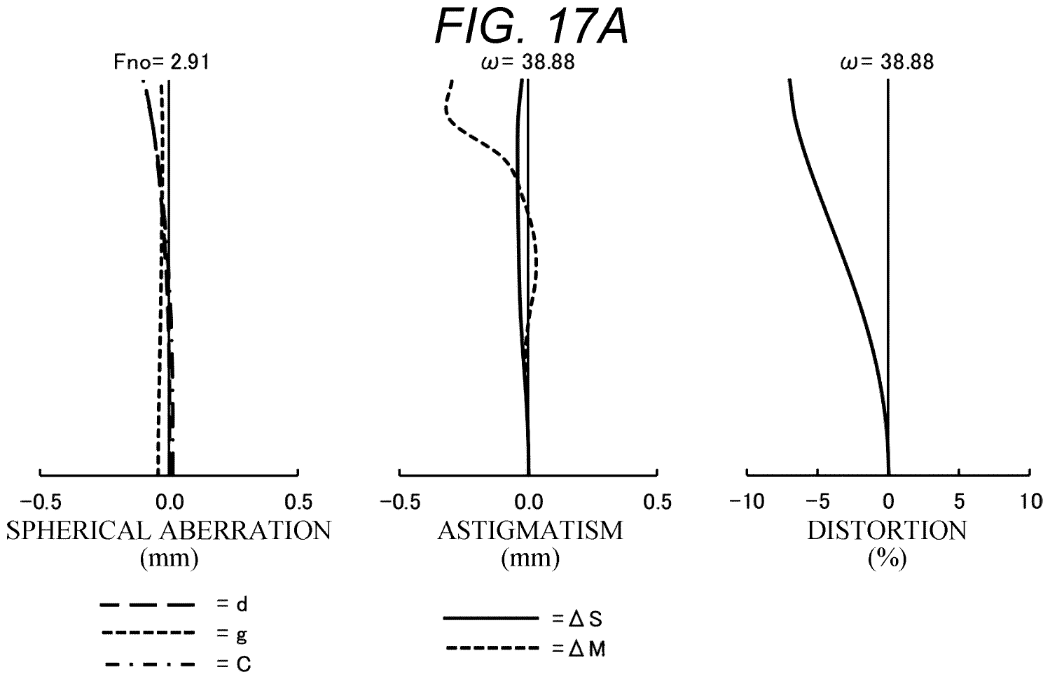

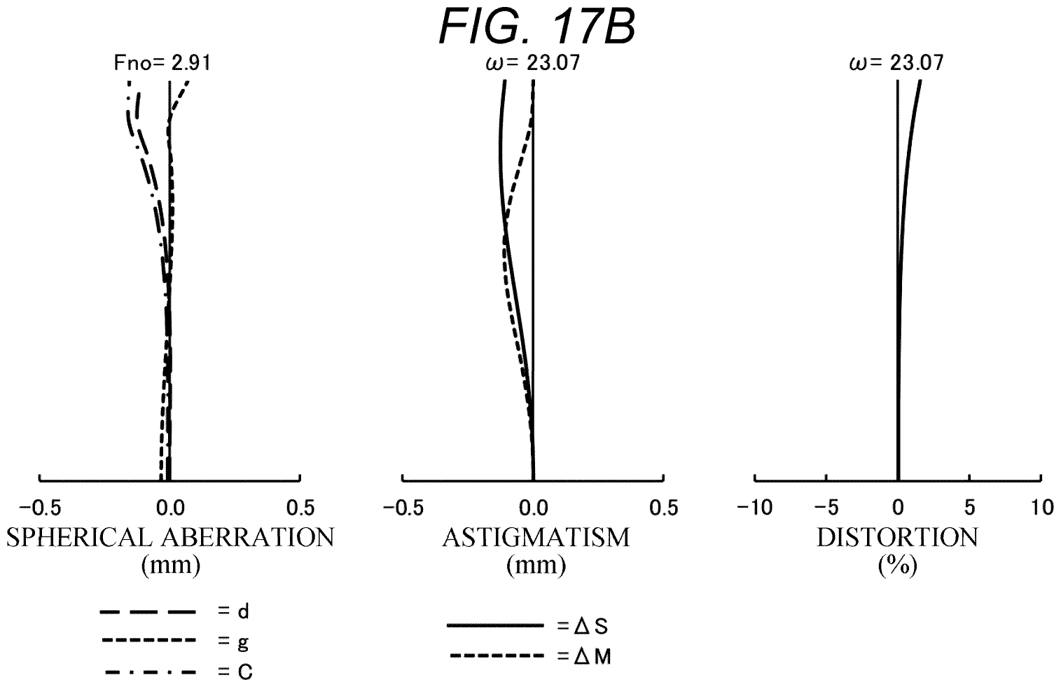

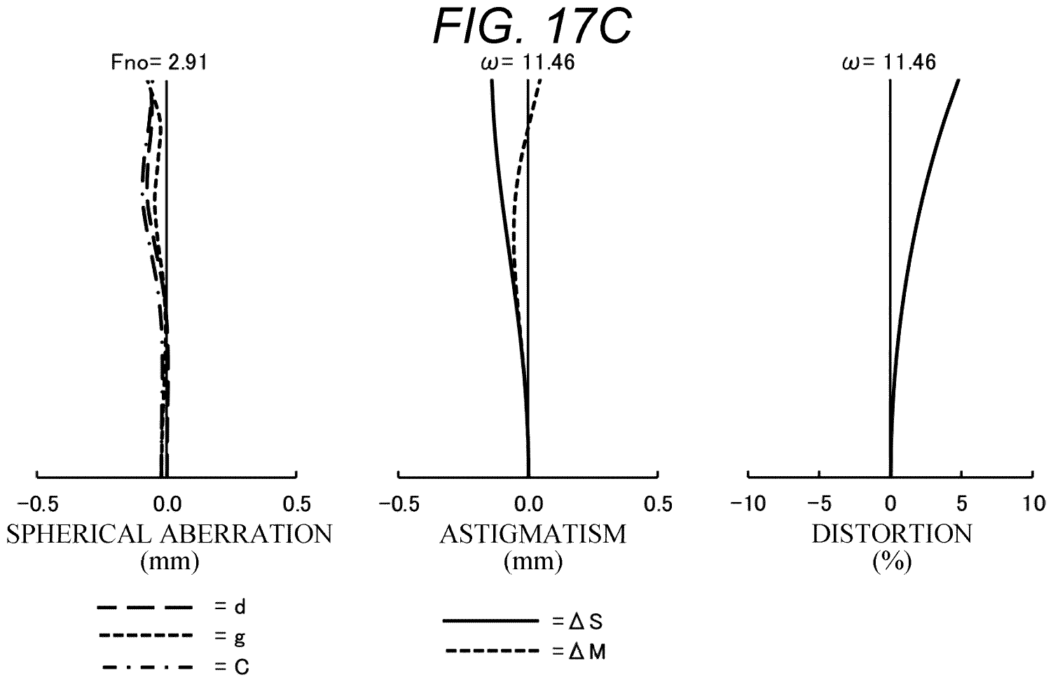

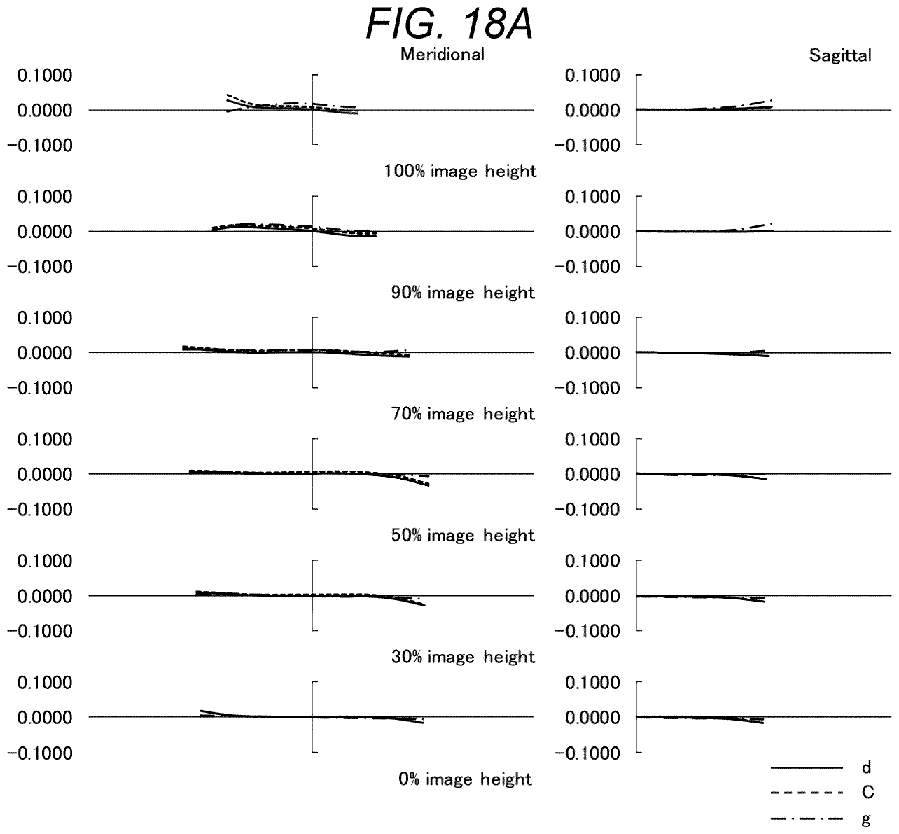

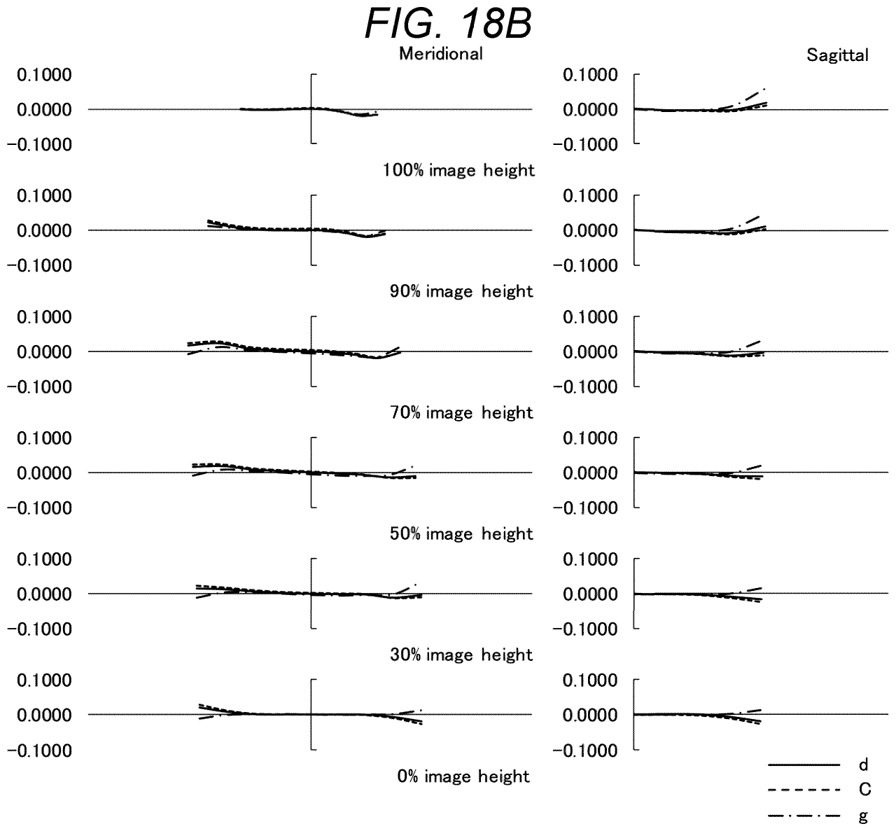

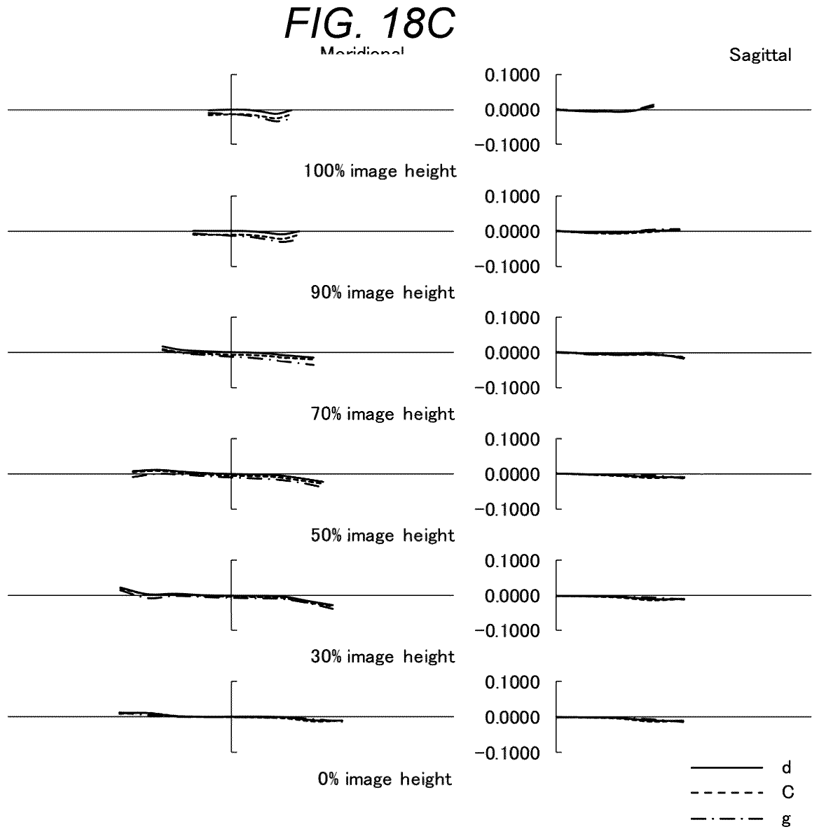

FIGS. 17A, 17B, and 17C are longitudinal aberration diagrams in a case where an infinite distance object is in focus at a wide-angle end, an intermediate focal length, and a telephoto end, respectively, according to Example 6. FIGS. 18A, 18B, and 18C are lateral aberration diagrams in a case where an infinite distance object is in focus at a wide-angle end, an intermediate focal length, and a telephoto end, respectively, according to Example 6. From the aberration diagrams, it can be seen that in the variable magnification optical system according to the present example, various aberrations are satisfactorily corrected from the wide-angle end to the telephoto end, and excellent image formation performance is obtained.

The specification values according to Example 6 of the present invention are shown below.

### Numerical Example 6

Unit: mm

[Surface data]

| Surface number | r | d | nd | vd | PgF |
|---|---|---|---|---|---|
| Object surface | ∞ | (d0) | | | |
| 1 | 151.4338 | 2.0000 | 1.84666 | 23.78 | 0.6192 |
| 2 | 70.1091 | 8.0563 | 1.43700 | 95.10 | 0.5336 |
| 3 | 1161.4935 | 0.2000 | | | |
| 4 | 66.2043 | 6.0728 | 1.85033 | 42.70 | 0.5646 |
| 5 | 312.9615 | (d5) | | | |
| 6* | 200.0000 | 2.0000 | 1.77377 | 47.17 | 0.5557 |
| 7* | 21.1321 | 8.4708 | | | |
| 8 | −42.6075 | 1.4000 | 1.77250 | 49.63 | 0.5504 |
| 9 | 38.2830 | 8.9449 | 1.78880 | 28.43 | 0.6009 |
| 10 | −39.5257 | 1.8540 | | | |
| 11* | −23.7321 | 1.1000 | 1.69350 | 53.18 | 0.5482 |
| 12* | −42.9357 | (d12) | | | |
| 13(diaphragm) | ∞ | 1.5000 | | | |
| 14* | 52.5953 | 8.2497 | 1.55332 | 71.69 | 0.5404 |
| 15 | −72.2621 | 3.6518 | | | |
| 16 | 100.4069 | 7.2700 | 1.43700 | 95.10 | 0.5336 |
| 17 | −59.3146 | 1.0000 | 1.61266 | 44.46 | 0.5640 |
| 18 | −168.3586 | 2.6430 | | | |
| 19 | −39.9587 | 1.2000 | 1.61266 | 44.46 | 0.5640 |
| 20 | −163.0217 | (d20) | | | |
| 21 | 40.5789 | 9.1529 | 1.43700 | 95.10 | 0.5336 |
| 22 | −48.2149 | 0.1500 | | | |
| 23 | −142.8106 | 1.0000 | 1.73800 | 32.33 | 0.5900 |
| 24 | 68.5186 | 4.7884 | 1.43700 | 95.10 | 0.5336 |
| 25 | −98.8788 | 0.1500 | | | |
| 26* | 61.2750 | 4.1724 | 1.55332 | 71.69 | 0.5404 |
| 27* | −155.5945 | (d27) | | | |
| 28 | 235.0137 | 2.0828 | 1.90110 | 27.06 | 0.6072 |
| 29 | −235.0137 | 1.0000 | 1.59201 | 67.02 | 0.5358 |
| 30* | 33.8176 | (BF) | | | |
| Image surface | ∞ | | | | |

[Aspherical Surface Data]

| | Surface 6 | Surface 7 | Surface 11 | Surface 12 | Surface 14 |
|---|---|---|---|---|---|
| K | 0.00000 | −1.00000 | 0.00000 | 0.00000 | 0.00000 |
| A4 | 3.70073E−06 | 1.63899E−05 | 1.28947E−06 | −3.55106E−06 | −1.22372E−06 |
| A6 | 6.14079E−09 | 3.25507E−08 | −4.61728E−09 | −1.07358E−08 | 2.34962E−09 |
| A8 | −9.49773E−12 | 1.85692E−10 | 1.35851E−12 | −2.52869E−11 | −1.97772E−11 |
| A10 | −5.84650E−14 | −5.74426E−13 | −7.92797E−14 | 6.54028E−14 | 8.05280E−14 |
| A12 | 2.06524E−16 | −5.45136E−16 | −2.37081E−16 | −9.86488E−17 | −1.33920E−16 |
| A14 | 2.35109E−19 | 9.58085E−18 | 2.37094E−18 | −3.72934E−19 | 0.00000E+00 |
| A16 | −8.48033E−22 | 1.36466E−19 | 1.89493E−21 | −3.01643E−21 | 0.00000E+00 |
| A18 | −2.62794E−24 | −7.31630E−22 | −5.98903E−23 | −1.01052E−23 | 0.00000E+00 |
| A20 | 5.95733E−27 | 9.06212E−25 | −1.49863E−25 | −9.24719E−27 | 0.00000E+00 |

| | Surface 26 | Surface 27 | Surface 30 |
|---|---|---|---|
| K | 0.00000 | 0.00000 | 0.00000 |
| A4 | −3.41581E−06 | 6.27992E−06 | 5.25680E−07 |
| A6 | −1.04251E−08 | −8.29989E−09 | 1.23822E−09 |
| A8 | 3.53385E−11 | 3.67806E−11 | 3.93473E−12 |
| A10 | −6.35480E−14 | 6.79988E−15 | −1.34511E−13 |
| A12 | −3.05828E−16 | −4.63745E−16 | 3.73957E−16 |
| A14 | 0.00000E+00 | 0.00000E+00 | 0.00000E+00 |
| A16 | 0.00000E+00 | 0.00000E+00 | 0.00000E+00 |
| A18 | 0.00000E+00 | 0.00000E+00 | 0.00000E+00 |
| A20 | 0.00000E+00 | 0.00000E+00 | 0.00000E+00 |

[Various Types of Data]
Zoom ratio 3.53

| | Wide angle | Intermediate | Telephoto |
|---|---|---|---|
| Focal length | 28.84 | 50.00 | 101.85 |
| F number | 2.91 | 2.91 | 2.91 |
| Total angle of view 2ω | 77.75 | 46.13 | 22.91 |
| Image height Y | 21.63 | 21.63 | 21.63 |
| Total length of lens | 174.18 | 182.80 | 200.08 |

[Variable Distance Data]

| | Wide angle | Intermediate | Telephoto |
|---|---|---|---|
| d0 | ∞ | ∞ | ∞ |
| d5 | 1.6000 | 14.9546 | 38.0109 |
| d12 | 28.7190 | 15.1911 | 1.5000 |
| d20 | 8.8423 | 2.1453 | 1.5000 |
| d27 | 3.1328 | 1.7994 | 5.3513 |
| BF | 43.7729 | 60.6013 | 65.6048 |

[Lens Group Data]

| Group | Starting surface | Focal length |
|---|---|---|
| G1 | 1 | 104.20 |
| G2 | 6 | −22.76 |
| G3 | 13 | 71.83 |
| G4 | 21 | 39.69 |
| G5 | 28 | −81.75 |

### Example 7

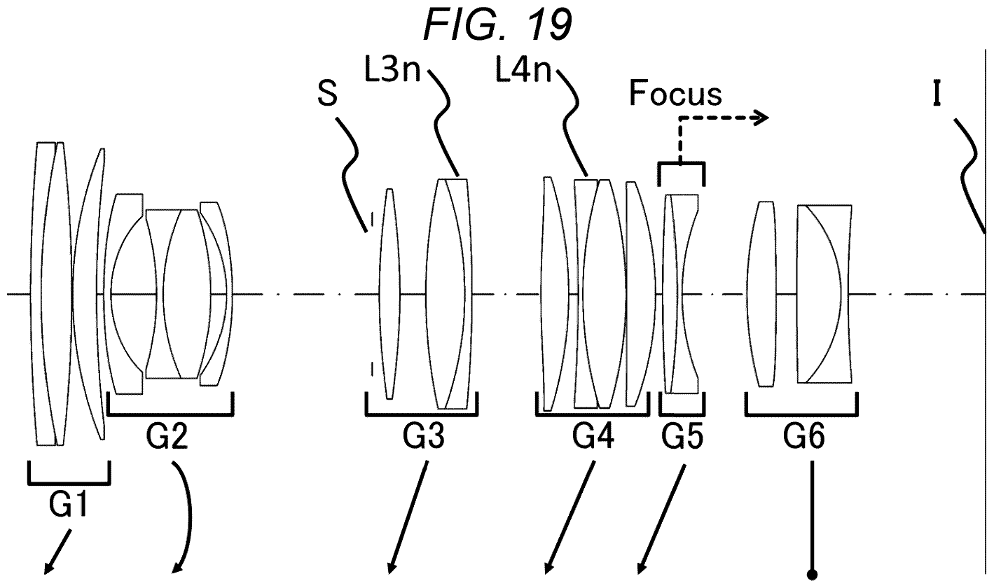

FIG. 19 is a lens configuration diagram according to Example 7 of the present invention.

In Example 7, the zoom lens consists of, in order from the object side, a first lens group G1 having a positive refractive power, a second lens group G2 having a negative refractive power, an aperture diaphragm S, a third lens group G3 having a positive refractive power, a fourth lens group G4 having a positive refractive power, a fifth lens group G5 having a negative refractive power, and a sixth lens group G6 having a negative refractive power. The sixth lens group G6 corresponds to the last lens group GL.

During zooming from the wide-angle end to the telephoto end, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 increases, and the distance between the fifth lens group G5 and the sixth lens group G6 increases. The sixth lens group G6 remains stationary with respect to the image surface I during zooming.

During focusing from the infinity end to the closest object end, the fifth lens group G5 moves to the image side along the optical axis.

The first lens group G1 consists of, in order from the object side, a cemented lens of a negative meniscus lens convex toward the object side and a biconvex lens, and a positive meniscus lens convex toward the object side.

The second lens group G2 consists of, in order from the object side, a negative meniscus lens convex toward the object side, a cemented lens of a biconcave lens and a biconvex lens, and a negative meniscus lens convex toward the image side.

The third lens group G3 consists of, in order from the object side, an aperture diaphragm S, a biconvex lens, and a cemented lens of a biconvex lens and a negative meniscus lens L3n convex toward the image side.

The fourth lens group G4 consists of, in order from the object side, a biconvex lens, a cemented lens of a biconcave lens L4n and a biconvex lens, and a positive meniscus lens convex toward the image side.

The fifth lens group G5 consists of a cemented lens of a biconvex lens and a biconcave lens, in order from the object side.

The sixth lens group G6 consists of a biconvex lens, and a cemented lens of a biconvex lens and a biconcave lens, in order from the object side.

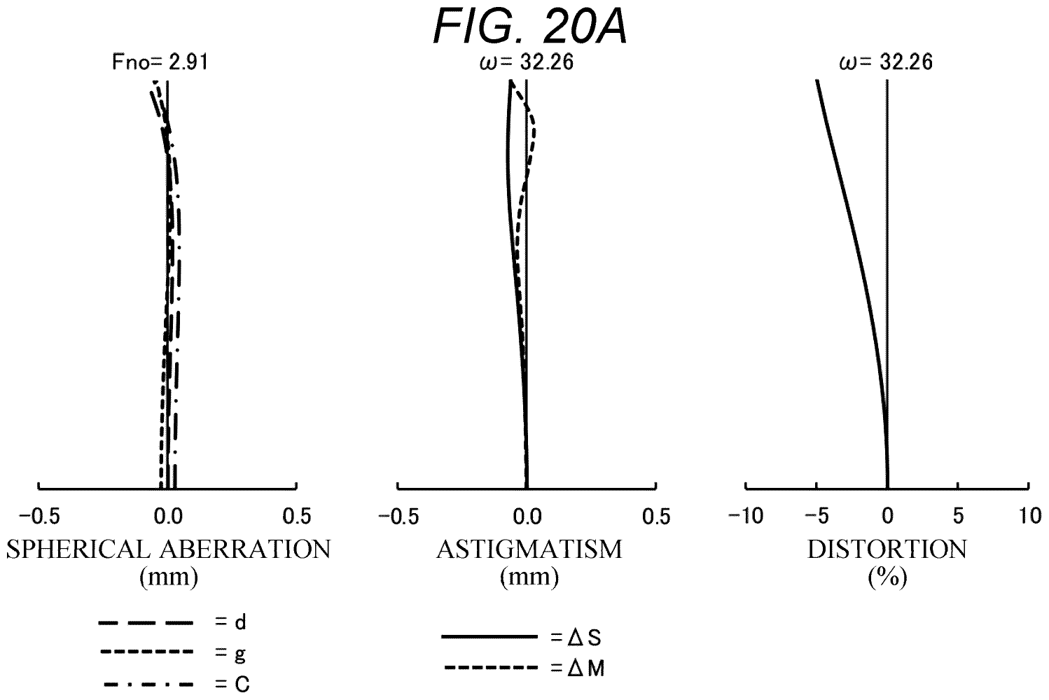

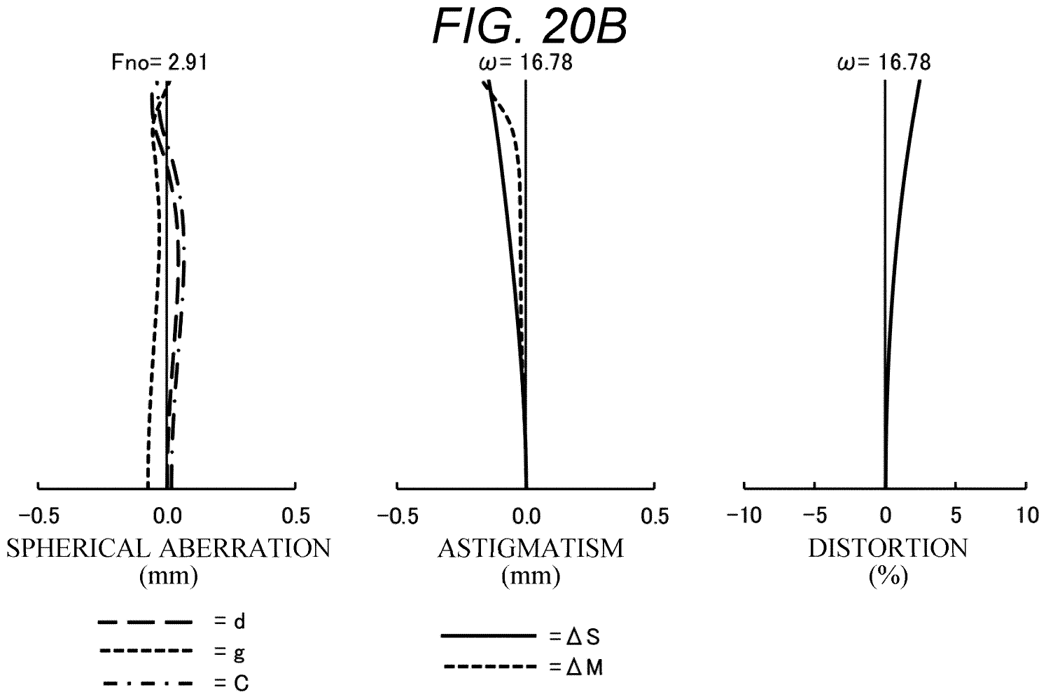

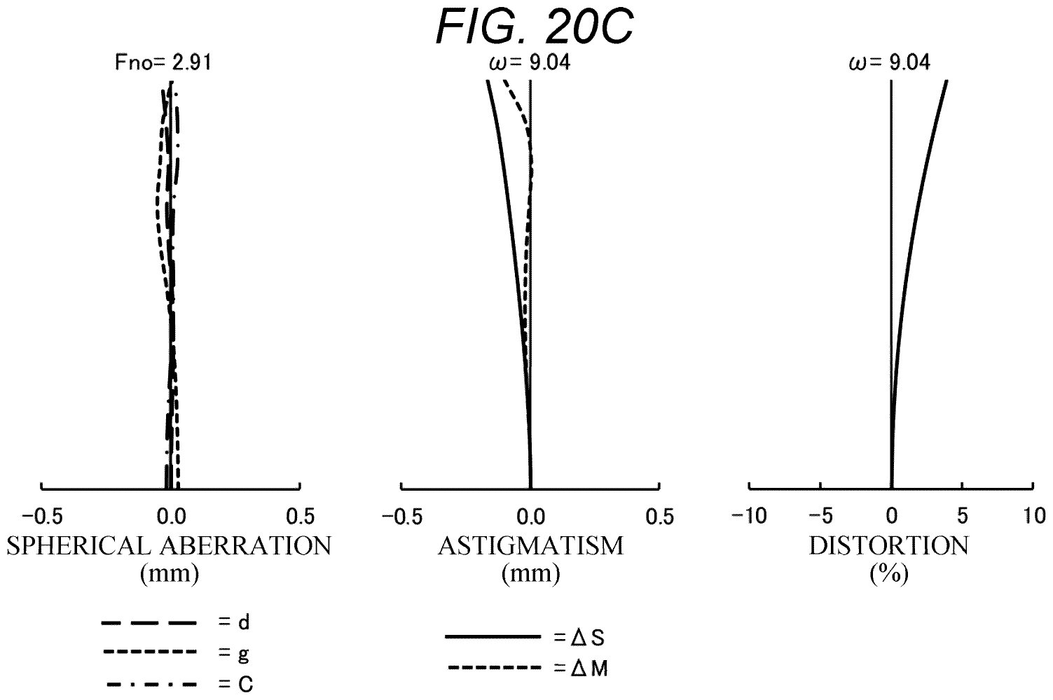

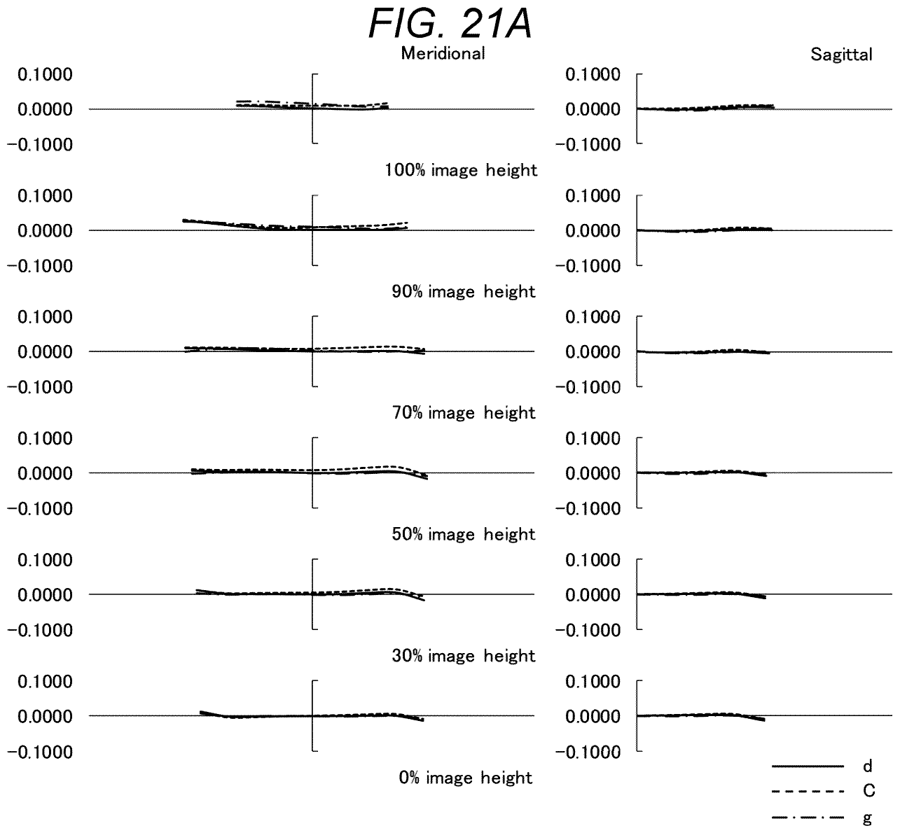

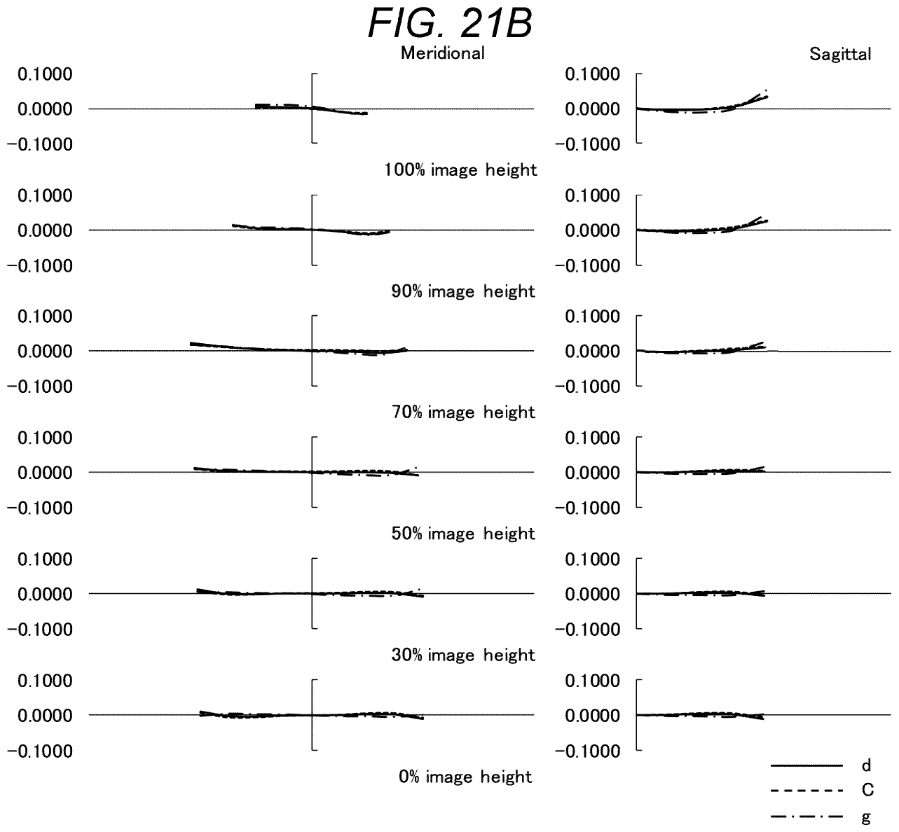

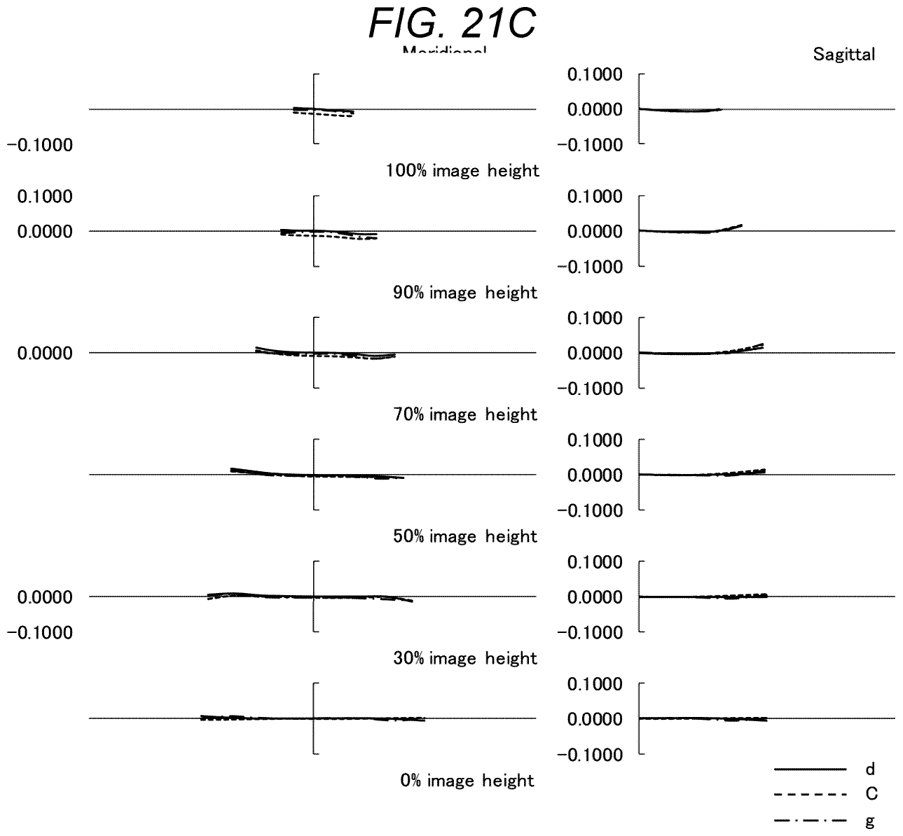

FIGS. 20A, 20B, and 20C are longitudinal aberration diagrams in a case where an infinite distance object is in focus at a wide-angle end, an intermediate focal length, and a telephoto end, respectively, according to Example 7. FIGS. 21A, 21B, and 21C are lateral aberration diagrams in a case where an infinite distance object is in focus at a wide-angle end, an intermediate focal length, and a telephoto end, respectively, according to Example 7. From the aberration diagrams, it can be seen that in the variable magnification optical system according to the present example, various aberrations are satisfactorily corrected from the wide-angle end to the telephoto end, and excellent image formation performance is obtained.

The specification values according to Example 7 of the present invention are shown below.

### Numerical Example 7

Unit: mm

[Surface data]

| Surface number | r | d | nd | vd | PgF |
|---|---|---|---|---|---|
| Object surface | ∞ | (d0) | | | |
| 1 | 339.1037 | 2.2000 | 1.84666 | 23.78 | 0.6192 |
| 2 | 140.5622 | 6.3134 | 1.43700 | 95.10 | 0.5336 |
| 3 | −256.2897 | 0.2000 | | | |
| 4 | 75.0019 | 4.9733 | 1.69680 | 55.46 | 0.5426 |
| 5 | 218.0286 | (d5) | | | |
| 6* | 96.2508 | 1.5000 | 1.69350 | 53.18 | 0.5482 |
| 7* | 22.9090 | 9.5225 | | | |
| 8 | −52.4864 | 1.4000 | 1.69680 | 55.46 | 0.5426 |
| 9 | 39.6244 | 9.9269 | 1.68960 | 31.14 | 0.6031 |
| 10 | −50.6074 | 3.3000 | | | |
| 11* | −26.2180 | 1.2000 | 1.58913 | 61.25 | 0.5374 |
| 12* | −63.8015 | (d12) | | | |
| 13(diaphragm) | ∞ | 1.5000 | | | |
| 14* | 124.7274 | 4.2858 | 1.55332 | 71.69 | 0.5404 |
| 15* | −124.7274 | 5.4144 | | | |
| 16 | 103.5446 | 8.1345 | 1.55032 | 75.50 | 0.5401 |
| 17 | −65.5833 | 1.5000 | 1.72342 | 37.99 | 0.5820 |
| 18 | −239.8010 | (d18) | | | |
| 19* | 175.4916 | 5.7946 | 1.55332 | 71.69 | 0.5404 |
| 20* | −71.0848 | 1.9685 | | | |
| 21 | −300.0000 | 1.0000 | 1.73800 | 32.26 | 0.5896 |
| 22 | 76.8744 | 8.9856 | 1.43700 | 95.10 | 0.5336 |
| 23 | −76.4879 | 0.1500 | | | |
| 24 | −3011.9276 | 6.0032 | 1.55032 | 75.50 | 0.5401 |
| 25 | −60.2741 | (d25) | | | |
| 26 | 329.0123 | 3.0206 | 1.80610 | 33.27 | 0.5884 |
| 27 | −142.6606 | 1.0000 | 1.58913 | 61.25 | 0.5403 |
| 28 | 44.0347 | (d28) | | | |
| 29* | 70.0105 | 6.0695 | 1.58913 | 61.25 | 0.5374 |
| 30* | −790.6205 | 4.3136 | | | |
| 31 | 781.5251 | 9.2092 | 1.71338 | 26.04 | 0.6297 |
| 32 | −25.0000 | 1.5000 | 2.00100 | 29.13 | 0.5995 |
| 33 | 203.9971 | (BF) | | | |
| Image surface | ∞ | | | | |

[Aspherical Surface Data]

| | Surface 6 | Surface 7 | Surface 11 | Surface 12 | Surface 14 |
|---|---|---|---|---|---|
| K | 0.00000 | −1.00000 | −1.00000 | 0.00000 | 0.00000 |
| A4 | 2.52743E−06 | 1.25164E−05 | −5.62862E−06 | −2.92132E−06 | −8.88979E−07 |
| A6 | 3.88924E−09 | 2.12690E−08 | 4.55818E−10 | 1.20480E−09 | −7.62713E−11 |
| A8 | −8.08322E−12 | 1.47497E−11 | −7.74093E−12 | −1.71475E−11 | −4.15453E−13 |
| A10 | −1.20972E−15 | 1.64395E−13 | −5.74930E−15 | 2.90325E−14 | 1.60017E−15 |
| A12 | 2.57303E−17 | 6.83255E−17 | −5.09029E−17 | −8.06100E−17 | −1.93054E−18 |
| A14 | 4.58729E−20 | −2.41670E−18 | −5.06920E−21 | 0.00000E+00 | −3.91589E−21 |
| A16 | −1.33950E−22 | 1.07440E−20 | 0.00000E+00 | 0.00000E+00 | 2.52162E−24 |

| | Surface 15 | Surface 19 | Surface 20 | Surface 29 | Surface 30 |
|---|---|---|---|---|---|
| K | 0.00000 | 0.00000 | 0.00000 | 0.00000 | 0.00000 |
| A4 | 8.88979E−07 | −2.87210E−06 | 1.45965E−06 | 1.61088E−06 | −1.15575E−06 |
| A6 | 7.62713E−11 | −4.44054E−10 | −1.54529E−09 | −4.09547E−09 | −6.65759E−09 |
| A8 | 4.15453E−13 | −1.06285E−12 | −4.59893E−13 | 1.49129E−11 | 4.72510E−12 |
| A10 | −1.60017E−15 | 1.59240E−15 | 1.36187E−15 | −4.56037E−14 | 6.83774E−15 |
| A12 | 1.93054E−18 | 5.06526E−19 | 0.00000E+00 | 1.29060E−16 | −5.42388E−17 |
| A14 | 3.91589E−21 | 0.00000E+00 | 0.00000E+00 | −3.03434E−19 | −1.01492E−19 |
| A16 | −2.52162E−24 | 0.00000E+00 | 0.00000E+00 | 0.00000E+00 | 0.00000E+00 |

[Various Types of Data]
Zoom ratio 3.63

| | Wide angle | Intermediate | Telephoto |
|---|---|---|---|
| Focal length | 36.05 | 70.00 | 130.94 |
| F number | 2.91 | 2.91 | 2.91 |
| Total angle of view 2ω | 64.53 | 33.56 | 18.07 |
| Image height Y | 21.63 | 21.63 | 21.63 |
| Total length of lens | 199.15 | 215.94 | 249.15 |

[Variable Distance Data]

| | Wide angle | Intermediate | Telephoto |
|---|---|---|---|
| d0 | ∞ | ∞ | ∞ |
| d5 | 1.5000 | 22.9692 | 50.4666 |
| d12 | 29.2284 | 9.9146 | 1.5000 |
| d18 | 14.3979 | 7.2216 | 5.6123 |
| d25 | 1.5000 | 4.7540 | 2.3627 |
| d28 | 13.5105 | 32.0582 | 50.1953 |
| BF | 28.6321 | 28.6321 | 28.6321 |

[Lens Group Data]

| Group | Starting surface | Focal length |
|---|---|---|
| G1 | 1 | 133.71 |
| G2 | 6 | −25.60 |
| G3 | 13 | 70.86 |
| G4 | 19 | 55.52 |
| G5 | 26 | −107.23 |
| G6 | 29 | −228.64 |

### Example 8

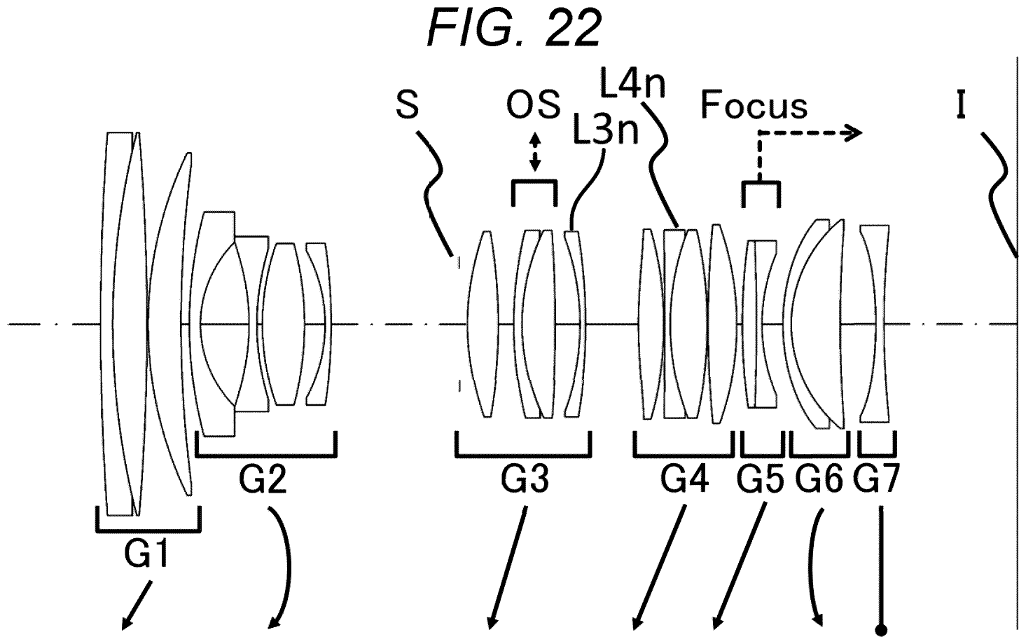

FIG. 22 is a lens configuration diagram according to Example 8 of the present invention.

In Example 8, the zoom lens consists of, in order from the object side, a first lens group G1 having a positive refractive power, a second lens group G2 having a negative refractive power, an aperture diaphragm S, a third lens group G3 having a positive refractive power, a fourth lens group G4 having a positive refractive power, a fifth lens group G5 having a negative refractive power, a sixth lens group G6 having a positive refractive power, and a seventh lens group G7 having a negative refractive power. The seventh lens group G7 corresponds to the last lens group GL.

During zooming from the wide-angle end to the telephoto end, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 decreases, the distance between the fifth lens group G5 and the sixth lens group G6 increases, and the distance between the sixth lens group G6 and the seventh lens group G7 increases. The seventh lens group G7 remains stationary with respect to the image surface I during zooming.

During focusing from the infinity end to the closest object end, the fifth lens group G5 moves to the image side along the optical axis.

The first lens group G1 consists of, in order from the object side, a cemented lens of a negative meniscus lens convex toward the object side and a biconvex lens, and a positive meniscus lens convex toward the object side.

The second lens group G2 consists of, in order from the object side, a negative meniscus lens convex toward the object side, a biconcave lens, a biconvex lens, and a negative meniscus lens convex toward the image side.

The third lens group G3 consists of, in order from the object side, an aperture diaphragm S, a biconvex lens, a cemented lens of a negative meniscus lens convex toward the object side and a biconvex lens, and a negative meniscus lens L3n convex toward the image side. In the case of the vibration reduction during the occurrence of the image blur, a cemented lens of a negative meniscus lens convex toward the object side which is second from the object side in the third lens group G3 and a third biconvex lens moves in a direction substantially perpendicular to the optical axis.

The fourth lens group G4 consists of a biconvex lens, a cemented lens of a biconcave lens L4n and a biconvex lens, and a biconvex lens, in order from the object side.

The fifth lens group G5 consists of a cemented lens of a biconvex lens and a biconcave lens, in order from the object side.

The sixth lens group G6 consists of a cemented lens of a negative meniscus lens convex toward the object side and a positive meniscus lens convex toward the object side, in order from the object side.

The seventh lens group G7 consists of a biconcave lens.

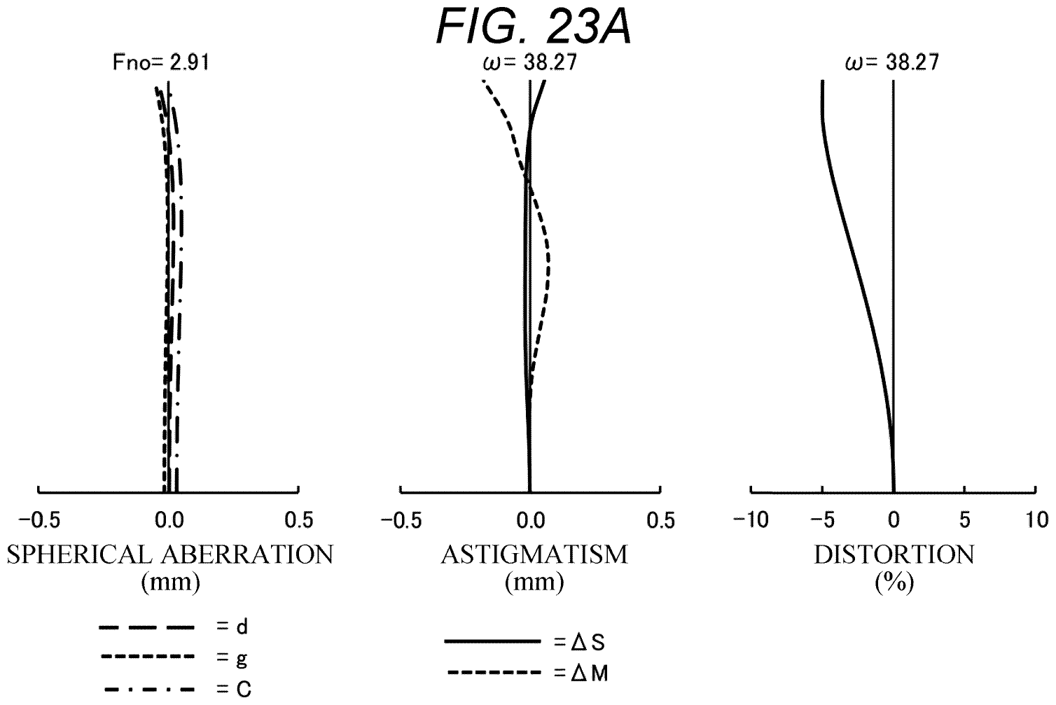

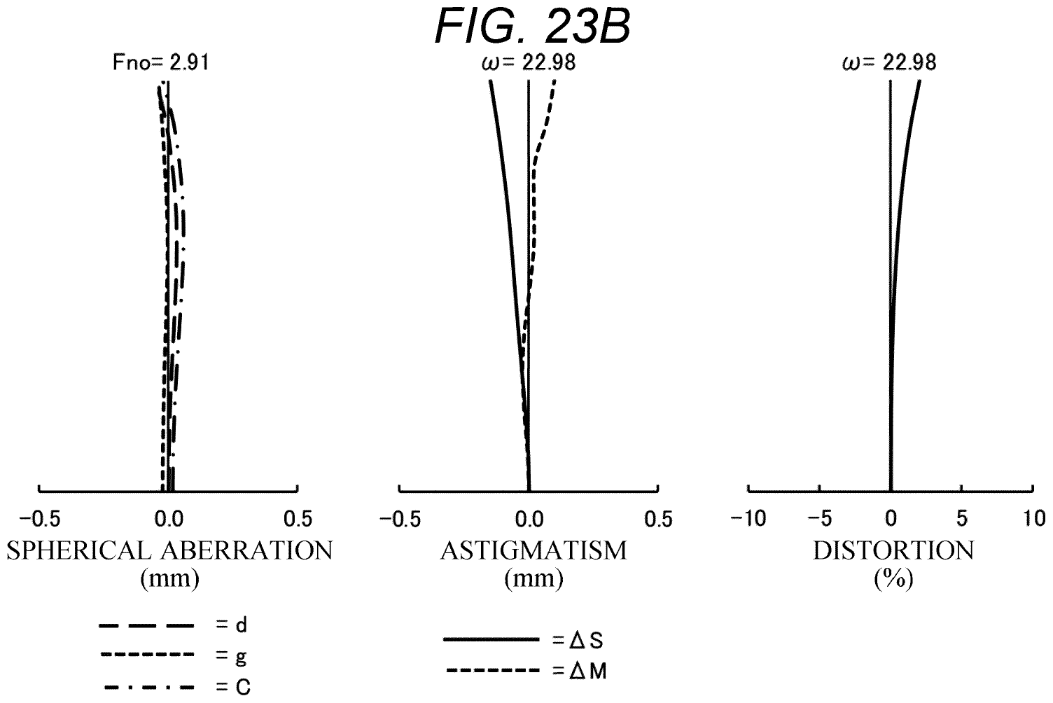

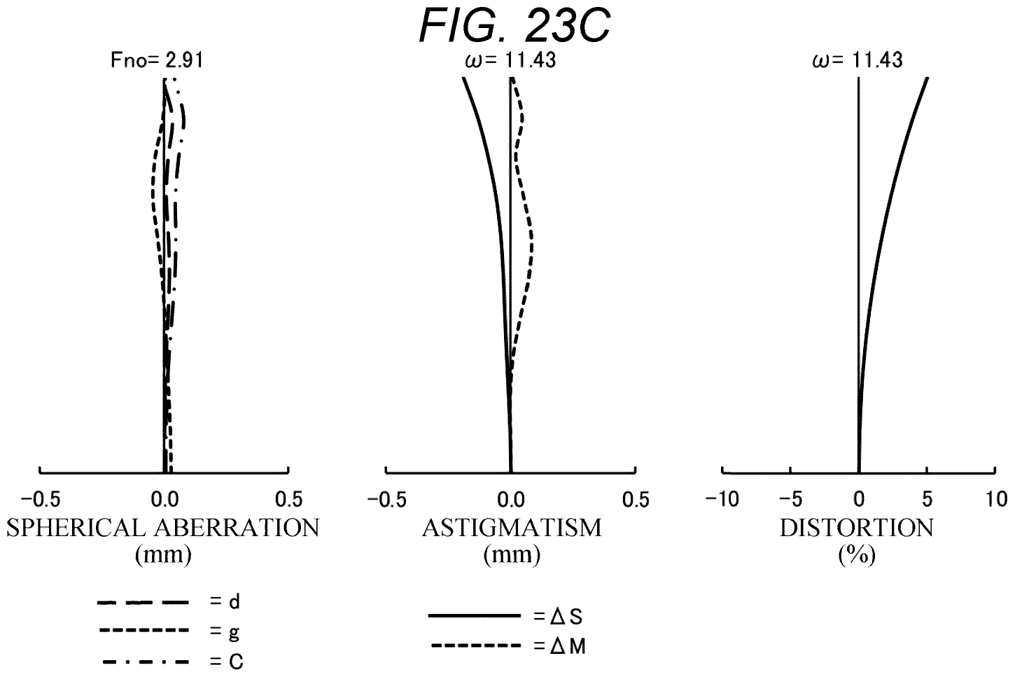

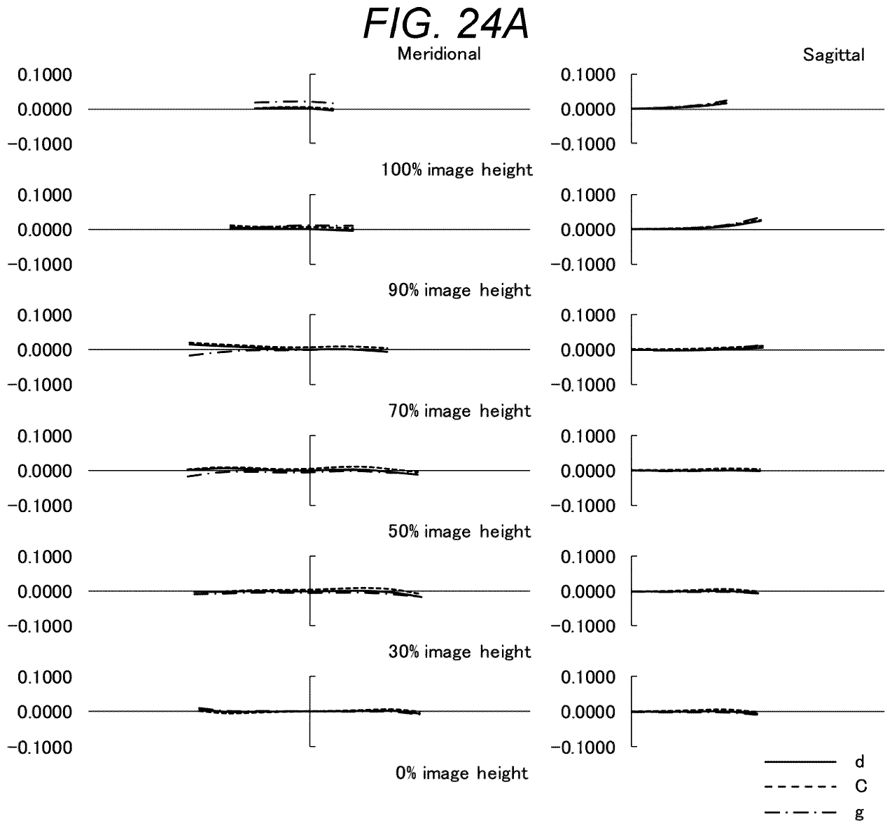

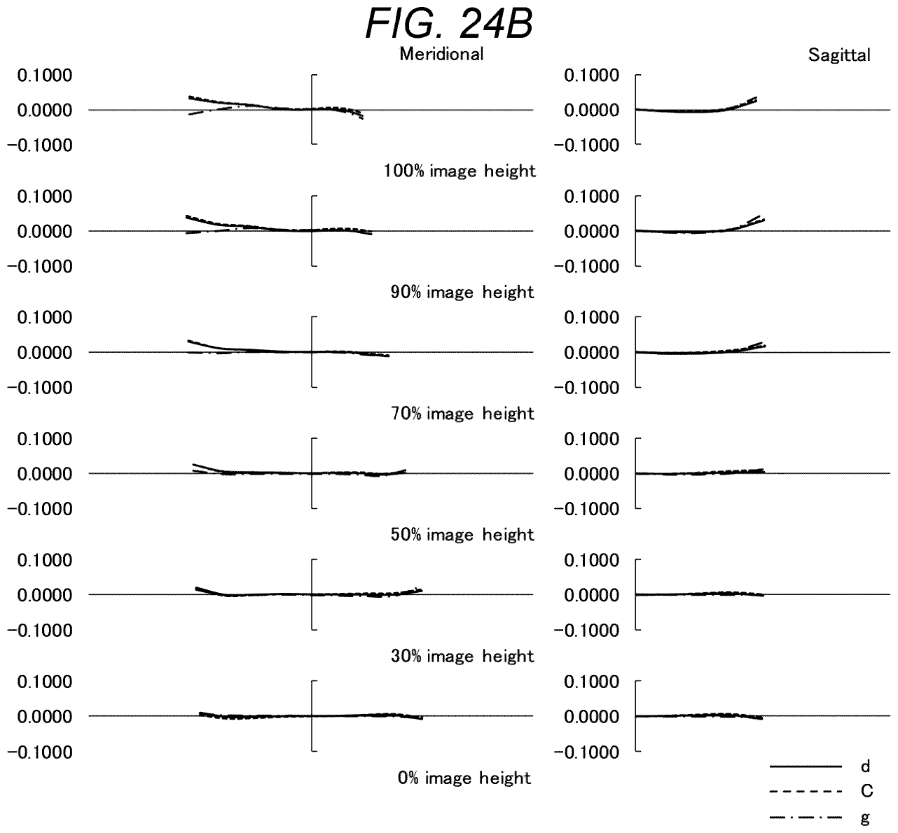

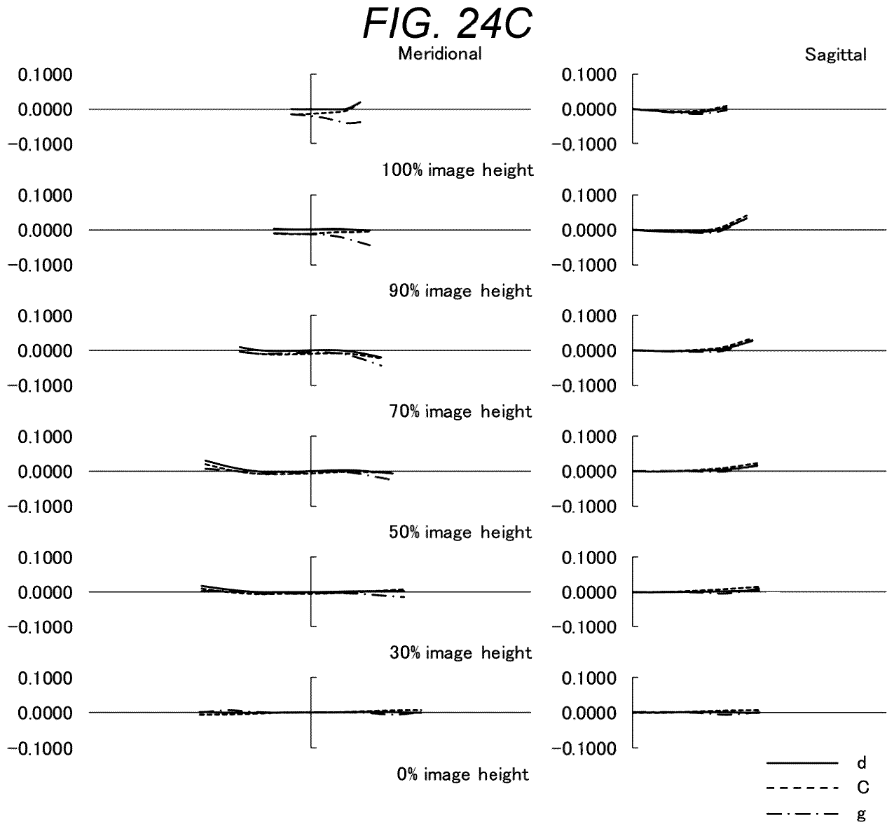

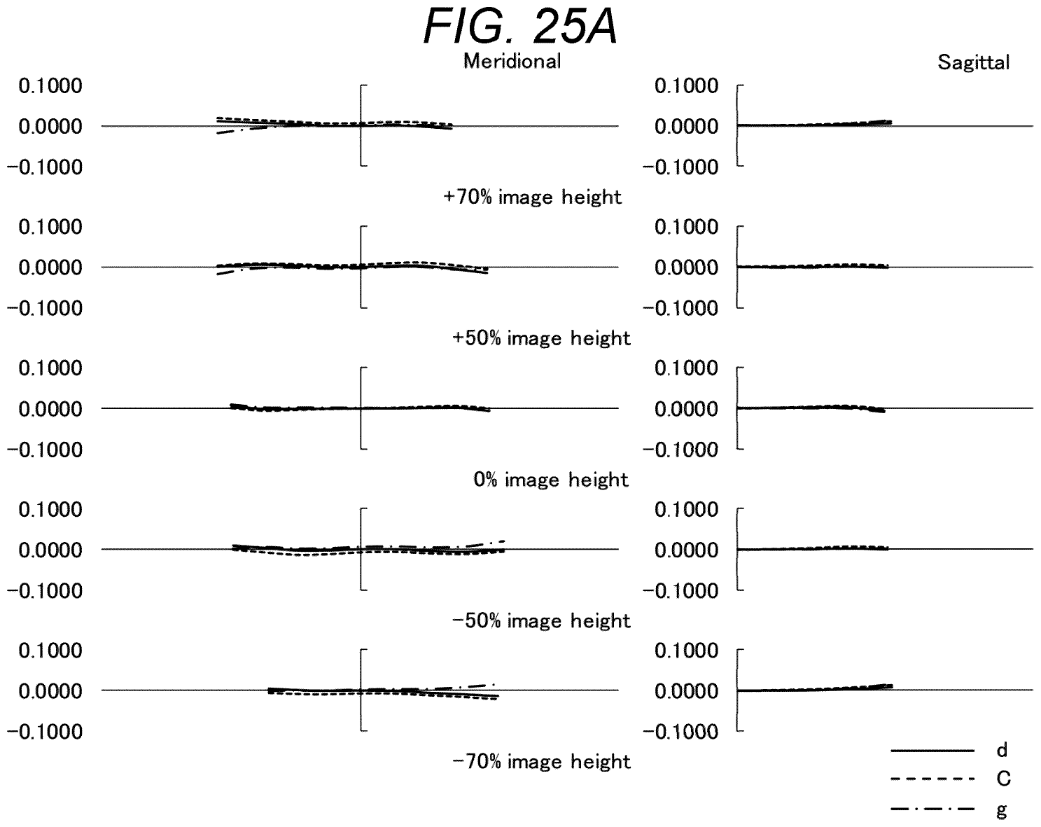

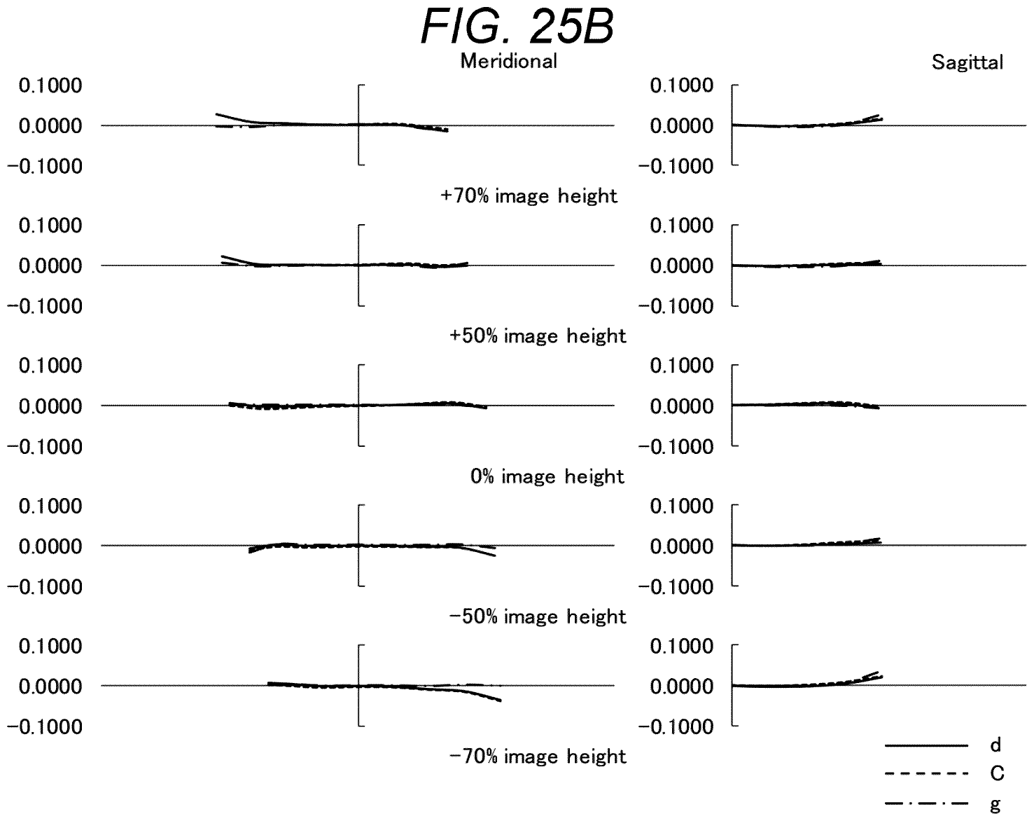

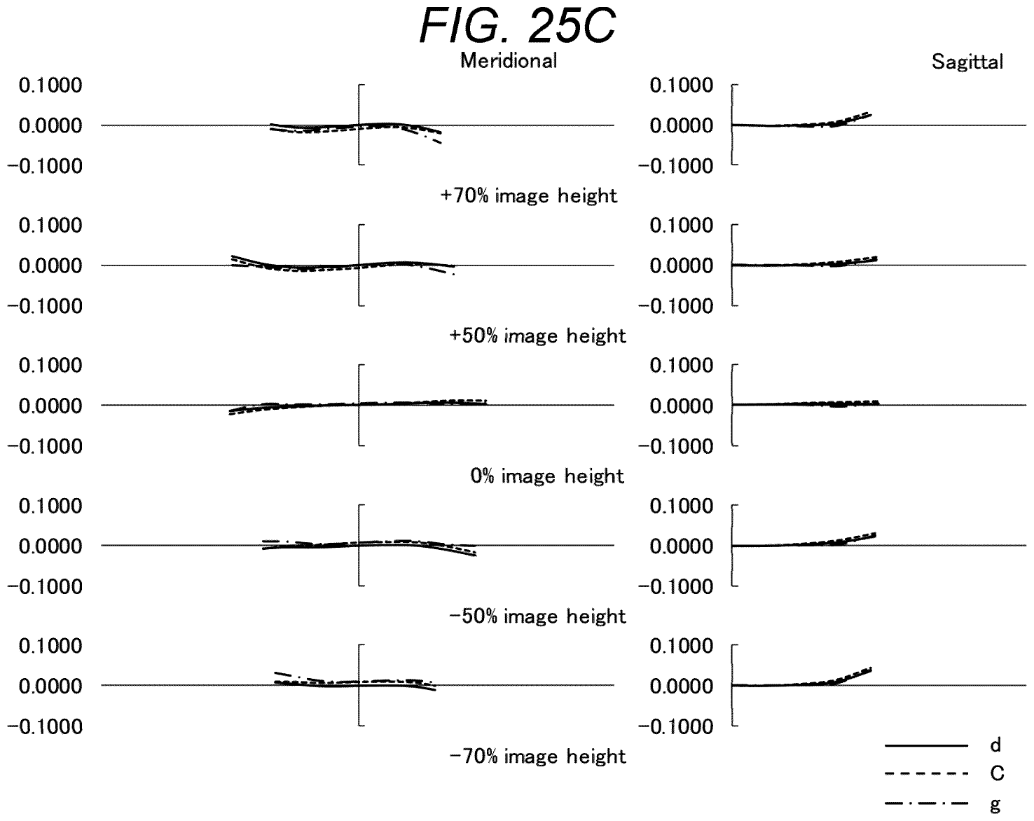

FIGS. 23A, 23B, and 23C are longitudinal aberration diagrams in a case where an infinite distance object is in focus at a wide-angle end, an intermediate focal length, and a telephoto end, respectively, according to Example 8. FIGS. 24A, 24B, and 24C are lateral aberration diagrams in a case where an infinite distance object is in focus at a wide-angle end, an intermediate focal length, and a telephoto end, respectively, according to Example 8. FIGS. 25A, 25B, and 25C are lateral aberration diagrams in a case where a vibration reduction is performed at an image blur correction angle of 0.3° during focusing on an infinite distance object at a wide-angle end, an intermediate focal length, and a telephoto end, respectively, according to Example 8. From the aberration diagrams, it can be seen that in the variable magnification optical system according to the present example, various aberrations are satisfactorily corrected from the wide-angle end to the telephoto end, and excellent image formation performance is obtained.

The specification values according to Example 8 of the present invention are shown below.

### Numerical Example 8

Unit: mm

[Surface data]

| Surface number | r | d | nd | vd | PgF |
|---|---|---|---|---|---|
| Object surface | ∞ | (d0) | | | |
| 1 | 499.9435 | 2.2000 | 1.84666 | 23.78 | 0.6192 |
| 2 | 144.7637 | 6.1705 | 1.55397 | 71.76 | 0.5392 |
| 3 | −430.4265 | 0.2000 | | | |
| 4 | 73.3119 | 5.9391 | 1.69680 | 55.46 | 0.5426 |
| 5 | 234.0640 | (d5) | | | |
| 6 | 80.9176 | 2.0000 | 1.72916 | 54.67 | 0.5453 |
| 7 | 21.4319 | 8.7809 | | | |
| 8* | −41.0107 | 1.4000 | 1.59201 | 67.02 | 0.5358 |
| 9* | 45.3855 | 1.0000 | | | |
| 10 | 45.2496 | 7.5917 | 1.78880 | 28.43 | 0.6009 |
| 11 | −56.9689 | 3.7108 | | | |
| 12 | −28.1571 | 1.1000 | 1.74400 | 44.90 | 0.5631 |
| 13 | −100.3347 | (d13) | | | |
| 14(diaphragm) | ∞ | 1.5000 | | | |
| 15* | 46.9306 | 5.5542 | 1.55332 | 71.69 | 0.5404 |
| 16 | −100.0616 | 2.7922 | | | |
| 17 | 73.7153 | 1.5000 | 2.05090 | 26.94 | 0.6052 |
| 18 | 40.3515 | 5.9670 | 1.60342 | 38.01 | 0.5828 |
| 19 | −239.6272 | 4.4583 | | | |
| 20 | −47.0826 | 1.0000 | 1.80000 | 29.84 | 0.6017 |
| 21 | −106.2236 | (d21) | | | |
| 22* | 95.2593 | 4.5814 | 1.59201 | 67.02 | 0.5358 |
| 23 | −64.1779 | 0.1501 | | | |
| 24 | −999.7999 | 1.0000 | 1.73037 | 32.23 | 0.5899 |
| 25 | 48.5191 | 6.6608 | 1.43700 | 95.10 | 0.5336 |
| 26 | −78.7307 | 0.1499 | | | |
| 27 | 202.4146 | 5.1695 | 1.61997 | 63.88 | 0.5426 |
| 28 | −54.3868 | (d28) | | | |
| 29 | 115.2381 | 2.5505 | 1.94594 | 17.98 | 0.6546 |
| 30 | −353.7179 | 1.0000 | 1.74951 | 35.33 | 0.5818 |
| 31 | 34.1537 | (d31) | | | |
| 32* | 37.9282 | 1.5000 | 1.69350 | 53.20 | 0.5467 |
| 33 | 25.0001 | 8.8108 | 1.48749 | 70.44 | 0.5306 |
| 34 | 237.6160 | (d34) | | | |
| 35* | −73.1774 | 1.5000 | 1.59201 | 67.02 | 0.5358 |
| 36 | 170.9535 | (BF) | | | |
| Image surface | ∞ | | | | |

[Aspherical Surface Data]

| | Surface 8 | Surface 9 | Surface 15 | Surface 22 | Surface 32 |
|---|---|---|---|---|---|
| K | −0.85184 | 0.20744 | 0.00000 | 0.00000 | 0.00000 |
| A4 | 2.35829E−06 | −2.26040E−06 | −3.03509E−06 | −8.62482E−06 | 2.63691E−06 |
| A6 | −2.10031E−09 | −2.22191E−09 | −2.16063E−09 | 5.65772E−09 | 2.83322E−09 |
| A8 | 3.58519E−11 | −3.61157E−11 | 8.28785E−12 | −5.07322E−12 | 2.18327E−11 |
| A10 | −2.00394E−14 | 4.58221E−13 | −4.05259E−15 | −2.17785E−15 | −4.93846E−14 |
| A12 | −1.65769E−16 | −1.37930E−15 | −5.12726E−17 | 1.27231E−17 | 1.07498E−16 |
| A14 | 0.00000E+00 | 0.00000E+00 | −5.46995E−20 | 0.00000E+00 | 0.00000E+00 |
| A16 | 0.00000E+00 | 0.00000E+00 | 7.28438E−22 | 0.00000E+00 | 0.00000E+00 |
| A18 | 0.00000E+00 | 0.00000E+00 | 2.74488E−24 | 0.00000E+00 | 0.00000E+00 |
| A20 | 0.00000E+00 | 0.00000E+00 | −1.18341E−26 | 0.00000E+00 | 0.00000E+00 |

| | Surface 35 |
|---|---|
| K | 0.00000 |
| A4 | −5.19869E−06 |
| A6 | −1.23838E−08 |
| A8 | 2.03578E−11 |
| A10 | −1.20432E−13 |
| A12 | −3.44965E−17 |
| A14 | 0.00000E+00 |
| A16 | 0.00000E+00 |
| A18 | 0.00000E+00 |
| A20 | 0.00000E+00 |

[Various Types of Data]
Zoom ratio 3.53

| | Wide angle | Intermediate | Telephoto |
|---|---|---|---|
| Focal length | 28.84 | 50.00 | 101.85 |
| F number | 2.91 | 2.91 | 2.91 |
| Total angle of view 2ω | 76.54 | 45.95 | 22.86 |
| Image height Y | 21.63 | 21.63 | 21.63 |
| Total length of lens | 165.28 | 174.96 | 213.68 |

[Variable Distance Data]

| | Wide angle | Intermediate | Telephoto |
|---|---|---|---|
| d0 | ∞ | ∞ | ∞ |
| d5 | 1.5000 | 12.9773 | 47.0554 |
| d13 | 23.1216 | 8.5990 | 1.5000 |
| d21 | 9.5256 | 3.7785 | 1.5000 |
| d28 | 1.0000 | 2.2639 | 0.9993 |
| d31 | 3.7632 | 19.7057 | 35.5544 |
| d34 | 6.3647 | 7.6305 | 7.0630 |
| BF | 24.0717 | 24.0717 | 24.0717 |

[Lens Group Data]

| Group | Starting surface | Focal length |
|---|---|---|
| G1 | 1 | 131.71 |
| G2 | 6 | −22.77 |
| G3 | 14 | 64.66 |
| G4 | 22 | 37.48 |
| G5 | 29 | −77.88 |
| G6 | 32 | 120.73 |
| G7 | 35 | −86.36 |

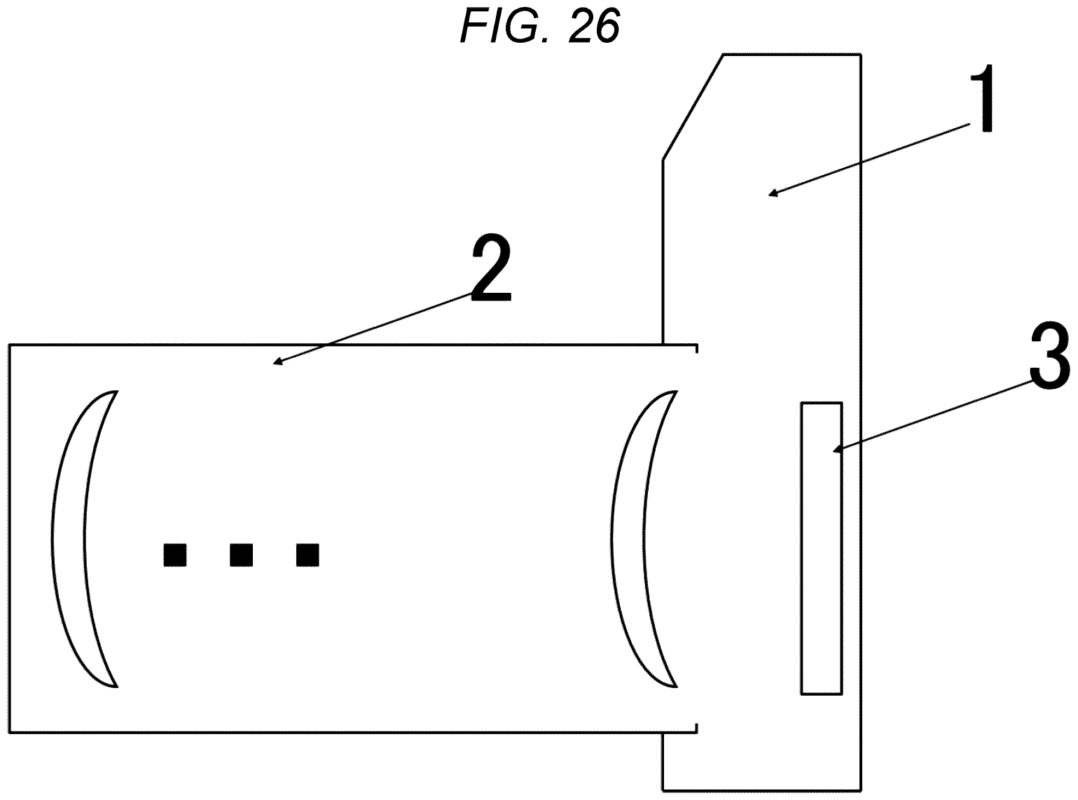

Next, an imaging apparatus comprising the variable magnification optical system according to the embodiment of the present invention will be described with reference to FIG. 26.

In FIG. 26, 1 is an imaging apparatus, 2 is a variable magnification optical system of any of Examples 1 to 8, 3 is an imaging unit incorporated in the imaging apparatus 1, and the imaging apparatus 1 includes an image processing engine and the like (not shown), and the imaging unit 3 includes members such as a cover glass and an optical low-pass filter (not shown), and an image sensor (photoelectric conversion element) such as a CCD sensor and a CMOS sensor. An object (subject) (not shown) is imaged by the variable magnification optical system 2 to form an image (subject image) on the imaging unit 3, and the image (subject image) is recorded in a memory (not shown) by the imaging apparatus 1.

Accordingly, a photographer can take a photograph of the subject by using the imaging apparatus comprising the variable magnification optical system that is small in size, that has a large aperture ratio and a high zooming ratio of the variable magnification optical system, and that has aberrations satisfactorily corrected.

Next, Table 1 shows aberration characteristics of Examples (1) to (8) according to the variable magnification optical system of the present invention together with the corresponding values of the conditional expressions of these variable magnification optical systems. Further, Table 2 shows aberration characteristics of the variable magnification optical system of Comparative Example together with the corresponding values of the conditional expressions of the variable magnification optical system. Various numerical values according to Comparative Examples A to C shown in Table 2 are calculated using Examples described in Patent Documents 1 to 3.

TABLE 1

| No. | | Example 1 | Example 2 | Example 3 | Example 4 |
|---|---|---|---|---|---|
| Conditional Expression (1) | f34/fW | 0.97 | 0.89 | 1.08 | 0.91 |
| Conditional Expression (2) | f4/f3 | 0.39 | 0.70 | 0.40 | 0.55 |
| Conditional Expression (3) | ΔPgF1 + | 0.0016 | −0.0003 | 0.0038 | −0.0082 |
| | ΔPgF2 | | | | |
| Conditional Expression (4) | \|f13\|/f4L | 0.53 | 0.31 | 0.49 | 0.49 |
| Conditional Expression (5) | m4/m3 | 1.24 | 1.21 | 1.29 | 1.35 |
| Conditional Expression (6) | \|f5\|/f4 | 1.92 | 1.43 | 2.29 | 2.36 |
| Conditional Expression (7) | m5/m4 | 0.90 | 1.08 | 1.00 | 1.15 |
| Conditional Expression (8) | \|f5L\|/fW | 2.51 | 2.01 | 2.80 | 2.56 |
| Conditional Expression (9) | bfW/fW | 0.98 | 0.62 | 0.90 | 0.78 |
| Conditional Expression (10) | ωW | 37.15 | 36.87 | 41.19 | 36.87 |
| On-axis chromatic aberration coefficient | L(dg)_W | 0.0004 | −0.0006 | 0.0000 | 0.0005 |
| between d-g-line at wide-angle end | | | | | |
| Magnification chromatic aberration coefficient | T(dg)_W | 0.0003 | 0.0003 | −0.0005 | 0.0003 |
| between d-g-line at wide-angle end | | | | | |
| On-axis chromatic aberration coefficient | L(CF)_W | 0.0022 | 0.0016 | 0.0028 | 0.0017 |
| between C-F-line at wide-angle end | | | | | |
| Magnification chromatic aberration coefficient | T(CF)_W | 0.0014 | 0.0013 | 0.0010 | 0.0014 |
| between C-F-line at wide-angle end | | | | | |
| Spherical aberration coefficient at wide-angle | I_W | −0.1280 | 0.4530 | −0.6300 | −0.0590 |
| end | | | | | |
| Comatic aberration coefficient at wide-angle | II_W | −0.0220 | 0.0040 | −0.0300 | −0.0140 |
| end | | | | | |
| Astigmatism coefficient at wide-angle end | III_W | −0.0010 | 0.0000 | 0.0020 | −0.0020 |
| On-axis chromatic aberration coefficient | L(dg)_T | 0.0001 | 0.0001 | −0.0056 | −0.0002 |
| between d-g-line at telephoto end | | | | | |
| Magnification chromatic aberration coefficient | T(dg)_T | 0.0003 | 0.0007 | 0.0010 | 0.0007 |
| between d-g-line at telephoto end | | | | | |
| On-axis chromatic aberration coefficient | L(CF)_T | 0.0015 | 0.0016 | 0.0003 | −0.0009 |
| between C-F-line at telephoto end | | | | | |
| Magnification chromatic aberration coefficient | T(CF)_T | −0.0007 | −0.0005 | 0.0001 | −0.0007 |
| between C-F-line at telephoto end | | | | | |
| Spherical aberration coefficient at telephoto | I_T | −0.2630 | −0.2450 | −0.2570 | 0.3270 |
| end | | | | | |
| Comatic aberration coefficient at telephoto end | II_T | −0.0200 | −0.0190 | −0.0030 | −0.0190 |
| Astigmatism coefficient at telephoto end | III_T | 0.0020 | 0.0010 | 0.0000 | 0.0020 |
| Root sum of squares of on-axis chromatic | RSS(L) | 0.0027 | 0.0023 | 0.0063 | 0.0020 |
| aberration coefficients of wide-angle end and | | | | | |
| telephoto end | | | | | |
| Root sum of squares of magnification | RSS(T) | 0.0016 | 0.0016 | 0.0015 | 0.0017 |
| chromatic aberration coefficients of wide-angle | | | | | |
| end and telephoto end | | | | | |
| Root sum of squares of spherical aberration | RSS(I) | 0.2925 | 0.5150 | 0.6804 | 0.3323 |
| coefficients of wide-angle end and telephoto | | | | | |
| end | | | | | |
| Root sum of squares of comatic aberration | RSS(II) | 0.0297 | 0.0194 | 0.0301 | 0.0236 |
| coefficients of wide-angle end and telephoto | | | | | |
| end | | | | | |
| Root sum of squares of astigmatism | RSS(III) | 0.0022 | 0.0010 | 0.0020 | 0.0028 |
| coefficients of wide-angle end and telephoto | | | | | |
| end | | | | | |
| Evaluation of on-axis chromatic aberration | EVA(L) | A | A | B | A |
| Evaluation of magnification chromatic | EVA(T) | A | A | A | A |
| aberration | | | | | |
| Evaluation of spherical aberration | EVA(I) | A | B | B | A |
| Evaluation of comatic aberration | EVA(II) | A | A | A | A |
| Evaluation of astigmatism | EVA(III) | A | A | A | A |

| No. | | Example 5 | Example 6 | Example 7 | Example 8 |
|---|---|---|---|---|---|
| Conditional Expression (1) | f34/fW | 0.86 | 0.89 | 0.86 | 0.82 |
| Conditional Expression (2) | f4/f3 | 0.68 | 0.55 | 0.78 | 0.58 |
| Conditional Expression (3) | ΔPgF1 + | −0.0034 | −0.0044 | 0.0014 | 0.0067 |
| | ΔPgF2 | | | | |
| Conditional Expression (4) | \|f13\|/f4L | 0.43 | 0.63 | 0.25 | 0.51 |
| Conditional Expression (5) | m4/m3 | 1.34 | 1.44 | 1.31 | 1.33 |
| Conditional Expression (6) | \|f5\|/f4 | 2.16 | 2.06 | 1.93 | 2.08 |
| Conditional Expression (7) | m5/m4 | 0.98 | 0.91 | 0.98 | 1.00 |
| Conditional Expression (8) | \|f5L\|/fW | 2.28 | 2.83 | 2.02 | 2.15 |
| Conditional Expression (9) | bfW/fW | 0.80 | 1.52 | 0.79 | 0.83 |
| Conditional Expression (10) | ωW | 36.87 | 36.87 | 30.96 | 36.87 |
| On-axis chromatic aberration coefficient | L(dg)_W | −0.0016 | 0.0010 | 0.0004 | 0.0001 |
| between d-g-line at wide-angle end | | | | | |
| Magnification chromatic aberration | T(dg)_W | 0.0003 | 0.0004 | 0.0003 | 0.0009 |
| coefficient between deg-line at wide-angle | | | | | |
| end | | | | | |
| On-axis chromatic aberration coefficient | L(CF)_W | 0.0002 | 0.0015 | 0.0016 | 0.0016 |
| between C-F-line at wide-angle end | | | | | |
| Magnification chromatic aberration | T(CF)_W | 0.0013 | 0.0014 | 0.0013 | 0.0013 |
| coefficient between C-F-line at wide-angle | | | | | |
| end | | | | | |
| Spherical aberration coefficient at wide- | I_W | 0.2450 | −0.0210 | −0.1810 | −0.1470 |
| angle end | | | | | |
| Comatic aberration coefficient at wide-angle | II_W | −0.0190 | 0.0030 | −0.0230 | −0.0270 |
| end | | | | | |
| Astigmatism coefficient at wide-angle end | III_W | −0.0010 | −0.0030 | −0.0010 | −0.0010 |
| On-axis chromatic aberration coefficient | L(dg)_T | 0.0004 | −0.0011 | −0.0018 | −0.0026 |
| between d-g-line at telephoto end | | | | | |
| Magnification chromatic aberration | T(dg)_T | 0.0009 | 0.0011 | 0.0005 | 0.0004 |
| coefficient between d-g-line at telephoto end | | | | | |
| On-axis chromatic aberration coefficient | L(CF)_T | 0.0026 | −0.0017 | −0.0016 | −0.0015 |
| between C-F-line at telephoto end | | | | | |
| Magnification chromatic aberration | T(CF)_T | −0.0004 | −0.0003 | −0.0008 | −0.0010 |
| coefficient between C-F-line at telephoto end | | | | | |
| Spherical aberration coefficient at telephoto | I_T | −0.2610 | −0.2490 | −0.1540 | −0.0280 |
| end | | | | | |
| Comatic aberration coefficient at telephoto | II_T | −0.0090 | 0.0000 | −0.0010 | −0.0110 |
| end | | | | | |
| Astigmatism coefficient at telephoto end | III_T | 0.0020 | 0.0000 | 0.0070 | 0.0010 |
| Root sum of squares of on-axis chromatic | RSS(L) | 0.0031 | 0.0027 | 0.0029 | 0.0034 |
| aberration coefficients of wide-angle end and | | | | | |
| telephoto end | | | | | |
| Root sum of squares of magnification | RSS(T) | 0.0017 | 0.0018 | 0.0016 | 0.0019 |
| chromatic aberration coefficients of wide- | | | | | |
| angle end and telephoto end | | | | | |
| Root sum of squares of spherical aberration | RSS(I) | 0.3580 | 0.2499 | 0.2376 | 0.1496 |
| coefficients of wide-angle end and telephoto | | | | | |
| end | | | | | |
| Root sum of squares of comatic aberration | RSS(II) | 0.0210 | 0.0030 | 0.0230 | 0.0292 |
| coefficients of wide-angle end and telephoto | | | | | |
| end | | | | | |
| Root sum of squares of astigmatism | RSS(III) | 0.0022 | 0.0030 | 0.0071 | 0.0014 |
| coefficients of wide-angle end and telephoto | | | | | |
| end | | | | | |
| Evaluation of on-axis chromatic aberration | EVA(L) | A | A | A | A |
| Evaluation of magnification chromatic | EVA(T) | A | A | A | A |
| aberration | | | | | |
| Evaluation of spherical aberration | EVA(I) | A | A | A | A |
| Evaluation of comatic aberration | EVA(II) | A | A | A | A |
| Evaluation of astigmatism | EVA(III) | A | A | B | A |

TABLE 2

| | | Comparative | Comparative | Comparative |
|---|---|---|---|---|
| No. | | Example A | Example B | Example C |
| Conditional Expression (1) | f34/fW | 0.94 | 0.67 | 0.49 |
| Conditional Expression (2) | f4/f3 | 1.41 | 0.38 | 0.16 |
| Conditional Expression (3) | ΔPgF1 + | −0.0080 | 0.0123 | −0.0056 |
| | ΔPgF2 | | | |
| Conditional Expression (4) | \|f13\|/f4L | 1.19 | 0.53 | 1.04 |
| Conditional Expression (5) | m4/m3 | 0.70 | 1.22 | 1.08 |
| Conditional Expression (6) | \|f5\|/f4 | 0.92 | 2.34 | 2.31 |
| Conditional Expression (7) | m5/m4 | 1.43 | 1.05 | 1.01 |
| Conditional Expression (8) | \|f5L\|/fW | 2.08 | 1.56 | 0.91 |
| Conditional Expression (9) | bfW/fW | 0.00 | 0.63 | 0.45 |
| Conditional Expression (10) | ωW | 41.28 | 37.55 | 31.00 |
| On-axis chromatic aberration coefficient | L(dg)_W | −0.0024 | 0.0008 | −0.0012 |
| between d-g-line at wide-angle end | | | | |
| Magnification chromatic aberration coefficient | T(dg)_W | −0.0002 | 0.0003 | −0.0003 |
| between d-g-line at wide-angle end | | | | |
| On-axis chromatic aberration coefficient | L(CF)_W | −0.0003 | 0.0042 | 0.0000 |
| between C-F-line at wide-angle end | | | | |
| Magnification chromatic aberration coefficient | T(CF)_W | 0.0009 | 0.0024 | 0.0013 |
| between C-F-line at wide-angle end | | | | |
| Spherical aberration coefficient at wide-angle | I_W | 0.6800 | 0.8870 | 0.1620 |
| end | | | | |
| Comatic aberration coefficient at wide-angle end | II_W | −0.0800 | 0.1270 | −0.0270 |
| Astigmatism coefficient at wide-angle end | III_W | −0.0050 | 0.0040 | −0.0580 |
| On-axis chromatic aberration coefficient | L(dg)_T | −0.0051 | −0.0049 | −0.0011 |
| between d-g-line at telephoto end | | | | |
| Magnification chromatic aberration coefficient | T(dg)_T | 0.0002 | −0.0003 | −0.0003 |
| between d-g-line at telephoto end | | | | |
| On-axis chromatic aberration coefficient | L(CF)_T | −0.0019 | −0.0038 | −0.0028 |
| between C-F-line at telephoto end | | | | |
| Magnification chromatic aberration coefficient | T(CF)_T | −0.0002 | −0.0025 | −0.0007 |
| between C-F-line at telephoto end | | | | |
| Spherical aberration coefficient at telephoto end | I_T | −0.8170 | −0.4050 | 1.1410 |
| Comatic aberration coefficient at telephoto end | II_T | −0.0150 | −0.2140 | −0.0960 |
| Astigmatism coefficient at telephoto end | III_T | −0.0050 | 0.0030 | −0.0820 |
| Root sum of squares of on-axis chromatic | RSS(L) | 0.0060 | 0.0075 | 0.0032 |
| aberration coefficients of wide-angle end and | | | | |
| telephoto end | | | | |
| Root sum of squares of magnification chromatic | RSS(T) | 0.0010 | 0.0035 | 0.0015 |
| aberration coefficients of wide-angle end and | | | | |
| telephoto end | | | | |
| Root sum of squares of spherical aberration | RSS(I) | 1.0630 | 0.9751 | 1.1524 |
| coefficients of wide-angle end and telephoto end | | | | |
| Root sum of squares of comatic aberration | RSS(II) | 0.0814 | 0.2488 | 0.0997 |
| coefficients of wide-angle end and telephoto end | | | | |
| Root sum of squares of astigmatism coefficients | RSS(III) | 0.0071 | 0.0050 | 0.1004 |
| of wide-angle end and telephoto end | | | | |
| Evaluation of on-axis chromatic aberration | EVA(L) | B | C | A |
| Evaluation of magnification chromatic | EVA(T) | A | C | A |
| aberration | | | | |
| Evaluation of spherical aberration | EVA(I) | C | C | C |
| Evaluation of comatic aberration | EVA(II) | C | C | C |
| Evaluation of astigmatism | EVA(III) | B | B | C |

The various aberration coefficients shown in Tables 1 and 2 are calculated by the calculation methods described in Non-Patent Documents 1 and 2.

The technical meaning of the aberration coefficient is that a relationship between a structure of an optical system and a limit of aberration and aberration correction ability can be explicitly expressed.

The aberration coefficient can be expressed by a method of expressing a component of lateral aberration on a paraxial image surface or a method of expressing a component of lateral aberration on a paraxial image surface by normalizing the component with respect to an aperture and an angle of view.

Here, the aberration coefficient was obtained by a calculation method of “Improvement of Normalization (2)” described in Non-Patent document 2.

This calculation method is effective as an evaluation means in a case where the performance of the optical systems is mutually compared and determined even in a case where the focal length, the NA, and the ideal image height of the variable magnification optical system are various.

In Tables 1 and 2, the aberration coefficients are evaluated at both the wide. angle end and the telephoto end, and the chromatic aberration is evaluated at a plurality of wavelengths, and the root sum of squares (RSS) thereof is obtained so that the aberration coefficients can be evaluated in a final manner.

The final evaluation of Examples and Comparative Examples is classified into three stages, and each of them is evaluated by the following method.

$$The on - axis chromatic aberration is represented by A : \\ RSS ( L ) < 0.004 , B : 0.004 \leq RSS ( L ) < 0.007 , C : RSS ( L ) \geq 0.007 .$$

$$The magnification chromatic aberration is represented by A : \\ RSS ( T ) < 0.002 , B : 0.002 \leq RSS ( T ) < 0.0035 , C : RSS ( T ) \geq 0.0035 .$$

$$The spherical aberration is represented by , A : \\ RSS ( I ) < 0.4 , B : 0.4 \leq RSS ( I ) < 0.8 , C : RSS ( I ) \geq 0.8 .$$

$$The comatic aberration is represented by , A : \\ RSS ( II ) < 0.04 , B : 0.04 \leq RSS ( II ) < 0.08 , C : RSS ( II ) \geq 0.08 .$$

$$The astigmatism is represented by , A : \\ RSS ( III ) < 0.004 , B : 0.004 \leq RSS ( III ) < 0.008 , C : RSS ( III ) \geq 0.008 .$$

As can be seen from Tables 1 and 2, in Examples according to the variable magnification optical system of the present invention, various aberrations are satisfactorily corrected from the wide-angle end to the telephoto end.

The following contents can be appropriately employed within a range where the image formation performance of the variable magnification optical system according to the embodiment of the present invention is not impaired.

Although configurations of five groups, six groups, and seven groups are shown as examples of the variable magnification optical system, the present invention is not limited thereto, and configurations of other numbers of groups (for example, eight groups, nine groups, and the like) can also be adopted. Specifically, a configuration in which a planar optical filter or a lens group is added to a side closest to the object side or a side closest to the image side of the variable magnification optical system may be used. The lens group is a portion that is separated at a distance that changes during zooming from the wide-angle end to the telephoto end and that has at least one lens.

In general, in a case of a lens group having a flat optical member or a sufficiently weak refractive power as compared with a focal length at a wide-angle end, even in a case where the lens group is added to the optical system, an influence on aberration correction is negligible and can be ignored, or even in a case where there is an influence on aberration correction due to the addition of the lens group to the optical system, the refractive power disposition of the optical system is only required to be changed slightly, and the lens group does not affect the skeleton of the optical system.

Although all the lens surfaces having a refractive power are curved surfaces and refractive surfaces, which are shown as examples of the variable magnification optical system, the present invention is not limited thereto, and a refractive index distribution material, a metasurface, and a diffractive optical element may be employed for a flat surface or a curved surface. Specifically, in the case of analogy with the variable magnification optical system according to the embodiment of the present invention, in a case where an object side lens surface of a negative lens L3n disposed closest to the image side in the third lens group G3 is a diffractive surface, the same effect as the present invention can be obtained even in a case where the orientation of the surface is convex toward the object side. In addition, in a case where the object side lens surface of the negative lens L4n disposed closest to the object side in the fourth lens group G4 is a diffractive surface, the same effect as that of the present invention can be obtained even in a case where the orientation of the surface is convex toward the object side.

An antireflection film may be applied to a lens surface constituting the variable magnification optical system. As a result, it is possible to reduce flare and ghost, and it is possible to obtain an image with higher contrast.

The focal lengths of the variable magnification optical systems or the lens groups, the back focuses of the variable magnification optical systems, the movement amounts, the refractive indexes, the Abbe numbers, and the partial dispersion ratios of the lens groups, and the half angle of views of the variable magnification optical systems can be values measured by the following methods, respectively.

The focal length of the variable magnification optical system or the lens group can be measured in accordance with JIS B 7094 (Photography—Lenses—Method for Measuring Focal Length). Specifically, the test lens is installed on a holding part mounted on a focal length measuring instrument capable of performing any of the measurement method 1 to the measurement method 4 described in the standard, and the focal length is measured. Examples of focal length measuring instruments include the MB series (Measurement Method 3) by Pearl Optical Industry Co., Ltd., and the OptiSpheric series (Measurement Method 1) by Trioptics GmbH.

The back focus of the variable magnification optical system can be measured by using a commercially available back focus measuring instrument. Specifically, the test lens is installed in a holding part mounted on the measuring instrument, and measurement is performed. Examples of back focus measuring instruments include the MB series manufactured by Pearl Optical Industry Co., Ltd. and the OptiSpheric series manufactured by Trioptics GmbH.

The amount of movement of the lens group can be measured by using a commercially available surface distance measuring instrument. Specifically, the test lens is installed in a holding part mounted on the measuring instrument, and measurement is performed. Examples of surface distance measuring instruments include the OptiSurf series by Trioptics GmbH.

The refractive index, the Abbe number, and the partial dispersion ratio can be measured in accordance with JIS B 7071 (Optics and photonics—Method for measuring refractive index of optical glass) or JIS K 7142 (Plastics—Method for measuring refractive index). Specifically, the test lens is processed into a shape that allows it to be installed on a holding part mounted on a refractive index measuring instrument capable of performing any of the measurement methods described in the standard (V-block method, minimum deviation method, or A method for plastics). After installation, the measurement is performed by changing the measurement wavelength for each corresponding spectral line. Examples of the refractive index measuring instrument include KPR series (V-block method) manufactured by Shimadzu Corporation and GMR series (minimum deviation method) manufactured by Shimadzu Corporation.

The half angle of view of a variable magnification optical system can be measured according to Non-Patent Document 3. Specifically, first, a photo captured by the variable magnification optical system is directly observed with the naked eye, and the image circle diameter Φ is measured with a length measuring instrument such as a caliper. Next, the half angle of view ω is obtained by using the focal length f obtained by the measurement described in the fourth paragraph according to ω=arctan ((Φ/2)/f)/2.

Although the configurations of the examples according to the variable magnification optical system of the present invention have been described above, various modification examples can be made without being limited to the description of the above-mentioned embodiments and examples. The shape and numerical value of each part shown in each of the above numerical examples are merely an example for carrying out the present technology, and the technical scope of the present invention is not limited by these examples.

The above-described embodiments can adopt the following configurations.

### [Item 1]

A variable magnification optical system including: in order from an object side, a first lens group G1 having a positive refractive power; a second lens group G2 having a negative refractive power; a third lens group G3 having a positive refractive power; a fourth lens group G4 having a positive refractive power; and a fifth lens group G5 having a negative refractive power, in which,

during zooming from a wide-angle end to a telephoto end, a distance between the first lens group G1 and the second lens group G2 changes, a distance between the second lens group G2 and the third lens group G3 changes, and a distance between the third lens group G3 and the fourth lens group G4 changes,

during focusing from an infinity end to a closest object end, any one of the fourth lens group G4 or the fifth lens group G5 moves along an optical axis,

the third lens group G3 includes at least one negative lens, a lens surface on the object side of a negative lens L3n disposed closest to the image side in the third lens group G3 is convex toward the image side,

the fourth lens group G4 includes at least one negative lens, a lens surface on the object side of a negative lens L4n disposed closest to the object side in the fourth lens group G4 is convex toward the image side, and

the variable magnification optical system satisfies following conditional expressions.

$$0.61 < f 34 / f W < 1.46 \qquad ( 1 )$$

$$0.32 < f 4 / f 3 < 0.96 \qquad ( 2 )$$

$$- 0.0085 < Δ PgF 1 + Δ PgF 2 < 0.007 \qquad ( 3 )$$

f34: total focal length of the third lens group G3 and the fourth lens group G4. Here, f34=1/(Σ(1/fn)), n=3 to 4. fn is a focal length of an n-th lens group.

fW: focal length of the variable magnification optical system at the wide-angle end

f4: focal length of the fourth lens group G4

f3: focal length of the third lens group G3

ΔPgF1: anomalous dispersion of a negative lens L3n disposed closest to the image side in the third lens group G3. Here, ΔPgF1=PgF1−0.64833+0.00180×vd1. PgF1: partial dispersion ratio of a negative lens L3n disposed closest to the image side in the third lens group G3, with respect to the g-line and the F-line. vd1: Abbe number of a negative lens L3n disposed closest to the image side in the third lens group G3, with respect to the d-line.

ΔPgF2: anomalous dispersion of a negative lens L4n disposed closest to the object side in the fourth lens group G4. Here, ΔPgF2=PgF2−0.64833+0.00180×vd2. PgF2: partial dispersion ratio of a negative lens L4n disposed closest to the object side in the fourth lens group G4, with respect to the g-line and the F-line. vd2: Abbe number of a negative lens L4n disposed closest to the object side in the fourth lens group G4, with respect to the d-line.

### [Item 2]

The variable magnification optical system according to [Item 1], in which the following conditional expression is further satisfied.

$$0.13 < \vert f 13 / f 4 L \vert < 1.25 \qquad ( 4 )$$

f13: total focal length of the first lens group G1 and the third lens group G3. Here, f13=1/(Σ(1/fn)), n=1 to 3. fn is a focal length of an n-th lens group.

f4L: total focal length of the fourth lens group G4 to the lens group disposed closest to the image side (hereinafter, last lens group GL). Here, f4L=1/(Σ(1/fn)), n=4 to L. fn is a focal length of an n-th lens group. fL is a focal length of the last lens group GL.

### [Item 3]

The variable magnification optical system according to [Item 1] or [Item 2], in which the following conditional expression is further satisfied.

$$1.12 < m 4 / m 3 < 1.56 \qquad ( 5 )$$

m4: amount of movement of the fourth lens group G4 during zooming from the wide-angle end to the telephoto end (movement toward the object side is positive)

m3: amount of movement of the third lens group G3 during zooming from the wide-angle end to the telephoto end (movement toward the object side is positive)

### [Item 4]

The variable magnification optical system according to any one of [Item 1] to [Item 3], in which the following conditional expression is further satisfied.

$$1.17 < \vert f 5 \vert / f 4 < 2.89 \qquad ( 6 )$$

f5: focal length of the fifth lens group G5

f4: focal length of the fourth lens group G4

### [Item 5]

The variable magnification optical system according to any one of [Item 1] to [Item 4], in which the following conditional expression is further satisfied.

$$0.83 < m 5 / m 4 < 1.24 \qquad ( 7 )$$

m5: amount of movement of the fifth lens group G5 during zooming from the wide-angle end to the telephoto end (movement toward the object side is positive)

m4: amount of movement of the fourth lens group G4 during zooming from the wide-angle end to the telephoto end (movement toward the object side is positive)

### [Item 6]

The variable magnification optical system according to any one of [Item 1] to [Item 5], in which the following conditional expression is further satisfied.

$$1.34 < \vert f 5 L \vert / fW < 4.25 \qquad ( 8 )$$

f5L: total focal length of the fifth lens group G5 to the lens group (hereinafter, last lens group GL) disposed closest to the image side Here, f5L=1/(Σ(1/fn)), n=5 to L. fn is a focal length of an n-th lens group. fL is a focal length of the last lens group GL.

fW: focal length of the variable magnification optical system at the wide angle end

### [Item 7]

The variable magnification optical system according to any one of [Item 1] to [Item 6], in which the following conditional expression is further satisfied.

$$0.51 < bfW / fW < 1.85 \qquad ( 9 )$$

bfW: back focus of variable magnification optical system at wide-angle end

fW: focal length of the variable magnification optical system at the wide-angle end

### [Item 8]

The variable magnification optical system according to any one of [Item 1] to [Item 7], in which the following conditional expression is further satisfied.

$$28.56 < ω W < 44.11 \qquad ( 10 )$$

ωW: half angle of view at a wide-angle end of the variable magnification optical system. Here, ωW=arctan(Y/fW)/2. Y is a maximum image height at a wide-angle end of the variable magnification optical system. fW is a focal length of the variable magnification optical system at a wide-angle end.

### [Item 9]

The variable magnification optical system according to any one of [Item 1] to [Item 8], in which the fourth lens group G4 moves to the object side along the optical axis during focusing from the infinity end to the closest object end.

### [Item 10]

The variable magnification optical system according to any one of [Item 1] to [Item 9], in which the fifth lens group G5 moves to the image side along the optical axis during focusing from the infinity end to the closest object end.

### [Item 11]

The variable magnification optical system according to any one of [Item 1] to [Item 10], in which an object side lens surface of a negative lens L3n disposed closest to the image side in the third lens group G3 is in contact with air.

### [Item 12]

The variable magnification optical system according to any one of [Item 1] to [Item 11], in which an object side lens surface of a negative lens L4n disposed closest to the object side in the fourth lens group G4 is in contact with air.

### [Item 13]

The variable magnification optical system according to any one of [Item 1] to [Item 12], in which the first lens group G1 includes at least one negative lens.

### [Item 14]

The variable magnification optical system according to any one of [Item 1] to [Item 13], in which an aperture diaphragm S is provided at a position closest to the object side in the third lens group G3, and the third lens group G3 and the aperture diaphragm S move as a unit during zooming.

### [Item 15]

The variable magnification optical system according to any one of [Item 1] to [Item 14], in which the fifth lens group G5 includes at least one positive lens.

### [Item 16]

The variable magnification optical system according to any one of [Item 1] to [Item 15], in which the second lens group G2 remains stationary with respect to an image surface during zooming from a wide-angle end to a telephoto end.

### [Item 17]

The variable magnification optical system according to any one of [Item 1] to [Item 16], in which a lens group disposed closest to the image side (hereinafter, last lens group GL) remains stationary with respect to an image surface during zooming from a wide-angle end to a telephoto end.

### [Item 18]

The variable magnification optical system according to any one of [Item 1] to [Item 17], in which the third lens group G3 includes a vibration reduction lens group that is movable in a direction substantially perpendicular to an optical axis and has a positive refractive power.

### [Item 19]

An imaging apparatus further including: the variable magnification optical system according to any one of [Item 1] to [Item 18].

### DESCRIPTION OF REFERENCE NUMERALS AND SIGNS

G1: first lens group

G2: second lens group

G3: third lens group

G4: fourth lens group

G5: fifth lens group

G6: sixth lens group

G7: seventh lens group

GL: last lens group

L3n: negative lens of third lens group G3, which is disposed closest to image side

L4n: negative lens of fourth lens group G4, which is disposed closest to object side

S: aperture diaphragm

I: image surface

What is claimed is:

1. A variable magnification optical system comprising:
in order from an object side, a first lens group G1 having a positive refractive power; a second lens group G2 having a negative refractive power; a third lens group G3 having a positive refractive power; a fourth lens group G4 having a positive refractive power; and a fifth lens group G5 having a negative refractive power, wherein,
during zooming from a wide angle end to a telephoto end, a distance between the first lens group G1 and the second lens group G2 changes, a distance between the second lens group G2 and the third lens group G3 changes, and a distance between the third lens group G3 and the fourth lens group G4 changes,
during focusing from an infinity end to a closest object end, any one of the fourth lens group G4 or the fifth lens group G5 moves along an optical axis,
the third lens group G3 includes at least one negative lens, a lens surface on the object side of a negative lens L3n disposed closest to the image side in the third lens group G3 is convex toward an image side,
the fourth lens group G4 includes at least one negative lens, a lens surface on the object side of a negative lens L4n disposed closest to the object side in the fourth lens group G4 is convex toward the image side, and
the variable magnification optical system satisfies following conditional expressions,
$$0.61 < f 34 / fW < 1.46 , \qquad ( 1 )$$
$$0.32 < f 4 / f 3 < 0.96 , \qquad ( 2 )$$
$$- 0.0085 < Δ PgF 1 + Δ PgF 2 < 0.0070 , \qquad ( 3 )$$
f34: total focal length of the third lens group G3 and the fourth lens group G4,
where, f34=1/(Σ(1/fn)), n=3 to 4,
fn is a focal length of an n-th lens group,
fW: focal length of the variable magnification optical system at the wide-angle end,
f4: focal length of the fourth lens group G4,
f3: focal length of the third lens group G3,
ΔPgF1: anomalous dispersion of a negative lens L3n disposed closest to the image side in the third lens group G3,
where, ΔPgF1=PgF1−0.64833+0.00180×vd1,
PgF1: partial dispersion ratio of a negative lens L3n disposed closest to the image side in the third lens group G3, with respect to the g-line and the F-line,
vd1: Abbe number of a negative lens L3n disposed closest to the image side in the third lens group G3, with respect to the d-line,
ΔPgF2: anomalous dispersion of a negative lens L4n disposed closest to the object side in the fourth lens group G4,
where, ΔPgF2=PgF2−0.64833+0.00180×vd2,
PgF2: partial dispersion ratio of a negative lens L4n disposed closest to the object side in the fourth lens group G4, with respect to the g-line and the F-line,
vd2: Abbe number of a negative lens L4n disposed closest to the object side in the fourth lens group G4, with respect to the d-line.

2. The variable magnification optical system according to claim 1, wherein
following conditional expression is satisfied,
$$0.13 < \vert f 13 \vert / f 4 L < 1.25 , \qquad ( 4 )$$
f13: total focal length of the first lens group G1 and the third lens group G3,
where, f13=1/(Σ(1/fn)), n=1 to 3,
fn is a focal length of an n-th lens group,
f4L: total focal length of the fourth lens group G4 and a lens group disposed closest to the image side (hereinafter, last lens group GL),
where, f4L=1/(Σ(1/fn)), n=4 to L,
fn is a focal length of an n-th lens group,
fL is a focal length of the last lens group GL.

3. The variable magnification optical system according to claim 1, wherein
following conditional expression is satisfied,
$$1.12 < m 4 / m 3 < 1.56 , \qquad ( 5 )$$
m4: amount of movement of the fourth lens group G4 during zooming from the wide-angle end to the telephoto end (movement toward the object side is positive),
m3: amount of movement of the third lens group G3 during zooming from the wide-angle end to the telephoto end (movement toward the object side is positive).

4. The variable magnification optical system according to claim 1, wherein
following conditional expression is satisfied,
$$1.17 < \vert f 5 \vert / f 4 < 2.89 , \qquad ( 6 )$$
f5: focal length of the fifth lens group G5,
f4: focal length of the fourth lens group G4.

5. The variable magnification optical system according to claim 1, wherein
following conditional expression is satisfied,
$$0.83 < m 5 / m 4 < 1.24 , \qquad ( 7 )$$
m5: amount of movement of the fifth lens group G5 during zooming from the wide-angle end to the telephoto end (movement toward the object side is positive),
m4: amount of movement of the fourth lens group G4 during zooming from the wide-angle end to the telephoto end (movement toward the object side is positive).

6. The variable magnification optical system according to claim 1, wherein
following conditional expression is satisfied,
$$1. 34 < \vert f 5 L \vert / fW < 4.25 , \qquad ( 8 )$$
f5L: total focal length of the fifth lens group G5 and a lens group (hereinafter, last lens group GL) disposed closest to the image side,
where, f5L=1/(Σ(1/fn)), n=5 to L,
fn is a focal length of an n-th lens group,
fL is a focal length of a lens group disposed closest to the image side (hereinafter, a last lens group GL),
fW: focal length of the variable magnification optical system at the wide-angle end.

7. The variable magnification optical system according to claim 1, wherein
following conditional expression is satisfied,
$$0.51 < bfW / fW < 1.85 , \qquad ( 9 )$$
bfW: back focus of the variable magnification optical system at the wide-angle end,
fW: focal length of the variable magnification optical system at the wide-angle end.

8. The variable magnification optical system according to claim 1, wherein
following conditional expression is satisfied,
$$28.56 < ω W < 44.11 , \qquad ( 10 )$$
ωW: half angle of view at a wide-angle end of the variable magnification optical system,
where, ωW=arctan(Y/fW)/2,
Y is a maximum image height at a wide-angle end of the variable magnification optical system,
fW is a focal length of the variable magnification optical system at a wide-angle end.

9. The variable magnification optical system according to claim 1, wherein
the fourth lens group G4 moves to the object side along the optical axis during focusing from the infinity end to the closest object end.

10. The variable magnification optical system according to claim 1, wherein
the fifth lens group G5 moves to the image side along the optical axis during focusing from the infinity end to the closest object end.

11. The variable magnification optical system according to claim 1, wherein
an object side lens surface of a negative lens L3n disposed closest to the image side in the third lens group G3 is in contact with air.

12. The variable magnification optical system according to claim 1, wherein
an object side lens surface of a negative lens L4n disposed closest to the object side in the fourth lens group G4 is in contact with air.

13. The variable magnification optical system according to claim 1, wherein
the first lens group G1 includes at least one negative lens.

14. The variable magnification optical system according to claim 1, wherein
an aperture diaphragm S is provided at a position closest to the object side in the third lens group G3, and the third lens group G3 and the aperture diaphragm S move as a unit during zooming.

15. The variable magnification optical system according to claim 1, wherein
the fifth lens group G5 includes at least one positive lens.

16. The variable magnification optical system according to claim 1, wherein
the second lens group G2 remains stationary with respect to an image surface during zooming from the wide-angle end to the telephoto end.

17. The variable magnification optical system according to claim 1, wherein
a lens group disposed closest to the image side (hereinafter, last lens group GL) remains stationary with respect to an image surface during zooming from a wide-angle end to a telephoto end.

18. The variable magnification optical system according to claim 1, wherein
the third lens group G3 includes a vibration reduction lens group that is movable in a direction substantially perpendicular to an optical axis and has a positive refractive power.

19. An imaging apparatus comprising: the variable magnification optical system according to claim 1.
